(19) United States
(12) Patent Application Publication
(10) Pub. No.: US 2025/0282905 A1
(43) Pub. Date: Sep. 11, 2025

(54) FOAM PRODUCTS AND THEIR PRODUCTION

(71) Applicant: KINGSPAN HOLDINGS (IRL) LIMITED, Co. Cavan (IE)

(72) Inventors: Patrick DE SCHYVER, Co. Cavan (IE); Tom PULLES, Co. Cavan (IE); Daniel MACK, Co. Cavan (IE); Samuel BUTLER, Co. Cavan (IE); Ruud ZEGGELAAR, Co. Cavan (IE)

(21) Appl. No.: 18/694,743

(22) PCT Filed: Sep. 23, 2022
(86) PCT No.: PCT/EP2022/076600

§ 371 Date: Mar. 22, 2024

(30) Foreign Application Priority Data
Sep. 24, 2021 (GB) 2113701.3

(51) Int. Cl. C08G 8/10; C08G 8/18; C08J 9/14

(52) U.S. Cl. CPC C08G 8/10; C08G 8/18; C08J 9/141; C08J 9/145; C08J 9/149; C08J 2203/14; C08J 2203/142; C08J 2203/182; C08J 2361/10

(57) ABSTRACT

A foam product comprising an expanded foam body having cells defined therein and blowing agent held within the cells, wherein at least 5% by weight of the foam body is formed from at least one component from a renewable source.

### FIELD

The invention relates to foam products in particular insulation foams and their production. Of particular interest are foam products which have a low environmental impact yet which have good insulation performances. Of interest are highly sustainable closed cell foam insulation foam products. Phenolic foam products based on the condensation of phenolic structures and aldehyde, a composition for forming this sustainable insulation foam, and the use of this sustainable foam are also of interest.

### BACKGROUND

In the Paris Agreement, ratified in 2016, long-term goals were agreed to avoid dangerous climate change by limiting a global temperature rise this century to below 2 degrees Celsius, above pre-industrial levels and to pursue efforts to limit the temperature increase even further to 1.5 degrees Celsius. Action is required to achieve these goals and one of the fields where significant improvements can be made, are in buildings.

Buildings and their construction together account for 36 percent of global energy use and 39 percent of energy-related carbon dioxide emissions annually, according to the United Nations Environment Program. According to the U.S. Energy Information Administration, residential and commercial buildings account for 40 percent of energy consumption. Also in the EU, nearly 40 percent of final energy consumption and 36 percent of greenhouse gas emissions results from houses, offices, shops and other buildings. Therefore, improving the energy performance of the building stock is crucial to limit global warming.

The use of insulation materials such as closed cell foam insulation materials such as closed cell foam products play an important role in the aim to reduce the energy consumption of buildings. Closed cell foam insulation materials, like for example polyisocyanurate (PIR), polyurethane (PUR), extruded polystyrene (XPS) and phenolic or phenol-formaldehyde (PF) foam, offer improved thermal insulation performance at comparable insulation thickness compared to more traditional insulation materials like Man Made Mineral Fibre (MMMF) insulation (such as refractory ceramic fibres (RCF), glass fibres, glass wool, rock wool, slag wool and glass filaments) and Expanded Polystyrene (EPS).

Closed cell foam insulation materials offer solutions to reduce energy consumption in the renovation of the existing buildings. The space available to install insulation material in many situations is limited by the existing construction. The use of closed cell PF insulation material (Low thermal conductivity PF: λ=0.018 W/m·K) can roughly halve the heat loss when compared to the same thickness of traditional insulation material (Higher thermal conductivity MMMF: λ=0.038 W/m·K) is installed.

High performance insulation materials, for example vacuum insulation panels, nano particle and aerogel insulation materials offer even higher thermal insulation performance compared to closed cell insulation materials, but the price to performance ratio of these insulation materials makes them less attractive from a commercial viewpoint. For vacuum insulation panels, an additional disadvantage is the inability to shape these products as needed on the building site.

Notwithstanding the foregoing there is need to provide materials that would lower environmental impact. In particular there is a need to provide insulation materials that offer good thermal insulation performance yet have low environmental impact.

### SUMMARY OF THE INVENTION

The ability to renovate existing buildings without the need to make significant changes to their construction, will not only reduce energy losses but will also reduce the consumption of materials used to construct replacement buildings. 50 percent of all raw materials are used for construction purposes. Upgrading the existing building stock to net-zero energy consumption levels, will significantly accelerate energy saving in an environmentally friendly way.

The present invention is based on the use of closed cell foam insulation materials to have a very positive impact on the energy consumption of buildings.

The present invention provides a foam product as set out in the claims.

The present invention relates to a foam product comprising an expanded foam body

having cells defined therein and blowing agent held within the cells, wherein at least 5% by weight of the foam body is formed from at least one component from a renewable source and optionally wherein the average thermal conductivity of the foam product over a 25 year life span of the product is 0.025 W/m·K or less as measured according to EN 12667 or EN 12939.

The at least one component from a renewable source may also form at least 5% by weight of a foamable composition from which the foam product is made. In general, the amounts given for the at least one component from a renewable source may also be applied to the amounts in the foamable composition from which the foam product is made.

A renewable source is a natural resource that can replenish itself in a limited time, preferably within several months, although years, or at maximum a few decades, may be acceptable as well.

Additionally or alternatively the present invention relates to a foam product comprising an expanded foam body having cells defined therein and blowing agent held within the cells, wherein at least 5% by weight of the foam body is formed from at least one component from a renewable source and optionally wherein the average thermal conductivity of the foam product over a 50 year life span of the product is 0.026 W/m·K or less as measured according to EN 12667 or EN 12939.

Additionally or alternatively the present invention relates to a foam product comprising an expanded foam body having cells defined therein and blowing agent held within the cells, wherein at least 5% by weight of the foam body is formed from at least one component from a renewable source and optionally wherein the average thermal conductivity of the foam product over a 25 year life span of the product is 0.025 W/m·K or less as measured according to EN13166 and/or EN14314.

Additionally or alternatively the present invention relates to a foam product comprising an expanded foam body having cells defined therein and blowing agent held within the cells, wherein at least 5% by weight of the foam body is formed from at least one component from a renewable source and optionally wherein the average thermal conductivity of the foam product over a 50 year life span of the product is 0.026 W/m·K or less as measured according to EN13166 and/or EN14314.

Additionally or alternatively the present invention may relate to a foam product comprising an expanded foam body having closed cells, and blowing agent held within the cells, wherein the foam body is formed form at least one component from a renewable source, and the foam body has a total GWP for the Cradle-to-gate stages (A1 till A3), below 1.0 kg CO₂ eq/kg (as determined in accordance with EN 16783:2017).

Additionally or alternatively the present invention may relate to a foam product comprising an expanded foam body having cells defined therein and blowing agent held within the cells, wherein the foam body comprises cardanol, rosin, or a polyol derived from: polyethylene terephthalate; polyurethane; and/or polyisocyanurate; or any combination thereof as plasticiser. A polyol is any compound containing at least two hydroxyl functional groups, aliphatic and/or aromatic OH.

Additionally or alternatively the present invention may relate to a foam product comprising an expanded foam body having cells defined therein and blowing agent held within the cells, wherein at least 5% by weight of the foam body is formed from at least one component from a renewable source and wherein the at least one component comprises technical lignin originating from paper and pulp processes. For example, technical lignin originating from paper and pulp processes may be kraft lignin, soda lignin, or lignosulphonate.

Additionally or alternatively the present invention may relate to a foam product comprising an expanded foam body having cells defined therein and blowing agent held within the cells, wherein at least 5% by weight of the foam body is formed from at least one component from a renewable source and wherein the at least one component comprises soda lignin.

Additionally or alternatively the present invention may relate to a foam product comprising an expanded foam body having cells defined therein and blowing agent held within the cells, wherein at least 5% by weight of the foam body is formed from at least one component from a renewable source and wherein the at least one component comprises an organosolv lignin.

Additionally or alternatively the present invention may relate to a foam product comprising an expanded foam body having cells defined therein and blowing agent held within the cells, wherein at least 5% by weight of the foam body is formed from at least one component from a renewable source and wherein the at least one component comprises a depolymerised lignin.

Additionally or alternatively the present invention may relate to a foam product having an expanded foam body having cells defined therein and blowing agent held within the cells, wherein at least 5% by weight of the foam body is formed from at least one component from a renewable source and wherein the at least one component comprises a sulphonated and/or phenolated lignin.

Additionally or alternatively the at least one component from a renewable source

comprises a sulfonated Kraft lignin.

The percentage by weight of sulfur in the sulfonated Kraft lignin may be at least 2% by weight of the Kraft lignin.

The sulfonated Kraft lignin may have a molecular weight from about 2,000 to about 23,000 Daltons (Da).

The at least one component from a renewable source may comprise a phenolated lignin. Without wishing to be bound by theory, phenolated lignin may enhance the reactivity of lignin during the production of a foam product. Phenolated lignins may be pyrolytic lignin, technical lignin originating from paper and/or pulp processes, soda lignin, organosolv lignin, depolymerised lignin, Kraft lignin, or a combination thereof. Wherein the at least one component from a renewable source comprises a phenolated lignin the foam may be a phenolic foam.

The at least one component from a renewable source may comprise a pyrolytic lignin.

Additionally or alternatively the present invention may relate to a foam product comprising an expanded foam body having cells defined therein and blowing agent held within the cells, wherein the foam body is formed from the reaction of phenolic material and formaldehyde and at least 10%, for example at least 20%, such as at least 30%, for example at least 40% desirably at least 50% by weight of the formaldehyde utilised is a bio-formaldehyde.

The bio-formaldehyde may be produced from bio-methanol. Optionally the bio-methanol is produced by fermentation of bio-waste. The bio-methanol may be produced from syngas (synthetic gas) for example syngas obtained by gasification of bio-waste such as forestry waste.

Additionally or alternatively the present invention may relate to a foam product comprising an expanded foam body having cells defined therein and blowing agent held within the cells, wherein the foam body is formed from a reaction with a phenol wherein at least 10% for example at least 15% such as at least 20% such as at least 25% by weight of the phenol is formed from bio-phenol. The bio-phenol may be produced from bio-benzene. The bio-phenol may be produced from bio-benzene optionally by means of pyrolysis of bio-waste such as wood materials including wood waste and by-products of wood processing such as in paper production. The bio-phenol may be produced from tall oil.

It will be appreciated that all of the components mentioned above as components of the foam product of the invention may be combined in any combination to form a foam product of the invention.

Suitably at least 7% by weight of the foam body is formed from at least one component from a renewable source, such as at least 10%, for example at least 15%, desirably at least 20%, optionally at least 25%, for example at least 30%.

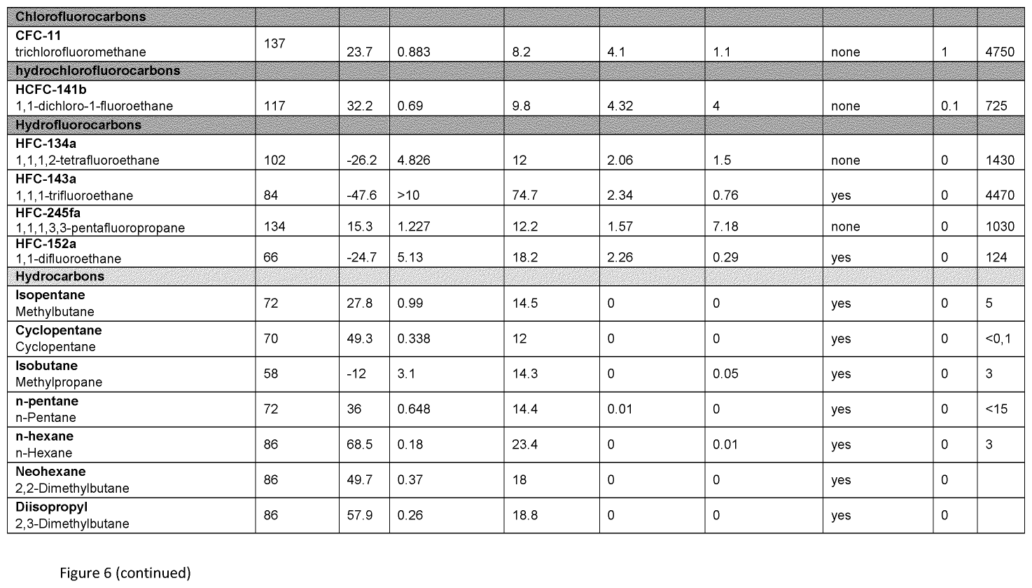

Desirably at least 70% of the blowing agent (based on the total weight of blowing agent) has a thermal conductivity in the gas phase at 25° C. of 12 mW/m·k or less for example 11.8 mW/m·k. A table of suitable blowing agents is shown in FIG. 6 which can be used individually or in any suitable combination.

Optionally the weight of the at least one component from a renewable source comprises carbon and is measured according to EN16640: 2017 and is based on a C¹⁴ measurement.

The foam body may have a C¹⁴ carbon content of greater than 3% as measured according to EN16640: 2017, for example a C¹⁴ carbon content of greater than 3.5%, 4%, 5%, 6%, 7%, 8%, 9%, 10%, 30%, or 50%. The foam body having a C¹⁴ carbon content of greater than 3% as measured according to EN16640: 2017, for example a C¹⁴ carbon content of greater than 3.5%, 4%, 5%, 6%, 7%, 8%, 9%, 10%, 30%, or 50% may be a phenolic foam body.

Desirably for any foam product of the invention the average thermal conductivity of the foam product over a 25 year life span of the product is 0.025 W/m·K or less as measured according to as determined in accordance with EN 16783:2017; and/or
the average thermal conductivity of the foam product over a 50 year life span of the product is 0.026 W/m·K or less as measured according to as determined in accordance with EN 16783:2017; and/or
wherein the total Global Warming Potential of the foam product is equal or less than 1.7 kg CO₂ eq./kg; such as equal or less than 1.5 kg CO₂ eq./kg; for example equal to or less than-0.5kg CO₂ eq./kg; as determined in accordance with EN 16783:2017; and/or
wherein the biogenic Global Warming Potential of the product is equal to or less than-0.2 kg CO₂ eq./kg; such as equal to or less than-0.4 kg CO₂ eq./kg as determined in accordance with EN 16783:2017; and/or
wherein in the foam product the components which form the foam body have renewable primary energy resources equal or less than 0.7 MJ/kg as determined in accordance with EN 16783:2017.

Biogenic global warming potential (GWP-biogenic) according to EN15804+A2 accounts for GWP from removals of CO2 into biomass from all sources except native forests, as transfer of carbon, sequestered by living biomass, from nature into the product system declared as GWP-biogenic. GWP-biogenic also accounts for GWP from transfers of any biogenic carbon from previous product systems into the product system under study. Fossil global warming potential (GWP-fossil) according to EN15804+A2 accounts for GWP from greenhouse gas emissions and removals to any media originating from the oxidation or reduction of fossil fuels or materials containing fossil carbon by means of their transformation or degradation (e.g. combustion, incineration, landfilling, etc.). GWP-fossil also accounts for GWP from GHG emissions e.g. from peat and calcination as well as GHG removals e.g. from carbonation of cement-based materials and lime.

A foam product according to the present invention desirably exhibits a fire performance that is a flame height <100 mm in a single flame source test as determined by EN ISO 11925-2.

A foam product according to the present invention desirably has a closed cell content of at least 90%, for example at least 92%, such as at least 94% optionally at least 95% as determined by EN ISO 4590.

A foam product according to the present invention desirably has a friability below 20% as measured by ASTM C421-08 (2014).

A foam product according to the present invention desirably has a compressive strength of 100 kPa or greater as measured by EN 826:2013.

A foam product according to the present invention desirably has a density of 10 kg/m³ up to 125 kg/m³ such as a density of from about 15 kg/m³ to about 100 kg/m³, preferably of from about 15 kg/m³ to about 60 kg/m³, suitably from about 20 kg/m³ to about 35 kg/m³ as determined by EN 1602:2013.

The foam product of the present invention may be a phenolic foam product.

The foam product of the present invention may be a polyisocyanurate (PIR) foam product, polyurethane (PUR) foam product, extruded polystyrene (XPS) foam product or Expanded Polystyrene (EPS) foam product. Such foam products desirably comprise a lignin component as described herein.

The present invention also relates to the use of lignin as a colour imparting additive in a foam product comprising an expanded foam body having cells defined therein and blowing agent held within the cells; and/or use of lignin as a colour stabilising additive in a foam product comprising an expanded foam body having cells defined therein and blowing agent held within the cells.

The present invention also relates to a method of preparing a high sustainable thermosetting foam with excellent thermal, mechanical and fire properties based on the use of natural polyphenols, more particular sulphonated and/or phenolated lignin, and the use of formaldehyde produced from bio-methanol. The method includes the steps of a) producing a prepolymer by condensation of a mix of fossil phenol monomer and at least 20 wt % of at least one natural polyphenol on total phenolic compound mix and formaldehyde in a ratio of 1:1.5 to 1:2.5 using an alkaline catalyst; 0.15 to 5 wt % at a reaction temperature between 50° C. and 100° C. b) adding 2 to 10 wt % of one or more surfactants/emulsifiers and mixtures thereof, c) adding 2 to 10% of one or more plastifying additives (plasticisers) and mixtures thereof, d) adding 0.1 to 2% of one or more nucleating agents and mixtures thereof, e) adding 1 to 10 wt % of one or more blowing agents and mixtures thereof, f) adding 10 to 20 wt % of a curing agent and g) a curing phase. All weight % (wt%) related to the total raw material input.

### DETAILED DESCRIPTION OF THE INVENTION

To evaluate the overall contribution of insulation materials to the environment, the full product life cycle needs to be taken into account. The Environmental Product Declaration (EPD) according to EN16783:2017, which defines the specific product category rules for thermal insulation products based on the rules for construction products established in EN 15804:2012+A2: 2019. Therefore, these rules are a measure for the impact of the insulation products on the environment. EPD's according to EN 15804:2012+A2: 2019 must also comply with the requirements of ISO 14044:2006+A1: 2018, the International Life Cycle Assessment (LCA) standard, and ISO 14025:2010 and ISO 21930:2017, the International standards covering EPD for construction products. These three standards, together with the more detailed requirements of EN 15804:2012+A2: 2019/EN16783:2017 in terms of exact application of LCA Life Cycle Assessment principles, make it possible to compare results for various insulation product types.

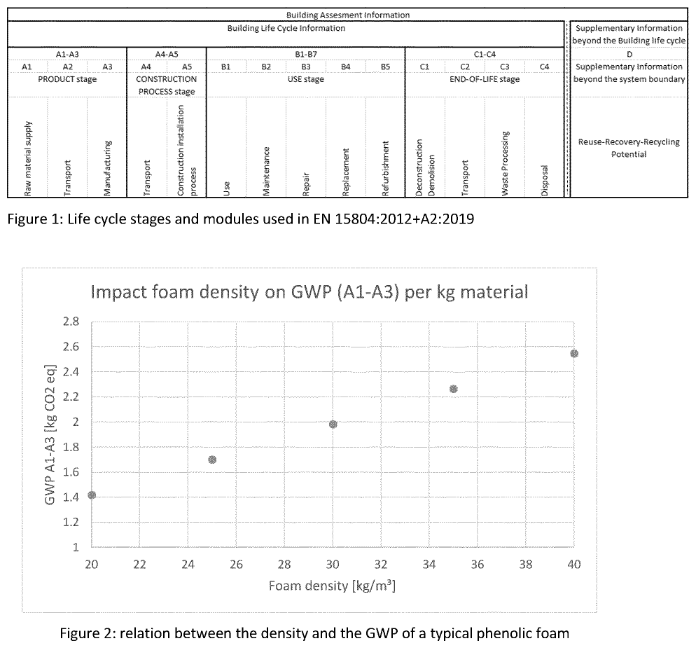

The EPD provides life cycle impact assessment (LCA) data for the product in a series of modules covering the various life cycle stages, described in FIG. 1.

The product stage (cradle to gate), modules A1-A3, are the most relevant stages to quantify the impact of the renewable content on the insulation product. The stages A4-A5 are related to the construction process of the building. The use stages (B1-87) are not relevant for insulation materials. The end-of-life stages (C1-C4) and supplementary module D relate to the demolishing of the building/recycling of the insulation material.

The output parameters of the EPD, can be divided into 4 different categories; core environmental impact indicators (Table 1), indicators describing resource use (Table 2), environmental information describing waste categories and output flows and additional environmental impact indicators.

TABLE 1
Core Environmental Impact Indicators in EN 15804: 2012 + A2: 2019
1. Core Environmental Impact Indicators

| | | | |
|---|---|---|---|
| 1.1 | GWP - total | [kg CO₂ eq] | Global Warming potential |
| 1.2 | GWP - fossil | [kg CO₂ eq] | Global Warming potential (fossil fuel only) |
| 1.3 | GWP - biogenic | [kg CO₂ eq] | Global Warming potential (biogenic) |
| 1.4 | GWP - luluc | [kg CO₂ eq] | Global Warming potential (land use only) |
| 1.5 | ODP | [kg CFC-11 eq] | Ozone Depletion potential |
| 1.6 | AP | [mole of H⁺ eq] | Acidification terrestrial and freshwater |
| 1.7 | EP - freshwater | [kg of P eq] | Eutrophication potential (freshwater) |
| 1.8 | EP - marine | [kg of N eq] | Eutrophication potentiel (marine) |
| 1.3 | EP - terrestrial | [mole of N eq] | Eutrophication potential (terrestrial) |
| 2.0 | POCP | [kg NMVOC eq] | Photochemical Ozone formation |
| 2.1 | ADPF | [MJ] | Abiotic Depletion potential (fossil) |
| 2.2 | ADPE | [kg Sb eq.] | Abiotic Depletion potential (element) |
| 2.3 | WDP | [m³ world eq] | Water Scarcity |

The indicator GWP-total indicates the total potential contribution to global warming in kg CO₂ per functional unit. A functional unit is also known as a declared unit.

Within the module A1-A3, an increase of the amount of renewable raw materials will result in a decrease of the GWP-total, due to the amount of embodied Carbon in the raw materials.

TABLE 2
Indicators describing resource use in EN 15804: 2012 + A2: 2019
2. Indicators describing resource use

| | | | |
|---|---|---|---|
| 2.1 | PERE | [MJ] | Use of renewable primary energy excluding |
| | | | renewable primary energy resources |
| | | | used as raw materials |
| 2.2 | PERM | [MJ] | Use of renewable primary energy |
| | | | resources used as raw materials |
| 2.3 | PERT | [MJ] | Total use of renewable |
| | | | primary energy resources |
| 2.4 | PENRE | [MJ] | Use of non-renewable primary energy |
| | | | excluding non-renewable primary energy |
| | | | resources used as raw materials |
| 2.5 | PENRM | [MJ] | Use of non-renewable primary energy |
| | | | resources used as raw materials |
| 2.6 | PERNT | [MJ] | Total use of non renewable |
| | | | primary energy resources |
| 2.7 | SM | [kg] | Use of secondary material |
| 2.8 | RSF | [MJ] | Use of renewable fuels |
| 2.S | NRSF | [MJ] | Use of non-renewable fuels |
| 2.1 | FW | [m³] | Use of net fresh water |

The indicator PERM quantifies the use of renewable primary energy resources used as raw materials and PENRM quantifies the use of non-renewable primary energy resources used as raw materials. PERT and PENRT are the sum from primary energy from primary energy resources and primary energy resources used as raw materials. In case the amount of renewable raw materials increases compared to non-renewable raw materials, the indicator PERM will increase while PENRM will decrease.

As both traditional PIR and PF closed cell foam insulation materials are to a large extent produced from fossil based raw materials, the embodied CO₂ expressed by the GWP contribution and PERNT are relative high.

Renewable insulation materials derived from agricultural or forestry source have relative low environmental impact during the production stage compared to fossil based materials. It should be noted that the word ‘renewable’ is specially used in reference to lower embodied energy and embodied carbon of these materials. Examples of renewable insulation materials are:

TABLE 3
Thermal conductivity of renewable insulation materials

| | | Thermal | Specific Heat |
|---|---|---|---|
| | Density | Conductivity | capacity |
| Insulation material | [kg/m³] | [W/m · K] | [J/g · K] |
| Cork | 100-120 | 0.037-0.043 | 1.5-1.7 |
| Cellulose | 30-80 | 0.037-0.042 | 1.3-1.6 |
| Flax | 20-100 | 0.033-0.090 | 1.6 |
| Hemp | 25-100 | 0.039-0.123 | 1.7-1.8 |
| Kenaf | 30-180 | 0.033-0.044 | 0.2-1.7 |
| Reeds | 130-190 | 0.045-0.056 | 1.2 |
| Sun flower | 36-152 | 0.038-0.050 | — |
| Rice husk | 130-170 | 0.048-0.080 | 1.2-2.7 |
| Coir fibres | 75-125 | 0.040-0.045 | 1.3-1.6 |
| Bagasse | 250-350 | 0.049-0.055 | 1.3-1.5 |
| Coffee Chaff | 350 | 0.076 | — |
| Jute fibre | — | 0.050 | — |
| Cotton stalks | 150-450 | 0.058-0.082 | 0.13 |
| Wood wool (fibre) | 50-270 | 0.038-0.050 | 1.9-2.1 |
| Sheep wool | 10-20 | 0.038-0.054 | 1.3-1.7 |

All these materials have a relative high thermal conductivity (λ). This means that relative thick layers of insulation material need to be installed to obtain sufficient thermal insulation performance.

The thermal conductivity (lambda value) of closed cell foam insulation materials, is significantly lower compared to these renewable insulation materials. A thinner insulation material means that less material is needed to insulate. This has to be taken into account when the EPD's are compared as the functional unit should be based on the insulation performance, rather than the weight or volume of the product.

TABLE 4
General thermal conductivity of closed
cell foam insulation materials

| | | Thermal | Specific Heat |
|---|---|---|---|
| | Density | Conductivity | capacity |
| Insulation material | [kg/m³] | [W/m · K] | [J/g · K] |
| Polyurethane foam | 30-180 | 0.022-0.035 | 1.3-1.45 |
| Polyisocyanurate foam | 30-45 | 0.018-0.028 | 1.4-1.5 |
| Extruded Polystyrene foam | 32-40 | 0.032-0.037 | 1.45-1.7 |
| Phenol Formaldehyde foam | 40-160 | 0.018-0.024 | 1.3-1.4 |

The importance of the thermal insulation performance on the total GHG (Green House Gas) footprint can be demonstrated by a concrete sandwich panel. When the insulation layer becomes thicker, also the concrete inner and outer wall need to increase in thickness to maintain the structural strength. When for example the thermal layer increased from 12 to 18 cm, the concrete needs to increase by approximately 10 mm. Concrete has a total GWP of 246 kg CO₂ eq./kg. An increase of 10 mm results in an increase of 24.6 kg CO₂ eq./kg. for the construction, which is more than the total GWP of the insulation product.

Environmental Product Declarations according EN16783:2017 can be published by trade associations or producers (Table 5).

TABLE 5
EPD results for several closed cell foam products

| | | | | Environmental Product Declaration | | | | | | | |
|---|---|---|---|---|---|---|---|---|---|---|---|
| | | | | | | GWP | | | | | |
| | | | Thermal | | | (A1-A3) | PERE | PERM | PENRE | PENRM | |
| | | Density | Conductivity | Functional | Thickness | [kg CO₂ | (A1-A3) | (A1-A3) | (A1-A3) | (A1-A3) | |
| insulation material | | [kg/m³] | [W/m · K] | unit | [mm] | eq.] | [MJ] | [MJ] | [MJ] | [MJ] | Source |
| [symbol] | | 32 | 0.023 | [symbol] | 120 | [symbol] | 24 | 3.1 | 91.5 | 190 | German trade |
| [symbol] | | 31 | 0.023 | [symbol] | 120 | 13.8 | [symbol] | 2.5 | 112 | 199 | association [symbol] |
| [symbol] | | 31 | 0.026 | [symbol] | 120 | [symbol] | 17.1 | 1.2 | 89.9 | 192 | [symbol] |
| [symbol] | | 33 | 0.026 | [symbol] | 120 | 14.8 | 16.3 | 0 | 226 | 99 | |
| [symbol] | foam | 32 | 0.022 | [symbol] | | 7.5 | 4.6 | 0 | 105 | 77 | [symbol] - Federal |
| | facer | n.a. | n.a. | | 80 | 2.2 | 3.5 | 0 | 34 | 0 | Public Service of |
| | total | 32 | 0.023 | | | 9.7 | 8.1 | 0 | 139 | 77 | Health, Food, Safety |
| Comparative value (est.): | | | | | 120 | [symbol] | 12.2 | 0 | 209 | 116 | and Environment |
| [symbol] | foam | 32 | 0.022 | [symbol] | 80 | 7.5 | 4.6 | 0 | 105 | 77 | |
| | facer | n.a. | n.a. | | | 1.0 | [symbol] | 0 | 21 | 0 | |
| | total | 32 | 0.022 | | | 8.5 | [symbol] | 0 | [symbol] | 77 | |
| Comparative value (est.): | | | | | 120 | 12.8 | 23.9 | 0 | 189 | 116 | |
| [symbol] | foam | 30.1 | 0.022 | [symbol] | 80 | [symbol] | 6.1 | 0 | 70 | 77 | [symbol] - Federal |
| | facer | n.a. | n.a. | | | 0.8 | 6.0 | 2.9 | 15 | 6 | Public Service of |
| | total | 30.1 | 0.022 | | | 7.6 | [symbol] | 2.9 | [symbol] | [symbol] | Health, Food, Safety |

| Comparative value (est.): | | | | 120 | 11.4 | 18.2 | 4.4 | 128 | 125 | and Environment |
|---|---|---|---|---|---|---|---|---|---|---|
| [symbol] | 45 | 0.02 | [symbol] | 160 | 34.3 | [symbol] | 0 | [symbol] | 0 | [symbol] |
| Comparative value (est.): | | | | 120 | 25.7 | 23.5 | 0 | 668 | 0 | |
| [symbol] | 35 | 0.02 | [symbol] | 80 | 5.6 | 22.1 | 0 | 82 | 77 | [symbol] |
| Comparative value (est.): | | | | 120 | 8.4 | 33.2 | 0 | 123 | 116 | |
| [symbol] | 38.4 | 0.025-0.027 | [symbol] | 100 | 13.0 | 12.2 | 0 | 203 | 154 | [symbol] |
| Comparative value (est.): | | | | 120 | 15.6 | 14.6 | 0 | 244 | 185 | |
| [symbol] | 34.2 | 0.030-0.040 | [symbol] | 100 | 9.4 | 0.1 | 0 | 139 | 145 | [symbol] |

| | | | | | | |
|---|---|---|---|---|---|---|
| Comparative value (est.): | 120 | 11.3 | 0.1 | 0 | 167 | 174 |

| | | | | Environmental | | | |
|---|---|---|---|---|---|---|---|
| | | | Thermal | Product Declaration | | | |
| | | Density | Conductivity | Functional | | | |
| insulation material | | [kg/m³] | [W/m · K] | unit | Date | Database | standard |
| [symbol] | | 32 | 0.023 | [symbol] | Apr. 1, 2021 | [symbol] | EN15804 + |
| [symbol] | | 31 | 0.023 | [symbol] | Apr. 1, 2021 | | A1 |
| [symbol] | | 31 | 0.026 | [symbol] | Apr. 1, 2021 | | |
| [symbol] | | 33 | 0.026 | [symbol] | Sep. 2, 2016 | | |
| [symbol] | foam | 32 | 0.022 | [symbol] | Apr. 16, 2020 | Ecoinvent | EN15804 + |
| | facer | n.a. | n.a. | | | | A1 |
| | total | 32 | 0.023 | | Apr. 16, 2020 | Ecoinvent | EN15804 + |
| Comparative value (est.): | | | | | | | A1 |
| [symbol] | foam | 32 | 0.022 | [symbol] | | | |
| | facer | n.a. | n.a. | | | | |
| | total | 32 | 0.022 | | | | |
| Comparative value (est.): | | | | | | | |
| [symbol] | foam | 30.1 | 0.022 | [symbol] | Apr. 22, 2021 | Ecoinvent | EN15804 + |
| | facer | n.a. | n.a. | | | | A2 |
| | total | 30.1 | 0.022 | | | | |

| Comparative value (est.): | | | | | | |
|---|---|---|---|---|---|---|
| [symbol] | 45 | 0.02 | [symbol] | Feb. 1, 2019 | Ecoinvent | EN15804 + |
| Comparative value (est.): | | | | | | A1 |
| [symbol] | 35 | 0.02 | [symbol] | Mar. 12, 2021 | [symbol] | EN15804 + |
| Comparative value (est.): | | | | | | A2 |
| [symbol] | 38.4 | 0.025-0.027 | [symbol] | Sep. 15, 2015 | [symbol] | EN15804 + |
| Comparative value (est.): | | | | | | A1 |
| [symbol] | 34.2 | 0.030-0.040 | [symbol] | Mar. 12, 2019 | [symbol] | EN15804 + |

| | |
|---|---|
| Comparative value (est.): | A1 |

[symbol]

indicates data missing or illegible when filed

Comparisons of EPD's is not always straight forward. The functional unit differs for different Insulation products. Table 5 shows that the total GWP of the Kooltherm phenolic insulation foam (8.4 kg CO₂ equivalent) is lower compared to respectively; Recticel (11.4 kg CO₂ equivalent), Unilin (14.6 kg CO₂ equivalent) and values claimed by the German trade association (11.2 kg CO₂ equivalent). Also the thermal insulation performance can differ. A PUR/PIR product, for example, with a thermal conductivity of 0.022 W/m·K and a thickness of 110 mm, results in same insulation performance as a PF foam with a thermal conductivity of 0.020 W/m·K and 100 mm thickness.

The indicator for renewable primary energy resources used as raw materials (PERM) for all foam products in Table 5 is for all products below 5 MJ. This very low contribution is the result of the contribution of the facer (block foam has no facer). The foam has a negligible contribution. The use of non-renewable primary energy resources used as raw materials (PENRM) for faced products is for the Unilin product the lowest at 116 MJ. This is more or less comparable to the Kooltherm foam with a value of 116 MJ. Taking into account the thermal insulation performance, the Kooltherm product would perform 10% better.

When the EPD's of the 2 phenolic foams in Table 5 are compared, it's obvious that the Kooltherm product has a significantly lower GWP environmental impact compared to the Safe R product. This difference is partly caused by the difference in density. The zero value for the PENRM for the Safe R product is assumed to be incorrect as this is technically not feasible.

An XPS product, blown with HFO, from Jackon with a lambda value of 0.025 will require a 25% thicker insulation layer compared to Kooltherm. When we assume a linear increase of the GWP in function of thickness, the GWP would be 19.5 kg CO₂ equivalent (15.6*0.025/0.020), which is more than twice as high.

The GWP of pentane blown XPS (FPX) is lower (11.3 kg CO₂ equivalent), but the lambda is also higher. Assumed a lambda of 0.035 W/m·K, a 75% thicker insulation layer is required. Linear extrapolation, means a GWP of 19.8 kg CO₂ equivalent. In other words, the impact of the blowing agent on the output data of the EPD is limited, but when the thermal insulation performance is taken into account in both cases XPS results in higher CO₂ emissions.

The PENRM indicator for the pentane and HFO blown Jackon product are respectively 145 and 154 MJ at 80 mm thickness. This is higher compared to PIR/PUR and PF foams.

The environmental performance of PIR/PUR, PF and XPS insulation materials can be improved by increasing the renewable content of these products, and also by recycling of the materials at the End-of-life stage. Creating circular business models is complicated as insulation materials in many cases have a life cycle of over 50 years. This relative long product life, will make it difficult to ensure recycling. Also pollution as a result of demolition of the construction is a complicating factor. For this reason in many cases the 50/50 rule is assumed, which means that 50% can be recycled and the other 50% will be disposed of as landfill or burned in a waste incineration plant. When a product contains a relative high renewable content, the energy contribution of the renewable material can possibly be classed as green energy.

Phenolic foams are used in a great variety of applications, due to their combination of superior thermal insulation and fire performance. Both the thermal insulation performance and/or the fire performance of the product may be the main reason for selection of this insulation material. Examples of such applications are cavity wall applications, pipe insulation and internal wall applications. Suitable thermal insulation foams would satisfy the requirements of EN 13166:2012+A2: 2016 and EN14314:2015 specification.

In a cavity wall construction, the insulation boards are installed against the inner wall. In the majority of cases, the insulation boards are fixed by drilling wall ties into the insulation material. In the second stage, the external wall is installed. In a traditional cavity wall, a small air gap between the insulation board and outer wall is maintained to prevent moisture flow from the outer wall into the insulation material. A reflective foil facer (emissivity) in combination with an air gap (for example above 15 mm) may be used to increase the insulation performance. The advantage of a high performing insulation material is a minimisation of the wall thickness. However, the use of renewable insulation materials would optimise the environmental footprint of the construction. A material which combines both aspects would be the preferred solution for this application.

Pipe insulation is used to limit the energy losses in heating, ventilation and air conditioning systems (HVAC). The material produced on-line is a cylindrical shape or is cut into pipe sections from blocks. The inner diameter of the insulation product is dimensioned to closely mate with the outer diameter of the pipe which transports the heating/cooling medium. The insulation thickness depends on the insulation requirements of the installation. The outside of the foam can be faced with an aluminium foil, which acts as a vapour barrier, to prevent accumulation of moisture inside the construction. As space is limited in many cases when a building is renovated, the optimum performance between thermal and the environmental performance is essential.

Internal wall insulation is installed on the inside of a construction. In many cases this application is used to renovate existing buildings, where the construction doesn't allow insulation on the outside of the building. As inner space in a building is scarce, the optimum thermal insulation performance in combination with the lowest thickness is selected in many cases. Due to the low thermal insulation performance of renewable insulation materials, these products are not preferred for this application.

Phenolic foam is produced by expanding and curing a foamable composition prepared by mixing phenolic resin, surfactant, blowing agent and catalyst. Other additives can be optionally mixed into the uncured phenolic resin such as formaldehyde scavengers like urea, plasticisers, flame retardants, neutralisers or pigments.

Phenolic resole resins, are used in the manufacture of phenolic foams. They are condensation polymers of phenol and formaldehyde made under aqueous basic conditions with an excess of formaldehyde and typically at elevated temperatures. In general, phenolic resins used in phenolic foam manufacture are viscous liquids with water concentrations from about 1 to 25 wt %. They have methylol groups as reactive substituents in a condensation polymerisation reaction. Cross-linked phenolic foam may be formed by heating and curing a mixture of phenolic resin, blowing agent, surfactant and acid catalyst. Upon addition of an acid catalyst to a chemical mixture comprising phenolic resin, blowing agent and surfactant, an exothermic reaction occurs between methylol groups and phenolic groups to form methylene bridges between phenolic rings. The methylene bridges cross-link the phenolic polymeric chains, and water of condensation polymerisation is produced. The resole resin composition, the quantity and nature of the acid curing catalyst and the chemical and physical properties of the blowing agent and any surfactant present in the foam reactants greatly influence the ability to control the exothermic reaction and the ability to form closed cell foam.

The amount of water in the reactants that form the foam and in particular the amount of water in the resin may influence the amount and type of acid catalyst required to complete the reaction.

Blowing agents having low thermal conductivity are used to form thermal insulating foams. As the gas volume of a foam may account for up to about 95% of the volume of a foam, the amount and nature of the blowing agent trapped in the foam has a significant impact on the thermal insulating performance of the foam. In order to form thermal insulating foam, a total closed cell content of 90 percent or more is generally required. One of the main determinants in the thermal insulation performance of foam is the ability of the cells of the foam to retain blowing agent having a low thermal conductivity.

The thermal insulation properties of phenolic foam are dependent on the retention of blowing agent, having a low thermal conductivity, in a closed cell structure formed during the formation of the phenolic foam. Important properties of phenolic foam are: foam cell size, which is desirably in a micrometre range, and foam cells which are uniformly distributed, providing a closed cell structure to enhance the thermal insulation properties of phenolic foam products by retention of blowing agents.

Surfactants are generally used in phenolic resin foamable compositions to facilitate the formation of cells which are structurally more stable, which in turn reduces loss of blowing agent from the resulting foam over time. Surfactants may also aid in the emulsification of blowing agent within the phenolic foam resin.

EPD's are calculated for a 50 year life span. For this reason the aged thermal conductivity is of essential importance. The product standards for phenolic foam (EN 13166:2012+A2:2016 and EN14314:2015) specify how to declare a lambda value for a 25 year life span. The EPFA (European Phenolic Foam Association) have published information, that the performance of phenolic foams even after 50 years is maintained.

Bio-based products/materials are materials in which the raw materials are fully or partly from biomass. In this respect the term “bio” is used herein to distinguish from fossil sources. In particular the present invention uses the term bio to refer to materials which are direct product from biomass or are by-products from biomass. For example by-products from paper production are of interest. Paper production involves the treatment of wood (biomass). Desirably the percentage (renewable) content for example organic based content should be higher than 30% by weight.

The vast majority of the raw materials used in the production of phenolic foam are based on fossil sources. This invention is about a foam product which combines excellent thermal and fire performance with a renewable content. For example at least 7% by weight of the foam body is formed from at least one component from a renewable source, such as at least 10%, for example at least 15%, desirably at least 20%, optionally at least 25%, for example at least 30%. The renewable content may be achieved by introducing bio-based formaldehyde (bio-formaldehyde) to replace fossil based formaldehyde. Additionally, fossil based phenol may be replaced by bio-based phenol and/or lignin or a combination thereof.

The type of lignin used is very critical as in general the addition on lignin results in a loss of desirable foam product properties such as low thermal conductivity.

For laminates, an improvement can be achieved by using a facer produced mainly from renewable material. In the present invention the term laminate(s) is used generally for foam products formed in a laminator, for example between two belts. Typically they are formed as continuous profiles (desired thickness and width) and are cut to a desired length as formed. Typically they are formed between upper and lower facers. When cut into discrete lengths they are often called foam boards. Block foams are produced as large blocks and cut to a final desired shape after curing. For block foams any facer(s) may be attached, for example adhered later to the product.

The Global Warming Potential in the Environmental Product Declaration of the inventive foam products of the invention such as phenol/lignin/bio-formaldehyde foam products for the life stages A1-A3 (cradle to gate) is relative low compared to traditional closed cell insulation materials. Indicators describing resource use for the stages A1-A3 use are significantly improved. The PERM indicator is increased together with a reduced PENRM value.

The high renewable content, will have a positive impact on the environmental footprint. Insulation products have a relative long service life, in many cases even over 50 years. This means that the carbon is sequestered in the product over a very long time span. This is important as the rotation of the biomass is an important aspect, especially for slow rotation biomass (e.g. forests). When wood is used to generate energy, the CO₂ released will spend some time in the atmosphere before being sequestered back to growing plants. During this period the CO₂ in the atmosphere will have a warming effect. As a consequence of this temporal scale, for energy generation from wood it could be argued that the net negative emission effect is not immediate, but will only be achieved once the carbon is fixed in the biomass again.

In case an insulation product is burned after demolition of the building, for example in a cement kiln, the natural resource has had the ability to regrow before the product has reached its end-of-life stage. Even when very slow rotation biomass is used, the renewable resource will have had the opportunity to regrow. For this reason, high rotation biomass is preferred.

The GWP (Global Warming Potential) of a foam such as a PF foam depends on the contribution of the different components in the product. As the phenolic-formaldehyde resin is the main component of the foam forming composition, the resin contributes to over 60% to the total product.

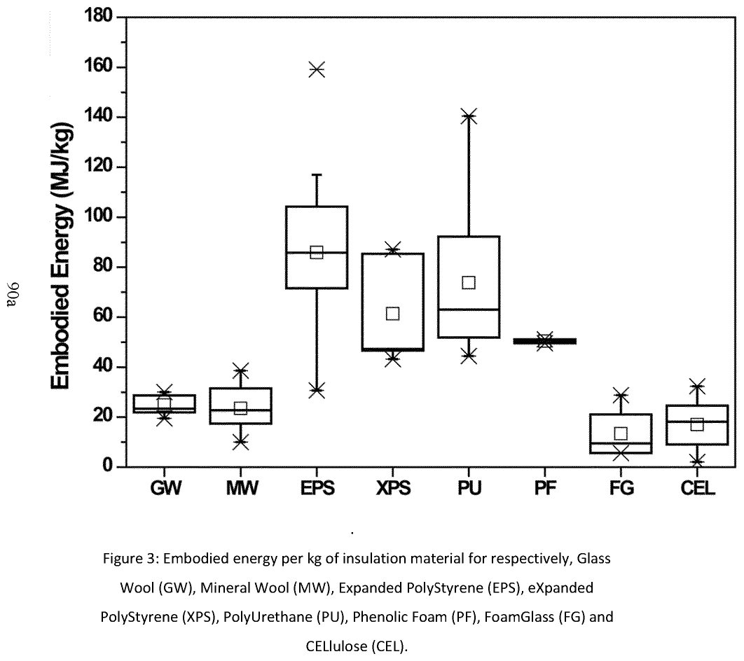

The density of the foam such as a phenolic foam also affects the GWP rating in the EPD of the phenolic foam product. FIG. 2 shows that the GWP reduces proportional with the density of the product.

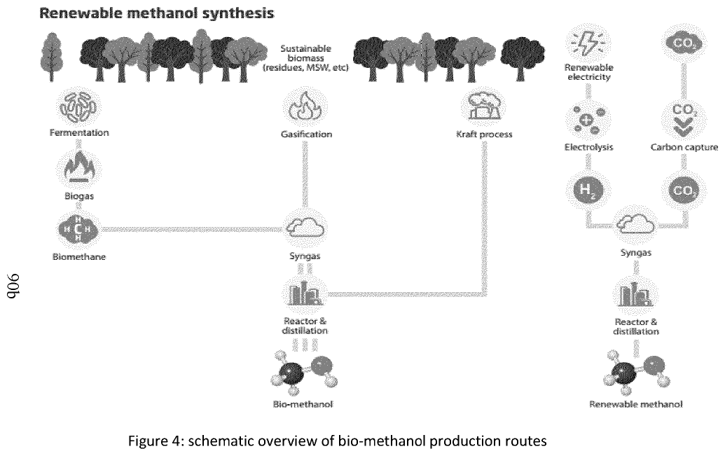

To exclude the effect of the density the functional unit will be 1 kg of insulation material. The graph in FIG. 3 shows that the embodied energy of closed cell insulation materials and EPS is significantly higher compared to the other insulants in the graph.

The technical challenge is that replacement of fossil based raw materials in many cases leads to a loss in performance or a product which is commercially non-viable. The main challenge is to maintain the excellent thermal insulation performance to well below the lambda of traditional renewable materials. Also an excellent fire performance is essential. These problems are solved by the present invention.

According to the invention there is provided a phenol/lignin/bio-based formaldehyde (bio-formaldehyde) foam product formed from a composition comprising:
phenol (optionally, one or more of bio-based phenol (bio-phenol); lignin; bio-based urea; bio-formaldehyde resin (optionally in combination with fossil raw materials),
a blowing agent,
an acid catalyst,
a surfactant, and
optionally other additives.
   The resin can comprise a bio-formaldehyde produced from bio-methanol and/or bio-phenol. The bio-phenol can be produced from bio-based benzene. The phenol can be replaced partly or fully by lignin.

The resulting product has a renewable content at least 7% by weight of the foam body is formed from at least one component from a renewable source, such as at least 10%, for example at least 15%, desirably at least 20%, optionally at least 25%, for example at least 30%. By combining the bio-based components, the renewable content can be increased to at least 30 wt %, 40 wt % or even at least 50% (all by weight). For laminates such as phenolic foam boards, the right selection of the facer can even increase the renewable content above 70 wt %.

The composition from which a renewable foam product of the present invention is formed may comprise a resin of phenolic structures and aldehyde. The phenolic resin may have a molar ratio of phenol groups to aldehyde groups in the range of from about 1:1.5 to about 1:2.5, such as about 1:1.6 to about 1:2.4, including 1:1.7 to about 1:1.2.3 for example from about 1:1.8 to about 1:2.2.

The preferred aldehyde is formaldehyde produced from bio-methanol. The bio-methanol can be produced by fermentation or gasification of biomass. The maximum level of crops cultivated for energy generation is limited to 75 wt %. At high levels of energy cultivated crops, the impact of fertilisers on the LCA of the bio-methanol will become negative.

Lignin is the most abundant resource of naturally occurring phenolic materials, and typically comprises 15-30 wt % of plant biomass. Unfortunately, it is in the form of a complex and recalcitrant polymer, embedded in the strong cell walls of plants. Hence, integrating this renewable resource in the chemical industry is a challenging task. A broad range of different lignins exist, each with their own unique characteristics, dependent on biomass type, lignin isolation process, and down-stream treatment. There are two main groups of lignin: paper and pulp lignins which are recovered from the waste stream of the paper pulping process; and the bio-refinery lignins which are the result of refinery processes which process biomass. An overview of different lignins is provided herein.

Kraft lignin—the paper and pulp industry is the largest sector that handles lignin. By far the most dominant chemical pulping process is Kraft pulping, producing more than 90% of the chemical pulp. During Kraft pulping, (hemi)cellulose is separated from lignin with the so called “white liquor”. Kraft lignin can be recovered from the black liquor waste stream. Different technologies are employed on an industrial scale to isolate Kraft lignin. There is simple acid precipitation and the more advanced processes such as the LignoBoost and the LignoForce technology.

Lignosulfonates—originate from sulfite pulping. Although the sulfite process is less important commercially compared to Kraft pulping considering overall global pulp production, lignosulfonates represent the largest volume of lignin being traded globally. Lignosulfonates can also be obtained through sulfonation of isolated Kraft lignin, which is for example performed by Ingevity (USA). By doing so, the degree of lignin sulfonation can be tailored independent of the pulping process.

Soda lignin—a third pulping process is named soda pulping. This process can be regarded as Kraft pulping without the utilization of sulfur containing chemicals. The resulting soda lignin is sulfur-free, but the absence of sulfide ions during pulping makes the process less efficient.

Hydrolysis lignin—cellulosic bio-ethanol is typically targeted through hydrolysis of the carbohydrate fraction of biomass, followed by enzymatic fermentation of the released sugars. The lignin-fraction is retrieved as a water-insoluble residue. These so-called “hydrolysis lignins” generally have a low purity, and are characterized by a high content of residual carbohydrates.

Organosolv lignin—raw biomass is treated with an organic solvent, which optionally contains water and/or catalytic amounts of acid/base. The treatment is performed at elevated temperature (100-210° C.), which effectuates lignin solvolysis and extraction. Afterwards, the lignin-containing liquor is separated from the carbohydrate-enriched pulp. The lignin can be isolated as a solid powder via solvent evaporation and/or precipitation in water.

Biomass solubilization lignin—produced through the complete solubilization of biomass in a liquid medium, followed by selective precipitation of the main biomass constituents.

Depolymerized lignins—the pulping and bio-refinery processes outlined above provide a lignin polymer, often in the form of a powder. In searching for an increase in value, lignin depolymerization is receiving increasing interest. Numerous depolymerization methods have been proposed, which can be categorized under the following terms: acid-catalysed, base-catalysed, oxidative, reductive, and thermal depolymerization. The depolymerized lignin comprises lignin oligomers, with a lower average molecular weight compared to the parent material. In addition, the depolymerized lignin can contain lignin monomers. The amount and structure of the monomers heavily depend on the depolymerization technique and feedstock.

The resin compositions such as the phenolic resin compositions for forming foam products of the invention may have a water content of from about 4 wt % to about 20 wt %, preferably from about 5 wt % to about 19 wt %, suitably from about 8 wt % to about 19 wt %, based on the total weight of the phenolic resin, prior to curing the foam formed by the composition. The water content is measured by dissolving the resin in the range of 25% by mass to 75% by mass in dehydrated methanol (manufactured by Honeywell Speciality Chemicals). The water content of the resin such as the phenol resin was calculated from the water amount measured by this method. The instrument used for measurement was a Metrohm 870 KF Titrino Plus. For the measurement of the water amount, Hydranal™ Composite 5, manufactured by Honeywell Speciality Chemicals was used as the Karl-Fischer reagent, and Hydranal™ Methanol Rapid, manufactured by Honeywell Speciality Chemicals, was used for the Karl-Fischer titration. For measurement of the titre of the Karl-Fischer reagent, Hydranal™ Water Standard 10.0, manufactured by Honeywell Speciality Chemicals, was used. The water amount measured was determined by method KFT IPol, and the titre of the Karl-Fischer reagent was determined by method Titer IPol, set in the apparatus.

The resin such as a phenolic resin may have a viscosity of from about 1,500 to about 200,000 cPs at 25° C., preferably 1,500 to 100,000 cPs, preferably 1,500 to 50,000 cPs and preferably 1,500 to 25,000 cPs. (cPs is centipoise). The viscosity of a resin employed in the manufacture of a foam product of the present invention may be determined by methods known to the person skilled in the art, for example using a Brookfield viscometer (model DV-II+Pro) with a controlled temperature water bath, maintaining the sample temperature at 25° C., with spindle number SC4-29 rotating at 20 rpm or appropriate rotation speed and spindle type or suitable test temperature to maintain an acceptable mid-range torque for viscosity reading accuracy.

A phenolic resin may have a low free formaldehyde content of from about 0.1% to about 3.0% as a wt % of the phenolic resin, preferably 0.1% to about 0.5% as a wt % of the phenolic resin, preferably from about 0.1% to about 0.3% as a wt % of the total resin when measured by potentiometric titration according to ISO 11402:2004 using hydroxylamine hydrochloride procedure. A free formaldehyde content of from about 0.1% to about 0.5% as a wt % of the total resin is desirable.

In one embodiment, a phenolic foam comprises an organic modifier for co-reacting with the phenolic resin. The modifier may comprise 1 to 10 parts by weight of a compound having an amino group per 100 parts by weight of phenolic resin. In one case at least one amino group containing compound is selected from urea, dicyandiamide and melamine.

Surfactants affect foam structure and are used to provide stability to the cells of the foam. Surfactants act as surface active agents by lowering the surface tension of the liquid phase of the phenolic resin and by providing an interface between the highly polar phenolic resin and the relatively less polar blowing agent. The formation of closed cells is driven by the internal pressure of the expansion of the blowing agent and is counteracted by the surface tension of the liquid phase of the phenolic resin.

Suitably, the composition to form a foam product of the invention comprises surfactant in an amount of from about 0.5 to about 10 parts by weight per 100 parts of the phenolic resin, suitably, the surfactant may be present in an amount of from about 1 to about 8 parts by weight per 100 parts by weight of the phenolic resin, for example 2 to 6 parts by weight, for example 3 to 5 parts by weight of the phenolic resin.

The surfactant may be a castor oil-ethylene oxide adduct, for example wherein more than 20 moles but less than 80 moles of ethylene oxide are added per 1 mole of castor oil. The surfactant may comprise a polysiloxane wherein the polysiloxane has a molecular weight of from about 10,000 to about 30,000 g/mol. The surfactant may be a combination such as a blend of a castor oil ethylene adduct and a polysiloxane as described above.

The composition from which a foam product of the invention such as a phenolic foam product of the invention is formed suitably comprises a blowing agent.

The blowing agent may comprise a C₁-C₇ hydrocarbon. C₁-C₇ hydrocarbons are advantageous as blowing agents as they have low thermal conductivity, may be used to form closed cell foams having stable excellent thermal insulation performance, and have low environmental impact. They are also relatively low cost.

The blowing agent may comprise a C₁-C₇ hydrocarbon, the C₁-C₇ hydrocarbon comprising at least one of butane, pentane, hexane, heptane, and isomers thereof. Desirably, the butane is isobutane or cyclobutane. Desirably the pentane is isopentane or cyclopentane.

The blowing agent may comprise a C₂-C₅ halogenated hydrocarbon, for example, the blowing agent may comprise a chlorinated aliphatic hydrocarbon, for example the blowing agent may comprise a chlorinated aliphatic saturated or unsaturated hydrocarbon. Suitably, the chlorinated aliphatic hydrocarbon having from 2 to 5 carbon atoms will have from 1 to 4 chlorine atoms. Suitably, the chlorinated aliphatic hydrocarbon containing 2 to 5 carbon atoms is selected from the group consisting of dichloroethane, 1,2-dichloroethylene, n-propyl chloride, isopropyl chloride, butyl chloride, isobutyl chloride, pentyl chloride, isopentyl chloride, 1,1-dichloroethylene, trichloroethylene, and chloroethylene.

The blowing agent may comprise a halogenated hydroolefin. For example, the blowing agent may comprise a halogenated hydroolefin selected from the group consisting of hydrofluoroolefins and hydrochlorofluoroolefins. Halogenated hydroolefins are advantageous as blowing agents as they have low global warming potential as well as providing excellent thermal insulation properties.

The blowing agent may comprise a combination of said C₁-C₇ hydrocarbons and said halogenated hydroolefins.

The blowing agent may comprise a halogenated hydroolefin which is selected from the group consisting of 1-chloro-3,3,3-trifluoropropene, 1-chloro-2,3,3,3-tetrafluoro-1-propene, 1,3,3,3-tetrafluoro-1-propene, 2,3,3,3-tetrafluoro-1-propene, 1,1,1,4,4,4-hexafluoro-2-butene, 1,1,1,3,3-pentafluoro-2-propene and combinations thereof.

The blowing agent may comprise 1-chloro-3,3,3-trifluoropropene, suitably trans-1-chloro-3,3,3-trifluoropropene or cis-1-chloro-3,3,3-trifluoropropene or combinations thereof, preferably, trans-1-chloro-3,3,3-trifluoropropene.

The blowing agent my comprise trans-1,1,1,4,4,4-hexafluoro-2-butene, cis-1,1,1,4,4,4-hexafluoro-2-butene, cis-1-chloro-3,3,3-trifluoro-1-propene, cis-1-chloro-2,3,3,3-tetrafluoro-1-propene, 2,3,3,3-tetrafluoro-1-propene, 1,3,3,3-tetrafluoro-2-propene, 1,1,1,3,3-pentafluoro-1-propene, trans-1,2-dichoroethylene, or methyl formate or combinations thereof.

The blowing agent may comprise a C₁-C₇ hydrocarbon selected from at least one of, butane, pentane, hexane, heptane, and isomers thereof. The blowing agent may comprise an alkyl halide such as isopropyl chloride.

The blowing agent may comprise a hydrocarbon and additionally a halogenated hydroolefin.

The blowing agent of the composition from which the foam product of the invention is formed may comprise 20% to 80% C₁-C₇ hydrocarbon based on the total weight of the blowing agent of the composition.

The blowing agent of the composition from which the foam product of the invention is formed may comprise 20% to 80% halogenated hydroolefin based on the total weight of the blowing agent of the composition.

The blowing agent may comprise from about 30 wt % to about 50 wt % 1-chloro-3,3,3-trifluoropropene and from about 50 wt % to about 70 wt % C₁-C₇ hydrocarbon based on the total weight of the blowing agent.

Suitably, in the composition from which the foam product of the invention, such as a phenolic foam for example optionally including lignin, is formed, the blowing agent may be present in an amount of from 1 to 20 parts by weight per 100 parts by weight of the phenolic resin. Preferably, in the composition for forming a foam product of the invention, the blowing agent is present in an amount of from 5 to 15 parts by weight per 100 parts by weight of the phenolic resin, for example 8 to 10 parts by weight of the blowing agent per 100 parts by weight of phenolic resin.

The composition from which the foam product of the invention is formed may comprise an acid catalyst wherein the acid catalyst may be an organic acid or an inorganic acid or a combination thereof.

The acid catalyst may comprise an inorganic acid such as sulphuric acid, or phosphoric acid, or an organic acid such as benzene sulphonic acid, xylene sulphonic acid, para-toluene sulphonic acid, naphthol sulphonic acid, phenol sulphonic acid, or similar, or a combination thereof.

The acid catalyst may be present from about 1 to about 20 parts by weight of the acid catalyst per 100 parts by weight of phenolic resin, suitably 5 to 15 parts by weight of the acid catalyst per 100 parts by weight of phenolic resin, suitably 8 to 10 parts by weight of the acid catalyst per 100 parts by weight of phenolic resin.

Besides the above, the foam may contain other additives such as plasticizers, inorganic additives, nucleating agents, microspheres, flame retardants, pigments and neutralising agents.

The resulting product has a total GWP for cradle to gate (A1-A3) below 2.0 (<1.5; <1.0; <0.75; <0.5) kg CO₂ equivalent/kg of foam, calculated in accordance with to EN16783:2017, which defines the specific product category rules for thermal insulation products based on the rules for all construction products established in EN 15804:2012+A2:2019.

The PENRM is reduced below 27.5 MJ/kg and the PERM is increased above 1.5 MJ/kg.

Advantageously, the foam product such as the phenol/lignin/bio-formaldehyde foam of the present invention has a closed cell content of greater than 90%, preferably higher than 95%.

For laminate foam product such as a phenolic foam board, the declared thermal conductivity after ageing for 14 days at 70° C. followed by 14 days at 110° C. and conditioning to stable weight at 23° C./50% R.H. to simulate the average thermal performance after 25 years in application as measured according to EN 13166:2012+A2:2016 (Method 2, Annex C) is less than 0.025 W/m·K, for example less than 0.022 W/m·K, for example less than 0.020 W/m·K for example less than 0.018 W/m·K. To simulate the performance after 50 years in applications, the accelerated ageing at 110° C. was extended to 4 weeks. Alternatively, the standard allows that the product can be aged for 25 weeks at 70° C. followed by conditioning at 23° C., 50% R.H. to simulate the average value after 25 years in application (In the present application R.H. is relative humidity).

For block foam product such as bio-phenol/lignin/bio-formaldehyde foam, the aged thermal conductivity after accelerated ageing for 25 weeks at 70° C. and conditioned to stable weight at 23° C./50% R.H. as measured according is EN14314:2015 (Heat ageing B4, Annex B) is less than 0.025 W/m·K, for example less than 0.022 W/m·K, for example less than 0.020 W/m·K, for example less than 0.018 W/m·K. The ageing for 50 weeks at 70° C. followed by conditioning to stable weight simulates the thermal performance over 50 years.

The combination of excellent thermal insulation performance and low environmental footprint has significant advantages over existing insulating products.

The foam product of the invention such as a phenol/lignin/bio-formaldehyde foam of the present invention may have a pH of from about 3 to about 7 as measured by EN 13468:2001(e). A foam product of the invention such as a phenol/lignin/bio-formaldehyde foam product with a pH in the range from about 3 to about 5 is beneficial as corrosion of metal surfaces in contact with the phenolic foam is unlikely to occur. Foam products having lower pH than 3 may cause corrosion of metal surfaces.

The foam product of the invention such as a phenol/lignin/formaldehyde (and/or combination thereof) bio-based foam product of the present invention may have a density of from about 10 kg/m³ to about 150 kg/m³, preferably from about 15 kg/m³ to about 60 kg/m³, suitably from about 20 kg/m³ to about 35 kg/m³ as measured according to ASTM D1622-14. A foam density in the range from about 10 kg/m³ to about 100 kg/m³ is beneficial as lower density foams contain a greater amount of blowing agent per m³. This is desirable as the blowing agent greatly influences the thermal insulation performance of the foam product.

The foam product of the invention such as a phenol/lignin/formaldehyde (and/or combination thereof) bio-based foam product of the invention may have a compressive strength of from about 80 kPa to about 250 kPa, preferably from about 100 kPa to about 175 kPa as measured by EN 826:2013. A compressive strength of from about 80 kPa to about 220 kPa is desirable as stronger foams, such as phenolic foams, are resistant to compressive damage when used as building insulation.

The foam product of the invention such as a phenol/lignin/formaldehyde (and/or combination thereof) bio-based foam product of the present invention may have a friability of from about 10% to about 50%, preferably from about 10% to about 40% as measured by ASTM C421-88. Lower friability is desirable as the foam, such as a phenolic foam, has a lesser tendency to have surface dust and/or break under stress.

The foam product of the invention such as a phenol/lignin/formaldehyde bio-based foam product desirably has a moisture uptake (Wp) of less than 1 kg/m³ according to EN 1609:2013 and a water vapour permeability (μ) between 20 and 500 according to EN 12086:2013.

Block foam is typically produced without a facer. Laminated foam products such a foam boards are typically produced with a facer (also called a facing). The facing may comprise at least one of glass fibre-non woven fabric, spun bonded-non woven fabric, aluminium foil, bonded-non woven fabric, metal sheet, metal foil, ply wood, hemp, flax, kenaf, jute, calcium silicate-board, plaster board, Kraft or other paper products, cork and wooden board. Typically the facing is applied to upper and/or lower surfaces of the foam product as it is formed. Typically the same facing is used on these opposing faces of the foam product though of course different facings can be employed.

To increase the renewable content of the product, preferred facer materials have a high renewable content like for example cellulose, hemp, flax, kenaf, jute fibres.

A foam product of the invention such as a phenolic/lignin/bio-formaldehyde foam of the invention can be used as a thermal insulation for buildings, installations and transport. Examples of insulation for buildings are flat and pitched roofs, cavity walls, floor, internal wall, ETICS (External Thermal Insulation Composite Systems), rainscreen facades. Examples of installations are Heating, Ventilation and Air Conditioning systems (HVAC) and process equipment. Examples of transport applications are cool/refrigerated trucks and transport containers.

### DETAILED DESCRIPTION OF THE INVENTION

The present invention relates to a foam product for example, based on a phenol/lignin/bio-formaldehyde resin, wherein at least 7% by weight of the foam body is formed from at least one component from a renewable source, such as at least 10%, for example at least 15%, desirably at least 20%, optionally at least 25%, for example at least 30% non-fossil sourced raw materials. The foam product of the invention comprising the use of recycled, bio-based and mineral substances.

Foams based on phenolic resins are used as thermal insulation in building and technical applications. These foams are manufactured based on aqueous resoles processed into a foamed material using a surfactant, a blowing agent and a curing compound in a (dis)continuous foaming process.

Actual manufacturing process of a resole resin for insulation foams consists of condensing phenol compounds and formaldehyde in a ratio from 1.0:1.5 to 1.0:2.5 with the aid of an alkaline catalyst in a range of 0.15 to 5.0 wt % calculated on the total amount of phenol and formaldehyde and at an elevated temperature ranging from 50° C. to 100° C. The condensation is stopped at the required viscosity ranging from 1500 to 50,000 mPa·s at 25° C. by neutralising the mix with an acid. In a final step, the water content of the final resin can be adjusted to the required level ranging from 5 to 20 wt % by adding water or by removing water by distillation under vacuum.

The first monomer in the condensation, polymerisation reaction to manufacture a phenolic resole resin is formaldehyde. This, is produced from methanol. For the conversion of methanol to formaldehyde on an industrial scale, the Formox and Silver process are being used. In the Formox process, methanol is directly oxidized by air over a metal oxide catalyst at a temperature of 470° C.:

2CH₃OH+O₂→2CH₂O+2H₂O

Excess heat is removed with an oil-transfer medium. The product gases are cooled, absorbed in water, and an aqueous 37% formaldehyde solution is obtained. The concentration can be increased by distillation.

In the initial step of the Silver process, methanol is dehydrogenated:

2CH₃OH→2CH₂O+2H₂

There is a secondary combustion of hydrogen:

H₂+½O₂→H₂O

The reaction takes place with air over a crystalline silver catalyst. The reaction occurs at slightly elevated pressure and temperatures of 650-700° C. Controlled amounts of water are fed into the reaction. A 40-50% aqueous formaldehyde solution is obtained, concentrated and purified by distillation.

In general, for each kilogram of bio-formaldehyde produced approximately 1.04 kg of bio-methanol is consumed. The electricity consumption is 0.15 kWh/kg. The CO₂ emissions amount to 0.11 kg CO₂/kg of formaldehyde produced with the generation of 2.3 kg steam.

About 80% of methanol (MeOH) is produced from natural gas. Approximately 17% of the world's methanol production is coal based. A relative small percentage of the methanol is produced from oil. 40% of the annual methanol production of 75 million metric tons is consumed for energy applications (fuel).

Methanol can also be fabricated from alternative feedstock, which includes biomass, waste and by-products from various sectors; such as biogas, sewage, solid waste, glycerin (glycerol) from biodiesel production and black liquor from pulp and paper industry.

Bio-methanol (bio-MeOH) from renewable sources and processes is chemically identical to fossil fuel-based methanol, but can involve significantly lower greenhouse gas emissions during the entire life cycle. In this patent the term ‘bio-methanol’ will be used for both methanol produced from renewable resources as well as produced from captured CO₂.

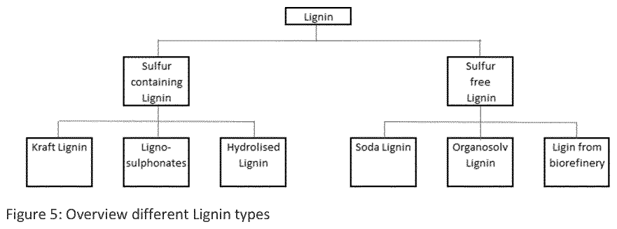

A schematic overview of synthesis routes for bio-methanol is given in FIG. 4.

Production plant configurations/processes of bio-methanol can be divided into several main types. The first process type is used to produce bio-methanol from biogas. (This is similar to a certain extent to methanol production from natural gas). The second process type is the gasification to syngas process, which shows similarities to coal-based methanol production via gasification. The third process type uses a waste stream from the Kraft paper process. The fourth process produces bio-methanol from CO₂ using renewable energy. Besides these processes hybrid and low carbon methanol processes exist also.

Bio-methanol production from biogas has some similarities to the production of methanol from natural gas. Several types of substrates may be used for the generation of biogas, for example biowaste, sewage sludge, liquid manure, co-fermentation of liquid manure and biowaste, grass and crops cultivated for energy generation such as maize/grain. (In the present application the term substrate used in such a context refers to the raw material/feedstock from which the component used in the present invention is derived.)

The raw materials for fermentation are pre-treated (shredding and size separation). The material is mixed with process water and already fermented material in a mixer. Via a heat exchanger the mixture in pumped into the fermenter. The fermentation process is based on anaerobic thermophile dry fermentation between 35 and 50° C. The retention time in the fermenter is approximately 14 days. During the fermentation biogas is produced. The sludge from the fermenter is dewatered and the sludge can be used as fertilizer. The water can be used for agriculture. In general, it is assumed that 0.1 Nm³ of biogas is generated per kg of feedstock.

Surprisingly, the substrate of the biogas used for the production of the formaldehyde has a significant impact on the resulting LCA of the formalin. (Formalin is formaldehyde dissolved in water.) Blogas derived from digestion of crops cultivated for energy production gives the highest score for the most presented non-biogenic emissions and for land occupation. In most cases, it is the supply chain of crops cultivated for energy generation that dominate the emission scores. This is the result of the fact that these input substrates are not modelled as a by-product, but as a raw material with allocated burdens in the chemical substrate generation. In addition, the obtained process waste water and subsequent water treatment dominate or significantly contribute to SO₂-emissions of biogas and Biological Oxygen demand (BOD)-emissions. Emissions of organic water pollutants are measured by the BOD, which refers to the amount of oxygen that bacteria in water will consume in breaking down waste.

For input substrates such as raw sewage sludge, manure and grass all environmental burdens are allocated to other products and services and hence the raw material input is characterized by zero environmental burdens.

Compared to natural gas, raw biogas is a heavy gas and has the presence of incombustible CO₂ and water vapor. The Table 6 below shows the typical composition of biogas:

TABLE 6
Composition of Biogas

| | | Biogas | Methane |
|---|---|---|---|
| | | Mix | 96% |
| Methane | Vol. % | 63.34 | 96.00 |
| Carbon Dioxide | Vol. % | 33.47 | 2.00 |
| Methane | Kg/Nm³ | 0.45244 | 0.68571 |
| Carbon Dioxide | Kg/Nm³ | 0.65713 | 0.03926 |
| Total Carbon Content | Kg/Nm³ | 0.51855 | 0.52499 |
| Nitrogen | Vol. % | 3.17 | 1.00 |
| Density | Kg/Nm³ | 1.15 | 0.75 |
| Lower Heating Value | MJ/Nm³ | 22.73 | 34.45 |

It is essential to remove H₂S (hydrogen sulphide), CO₂ and water. The upgrade of blogas is done via pressure swing adsorption technology (PSA). The raw biogas is first compressed and lead in the H₂S removal reactor. The H₂S removal is based on the principle of cracking the H₂S-molecule on an activated carbon surface at temperatures of 60-90° C.

2H₂S+O₂→1H₂O+¼S_{S}

The sulphur is subsequently absorbed on the surface of the activated carbon. The resulting H₂S content in the biogas is 5 mg/Nm³ or lower. The life time for the removal adsorbent is about one year. In the subsequent conditioning system, the biogas temperature is reduced to approximately 20-30° C. and a dew point of approximately 3 to 5° C. is obtained by means of cold drying. The drying serves as protection against corrosion of the following parts.

The almost H₂S-free dry biogas is then lead into a four-bed-pressure-swing-adsorption (PSA) plant to purify the methane. Every adsorber of this plant is operated in a four-step-cycle of adsorption, depressurisation, regeneration and depressurisation. The absorber is totally regenerated by evacuation and thus there is no need for an exchange of adsorber material,

To produce 1 m³ of bio-methane, in general 1.5 m³ of biogas is consumed.

The main processes to convert methane (CH₄) to methanol are desulphurization, steam reforming, water-gas shift, pressure swing adsorption and methanol synthesis and purification. The first process stage is desulphurization. This is followed by catalytic steam cracking (reforming) of the bio-methane. During this stage the methane is first converted into Hydrogen (H₂) and Carbon monoxide (CO) by means of steam:

CH₄+H₂O←→CO+3H₂

In an exothermic water-gas-shift reaction, which takes place at the same time, carbon monoxide and water are converted into carbon dioxide and hydrogen:

CO+H₂O←→CO₂+H₂

Pressure swing adsorption can be used for example to adjust the stoichiometric factor of the synthetic gas (ratio of H₂/CO). Depending on the synthesis conditions (which include reactor temperature, pressure and catalyst amount and type) this process usually aims at (H₂—CO₂):(CO+CO₂) ratio of approximately 2:1. The synthetic gas produced in this way is purified, compressed and converted to methanol by means of catalysts. Catalyst systems used for methanol synthesis are typically mixtures of copper, zinc oxide, alumina and magnesia. Recent advances have also yielded possible new catalysts composed of carbon, nitrogen and platinum. The remnants of the reaction are transferred to the side of the product by means of temperature and high pressures. To form 1 kg of methanol, in general 0.68 kg of methane is consumed. Commercial quantities of bio-methanol produced from biogas are for example produced by commercial producers BioMCN, New Fuel and Nordic green,

The main processes in a syngas process are: gasification, gas purification, by reforming of high molecular weight hydrocarbons, water-gas removal, hydrogen addition and/or CO₂ removal, and methanol synthesis and purification. This process has similarities with the production of methanol from coal. Pre-treatment of the raw material can be required, e.g. chipping and drying of woody biomass or purification of liquid feedstock.

In the first step the feedstock is gasified into synthesis gas (syngas), which is a mixture of mainly carbon monoxide (CO) and hydrogen (H₂). It also contains CO₂, water (H₂O) and other hydrocarbons. The composition of the syngas is dependent on a large number of factors, such as:
1. the gasification technology (fixed bed, fluidized bed, entrained flow, atmospheric or pressurized reactor, oxygen or air blown, direct or indirect heating of the gasification reaction)
2. choice of various operating parameters: steam to biomass (S/B) ratio, equivalence ratio (Oxygen ratio in the supply), temperature, and pressure
3. Composition of the feedstock (ultimate chemical analysis, moisture content, etc.).

Using a limited amount of oxygen during feedstock heating (i.e. above 700° C.) will improve the formation of CO and H₂ and reduces the amount of unwanted CO₂ and H₂O. However, if air is used as a source of oxygen, the increased gas flow through equipment results in higher investment costs. On the other hand, using pure oxygen is rather expensive and the required energy consumption of the process negatively influences the ICA of the resulting bio-methanol.

After gasification, impurities and contaminants are removed before the gas is passed through conditioning steps to optimize its composition for methanol synthesis. The aim is to produce syngas which has at least twice as much H, molecules as CO molecules. The initial syngas composition depends on the carbon source and gasification method. The concentrations of CO and H₂ can be altered in several ways. First, unprocessed syngas can contain small amounts of methane and other light hydrocarbons with high energy content. These are reformed to CO and H₂, for example by high temperature catalytic steam reforming or by autothermal reforming (ATR).

Second, the initial hydrogen concentration in the syngas is usually too low for optimal methanol synthesis. To reduce the share of CO and increase the share of H₂, a water gas-shift reaction (WGSR) can be used, which converts CO and H₂O into CO₂ and H₂. CO₂ can also be removed directly by for example using chemical absorption by amines.

The gasification of 1 kg of mixed wood chips (dry matter) in a typical fixed bed gasifier, generates 1.922 net Nm³ of syngas (273 K, 1 atm). (Nm³ is Normal m³.) The overall efficiency of the process is approximately 50%. The total CO₂ emissions of a typical fixed bed gasifier, amounts to 0.374 kg CO₂ per net Nm³ of syngas.

The gasification in a typical fluidised bed gasifier, generates 1.545 net Nm³ (Normal m³) of syngas. The overall efficiency of the process is slightly higher at approximately 53%, For a fluidised bed gasifier, the direct CO₂ emissions amount to 0.322 kg CO₂ per net Nm³. From an LCA perspective therefore a fluidised bed reactor is preferred.

Hydrogen can be produced separately, and added to the syngas. Industrial hydrogen is produced either by steam reforming of methane or electrolysis of water. While electrolysis is usually expensive, it can offer important synergies if the oxygen produced during electrolysis is used for partial oxidation in the gasification step, thus replacing the need for air or for oxygen production from air separation. However, from an environmental point of view, electrolysis only makes sense if renewable electricity is available. In many cases this is not the case, so the GWP contribution in the LCA of the bio-methanol is negatively impacted.

After conditioning, the syngas is converted into methanol by a catalytic process based on copper oxide, zinc oxide, or chromium oxide catalysts. Distillation is used to remove the water generated during methanol synthesis.

The technologies used in the production of methanol from biomass are relatively well known since they are similar to the coal gasification technology, which has been applied for a long time. Technically, any carbon source can be converted into syngas. Main categories of feedstock are: Municipal solid waste (MSW), Agricultural waste, forestry waste/residues, Black liquor from pulp processing and glycerin from biodiesel production and bagasse (milled sugar-cane fiber from bio-ethanol production).

To produce 1 kg of bio-methanol, 7.13 Nm³ of syngas needs to be generated. Direct CO₂ emissions from the conversion of Syngas into bio-methanol typically amounts to 2.76 kg CO₂/kg of methanol.

According to (Althaus 2004), the overall heat demand for methanol synthesis from natural gas amounts to 7.7 to 10.5 MJ/kg methanol. For the syngas to methanol process, the additional amount of heat required by the syngas-to-methanol process, causes the overall heat demand to be approximately 9.5 MJ/kg methanol. This means that both processes are more or less competitive in terms of energy efficiency.

Commercial quantities of bio-methanol from gasification are for example produced by Enerkem.

Bio-methanol can also be produced from waste of the Kraft process for the production of paper. In the sulphate pulp process, wood chips are treated with chemicals (NaOH/NA₂S) to separate the wood into its constituents, i.e. cellulose and hemicellulose (pulp) and lignin. Methanol is created when the wood and chemicals react.

After treatment/cooking the chemicals, lignin and other residues are washed out of the pulp. They form black liquor, whose water content is then reduced by evaporation. What remains is a condensate of methanol, turpentine and sulphur compounds,

The condensate is cleaned to be re-used in the mill and then raw methanol is created, which is a mixture of combustible residues, Raw methanol can be burned to produce heat and energy, but for example also used to produce formaldehyde. This energy can also be used to obtain a commercial grade bio-methanol. For every ton of pulp, about 10 kg of methanol can be produced.

Commercial grades of methanol from the Kraft process can for example be obtained from Södra.

Besides bio-methanol from renewable resources, methanol can also be produced from captured CO₂. The CO₂ can be captured from the atmosphere and from industrial exhaust streams. Power plants, steel and cement factories and even volcanic activities produce CO₂ that could be used as a source to produce methanol.

A key element of this technology is the presence of renewable energy. This renewable energy can be from any source (for example solar, wind, hydro, geothermal). The energy is used to produce hydrogen from the electrolysis of water. By mixing CO₂ and H₂ together, a syngas can be produced which is suitable for the production of bio-methanol or e-methanol. (In relation to the present invention e-methanol is used to refer to methanol produced by a process including an electrolysis step, see for example FIG. 4.)

Commercial quantities of e-methanol are produced for example by Carbon Recycling International.

Besides bio-methanol, also hybrid and so called low carbon methanol is commercially available. An example of this technology is the injection of sequestered CO₂ from for example industrial facilities into traditional methanol synthesis routes. This process significantly improves the environmental performance. Another example is the extraction of the CO₂ from exhaustion gasses and re-inject it into the methanol production, reducing GHG emissions and water consumption.

Commercial quantities of these grades are for example available from Methanex and QAFAC.

The majority of the available bio-methanol is used as fuel or for other energy applications. Renewable fuel drastically cuts greenhouse gas emissions. This includes reducing CO₂ to between 50 to 95% and NOx by up to 80% and eliminating sulfur oxide and particulate matter.

Bio-methanol from biogas is readily available on a commercial scale. Also bio-methanol from gasification of wood based biomass is available in bulk quantities. The availability of other sources, like e-methanol for example is lower. Investigation of the contribution of different production routes for methanol lead to a surprising result. Bio-methanol from a mixed source biogas results in an increase of the fossil GWP (1.07 kg CO₂ eq./kg). The reason for this high value is that manure (from animals) is a substantial part of the substrate. The GWP is not related to CO₂, but it is related to methane and N₂O emissions (mainly from the digestion process).

When crops, which are cultivated for generation of biogas (for example rape seed—vegetable oil), the contribution of the fertiliser used to grow crops has a significant impact on the fossil GWP. When more than 50% of the biomass is from a waste stream, the GWP-fossil of the resulting bio-methanol will be comparable to fossil methanol.

However by optimization of the chemical substrates for biogas fermentation, the fossil contribution can be reduced to a level which is roughly at the same level (0.6 kg CO₂ eq./kg) as fossil methanol. Agricultural waste from growing crops for food are of special interest as all CO₂ emissions are allocated to the food which is produced.

Even more surprising is that the Syngas route although the efficiency is relative low (approx. 50%), results in a lower GHG footprint. This can be contributed to the feedstock of waste wood chips.

TABLE 7
GWP of bio-methanol

| | | | | | | [symbol] | | |
|---|---|---|---|---|---|---|---|---|
| | | | [symbol] | [symbol] | [symbol] | [symbol] | [symbol] | |
| | | | [symbol] | [symbol] | [symbol] | [symbol] | [symbol] | [symbol] |
| | | | [symbol] | [symbol] | [symbol] | [symbol] | [symbol] | [symbol] |
| | | [symbol] | [symbol] | [symbol] | [symbol] | [symbol] | [symbol] | [symbol] |
| | Unit | [symbol] | [symbol] | [symbol] | [symbol] | [symbol] | [symbol] | [symbol] |
| Global | [kg | 0.638 | [symbol] | [symbol] | [symbol] | [symbol] | [symbol] | 0.295 |
| warming | CO₂ | | | | | | | |
| potential | eq/kg] | | | | | | | |
| Natural gas | | [symbol] | | | | | | |
| [symbol] | | | [symbol] | [symbol] | [symbol] | [symbol] | [symbol] | |
| Synthgas | | | | | | | | [symbol] |
| (pyrolysis) | | | | | | | | |
| of waste | | | | | | | | |
| wood chips | | | | | | | | |
| Electricity | | 0.055 | 0.055 | 0.055 | 0.055 | 0.055 | 0.055 | 0.026 |
| Heat | | [symbol] | [symbol] | [symbol] | [symbol] | [symbol] | [symbol] | 0.001 |
| Methanol | | 0.029 | 0.029 | 0.029 | 0.029 | 0.029 | 0.029 | [symbol] |
| production | | | | | | | | |
| Biogenic CO₂ | [kg | | −1.38 | [symbol] | −1.38 | [symbol] | −1.38 | −1.38 |
| Total Global | CO₂ | 0.638 | [symbol] | −0.310 | −0.601 | [symbol] | [symbol] | [symbol] |
| Warming | eq/kg] | | | | | | | |
| potential | | | | | | | | |

[symbol]

indicates data missing or illegible when filed

The GWP of methanol contributes to more than 95% of the GWP of the formaldehyde being produced.

When biogas from agri-waste or grass is used as substrate for digestion, an improvement in the GWP-fossil can be achieved. Bio-methanol from biogas is less favorable compared to bio-methanol from gasification of biomass to syngas. The GWP of a fixed and fluid bed gasifier are negligible. The higher GHG emissions of digestion are mainly the result of the production of the chemical substrate and treating of biogas to increase the methane level.

To achieve a significant improvement in the environmental footprint of the novel insulation foam, the preferred option is to use bio-methanol with a fossil GWP lower than traditional methanol. For the final product (cradle-to-gate), the total GWP can be reduced by 10-20% from approximately 2.0 kg CO₂ eq/kg to below 1.7 kg CO₂ eq/kg insulation foam. Even a value of 1.5 kg CO₂ eq/kg can be achieved with an optimised substrate for biogas digestion and/or syngas.

Phenol, the second monomer in the condensation, is produced from petrochemical precursors where cumene based technology is mostly used. To produce phenol, fossil benzene and propylene are converted into cumene and subsequently into acetone, alpha-methylstyrene (AMS) and phenol. The major feedstock for fossil benzene are oil and natural gas. The fossil-GWP-total of traditional phenol is 1.79 kg CO₂ eq./kg (CEFIC, the European Chemical Industry Council (from its former French name Conseil Européen des Fédérations de l'Industrie Chimique)).

Several first generation bio-refineries are producing bio-benzene. Bio-based benzene can be produced from (animal) fats, fatty acid residue, cooking oils and vegetable oils (palm, soy, rape seed).

Commercial quantities of bio-benzene are for example available from Total (France), Versalis (Italy), INEOS (Germany) and Neste (Finland).

The schematic representation below shows the potential chemical pathways to produce bio-benzene from bio-waste such as lignin.

Similar to bio-methanol, the feedstock is very important to minimise the environmental impact of the insulation product. Palm oil (or alternative other vegetable oils) is a very common feedstock in the production of bio-benzene. The preferred route however is the syngas to bio-benzene, where wood and or bio-waste as substrate is used. Even more specific waste products from the paper and pulp industry (for example tall oil). For these bio-benzene grades, the total GWP of the resulting product can be reduced significantly:

TABLE 8
impact of bio-based phenol on the GWP-total

| Content fossil: | [%] | 100 | 90 | 80 | 70 | 60 | 50 | 40 | 30 | 20 | 10 | 0 |
|---|---|---|---|---|---|---|---|---|---|---|---|---|
| Phenol | [kg CO2 eq] | 1.79 | | | | | | | | | | |
| Phenol delta bio | [kg CO2 eq] | | −0.23 | −0.58 | −0.88 | −1.17 | −1.46 | −1.75 | −2.04 | −2.34 | −2.63 | −2.92 |
| sum: | [kg CO2 eq] | [symbol] | [symbol] | [symbol] | [symbol] | [symbol] | [symbol] | [symbol] | [symbol] | [symbol] | [symbol] | [symbol] |

[symbol]

indicates data missing or illegible when filed

By replacing 25% of the fossil phenol by bio-phenol, the total GWP of a phenolic insulation foam can be reduced below 1.7 kg CO₂ eq/kg foam. At 50% replacement a GWP of approx. 1.5 kg CO₂ eq/kg foam. A 100% replacement can lead to a total GWP of the foam below 1.0 kg CO₂ eq/kg foam,

The carbon footprint of the production process of the phenolic resin results mainly from the raw materials used. The total carbon footprint for the production of 1 kg of resin is 0.072 g CO₂ eq. See Table 9 below.

TABLE 9

| Type of unit | Carbon footprint (CO2 eq.) |
|---|---|
| Process electricity | 1.81E−05 |
| Reactor | 2.02E−02 |
| Heat exchanger | 5.22E−02 |
| Total | 7.24E−02 |

This is partly the result of the exothermic chemical reaction, which does not require significant heating. The water removed from the reaction takes place via vacuum distillation. The energy consumed is actually used to cool the reaction mixture under vacuum reflux to a condenser in the reaction vessel.

To further reduce the GWP of the product, (bio-)phenol can be replaced by natural, bio-based and therefore sustainable polyphenols found in nature like lignin, tannin, rosin, . . . etc.

Lignin is a high molecular weight aromatic structure found in plants where it acts as binder of the (hemi) cellulose fibers. This lignin can be recovered from vegetation or biowaste with different technologies.

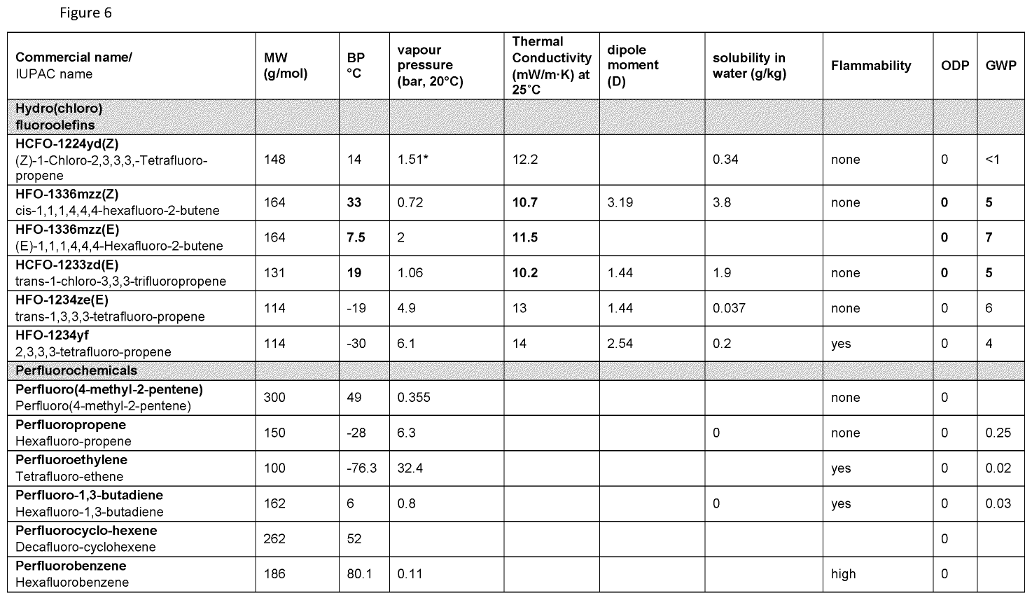

Lignins can be divided between Sulfur containing Lignins and Sulfur free Lignin. The main categories of lignins are schematically depicted in FIG. 5.

The lignin structure, composition and functionality depends on the origin of the feedstock (lignocellulose) and the extraction and purification process. Lignin extracted from waste streams of paper and pulp manufacturing are Kraft lignin, soda lignin and lignosulphonates, depending on the pulping process. In pulping processes, the main focus is on the production of high quality cellulose pulp.

Bio-refineries that convert biomass to biofuels have also a lignin containing waste stream, mostly recovered with solvent extraction. These lignins are often referred to as organosolv lignins.

In other processes, for example bio-refinery processes, lignin can also be extracted directly from the biomass which are called hydrolysis lignins. In these processes the focus is on co-production of lignin, cellulose and (fermentable) sugars.

The most common chemical pulping process of wood today is the Kraft pulping process. In this process, sodium sulphite is used under alkaline conditions. This process yields solubilized sulphur-containing lignin (1-3%) which is recovered from the black liquor. Several companies in 2020 are producing Kraft lignin using different isolation processes such as LignoBoost, LignoForce etc.

The sulphite process is also widely applied for the production of pulp. In this process, an aqueous solution of sulphur dioxide, to form H₂SO₃, is used at different pH values. The lignin from this process contains sulfonate groups (the sulfonate groups are 3-8% by weight of the lignin). Most lignosulphonates are water-soluble and so make these lignins different from other lignin types regarding water solubility.

In the soda pulping process, sodium hydroxide is used instead of sodium sulphide to dissolve the lignin from lignocellulosic material, such as annual fibre crops like flax, straw, and wood. Soda lignin is recovered by an alternative recovery process by acid precipitation, a maturing process and filtration, resulting in sulphur-free lignin.

Organosoly pulping and/or fractionation processes uses organic solvents (e.g. ethanol), to avoid the formation of sulphur-containing by-products. Organosolv pulping or fractionation enables the production of both high quality cellulose and high quality lignin. The water insoluble organosolv lignins are more pure, compared to other extraction methods, containing a higher percentage of lignin.

Bio-refinery processes consist of several different technologies such as for example steam explosion acid hydrolysis. The steam explosion process is used for fractionation of lignocellulose to produce cellulose, fermentable sugars and lignin. Wood based biomass is pre-treated with steam at high temperature and high pressure, followed by a rapid pressure release. The fibrous network is disrupted and liberated fibres and bundles are formed. In this process, the acid-hydrolysed lignin can be extracted from the cellulose, largely by solvents. The resulting steam explosion liberated lignin contains a low content of carbohydrates and wood extraction impurities. The acidic process uses acid with or without steam and is often applied to fractionate different types of biomass, e.g. agricultural waste and wood species. All lignins are crude grades which can be used as such but often need further fractionation, depolymerisation and chemical modification, Kraft lignin and lignosulphonates are widely available for industrial use.

TABLE 10
Examples of available lignin types

| | | | Lignin | Lignin | Lignin | | | [symbol] |
|---|---|---|---|---|---|---|---|---|
| | | | production | isolation | with | Purity | | [symbol] |
| Process | Company | Feedstock | [symbol] | process | sulphur | [symbol] | Products | [symbol] |
| Kraft | [symbol] | Fine | 60 | Own | Yes | high | [symbol] | [symbol] |
| | | | kton/y | technology | | | [symbol] | [symbol] |
| Kraft | [symbol] | Softwood | 50 | LigneBoost | Yes | high | [symbol] | [symbol] |
| | | | kton/y | | | | | |
| Kraft | [symbol] | Softwood | 25 | LignoBoost | Yes | high | [symbol] | Various under |
| | | | kton/y | | | | | research |
| Kraft | West Frasier | Softwood | 10 | LignoForce | Yes | high | [symbol] | Plywood |
| | (CAN) | | kton/y | System ™ | | | | |
| [symbol] | [symbol] | Softwood, | 1,000 | Own | Yes | high | [symbol] | [symbol] |
| | [symbol] | hardwood, | kton/y | technology | | | [symbol] | |
| | [symbol] | agricultural | | | | | | |
| | | residues. | | | | | | |
| Soda | [symbol] | [symbol] | 5-10 | LPS | No | high | [symbol] | [symbol] |
| | | | kton/y | system | | | | |
| Kraft | [symbol] | [symbol] | Demo (20 | LignoBoost | Yes | high | [symbol] | [symbol] |
| | | | kton/y) | | | | | |
| [symbol] | [symbol] | Wood | Demo (15 | Own | No | Medium | Ethanol, | Energy |
| | | residues | kton/y) | process | | | lignin | |
| Kraft | [symbol] | Wood | Demo (8 | LignoBoost | Yes | High | Cellulose | Various under |
| | | | kton/y) | | | | pulp, lignin | research |
| Enfinity | [symbol] | Agricultural | Demo | Own | No | Medium | [symbol] | Various under |
| | | residues | | process | | | | research |
| | | (e.g.\straw) | | | | | | |
| [symbol] | [symbol] | Agricultural | Demo | Own | No | Medium | Ethanol, | Energy |
| | | residues | | process | | | lignin | |
| [symbol] | [symbol] | Wood | Demo | Own | No | Medium | [symbol] | [symbol] |
| | | | | process | | | | |
| Sweetwater's | [symbol] | Wood | Demo | Own | No | high | Cellulose, | Under |
| Sunburst | | | building | process | | | lignin | evaluation |
| | | | phase | | | | | |
| Own | [symbol] | Wood | | Own | No | unknown | Cellulose, | Under |
| technology | | | | process | | | lignin | evaluation |
| [symbol] | [symbol] | Straw | Pilot | Evaporation | No | high | [symbol] | [symbol] |
| | | | | solvent | | | | |
| Kraft | PFInnovations | Pine | Pilot | LignoForce | Yes | high | [symbol] | [symbol] |
| | (CAN) | | (0.2 t/day) | System ™ | | | | |
| [symbol] | PFInnovations | Ieine | Pilot | Own | No | Medium-low | Sugars, | [symbol] |
| | (CAN) | | (0.2 t/day) | technology | | | lignin | |
| [symbol] | [symbol] | Hardwood | Pilot | Evaporation | No | high | [symbol] | [symbol] |
| | | | | solvent | | | | |
| [symbol] | [symbol] | Hardwood | Pilot | Evaporation | No | high | [symbol] | [symbol] |
| | | | | solvent | | | | |
| Plantrose | [symbol] | [symbol] | Pilot | Own | No | Medium | [symbol] | Application |
| (Supercritical | | | | technology | | | | under study |
| Hydrolysis) | | | | | | | | |
| [symbol] | [symbol] | Grass, | Demo | Own | No | [symbol] | [symbol] | Energy |
| | | wood | | technology | | | | production, |
| | | | | | | | | aromatics |
| Soda | [symbol] | [symbol] | Pilot | Own | No | Medium-high | Cellulose, | Bio- |
| extrusion | | | | technology | | | lignin | asphalt |
| Soda | [symbol] | [symbol] | Pilot | Own | No | Medium-high | [symbol] | Application |
| | | | | technology | | | | under study |
| [symbol] | [symbol] | Wood | Pilot | Own | No | Medium-high | [symbol] | [symbol] |
| | | | | technology | | | | |
| [symbol] | [symbol] | [symbol] | Lab | Own | No | Unknown | [symbol] | Various |
| | | | | technology | | | | under study |
| PHOENIX | Sustainable Fiber | Agricultural | Pilot | Own | No | Low | [symbol] | Various |
| PROCESS ™ | Technologies (US) | residues | | technology | | | | under study |
| [symbol] | [symbol] | Wood | Lab | Residual | No | Medium-high | Cellulose, | Under |
| | | | | | | | lignin | evaluation |
| [symbol] | [symbol] | Agricultural | Lab | Water | No | High | [symbol] | Under |
| | | residues | | addition | | | | evaluation |
| Soda, | [symbol] | Agricultural | Lab | Own | No | High | Cellulose, lignin | Application |
| acetic acid | | residues | | technology | | | | under study |

[symbol]

indicates data missing or illegible when filed

TABLE 10a
Examples of (commercially) available lignin types (and their sources)

| | | | | | | | | Carbo- | | | | | | | | | |
|---|---|---|---|---|---|---|---|---|---|---|---|---|---|---|---|---|---|
| | Feed- | Sup- | C | [symbol] | N | S | Lignin | hydrates | Ash | [symbol] | [symbol] | G—OH | H—OH | [symbol] | Mn | [symbol] | [symbol] |
| Lignin | stock | plier | [%] | [%] | [%] | [%] | [%] | [%] | [%] | [symbol] | [symbol] | [symbol] | [symbol] | [symbol] | [symbol] | [symbol] | [symbol] |
| KRAFT | Softwood | [symbol] | [symbol] | [symbol] | 0.7 | 1.7 | 92 | 1.4 | [symbol] | [symbol] | 0 | [symbol] | 0.22 | 0.4 | [symbol] | 4290 | [symbol] |
| Soda | [symbol] | [symbol] | [symbol] | 5.7 | [symbol] | 1 | 91 | 2.4 | [symbol] | [symbol] | [symbol] | [symbol] | [symbol] | [symbol] | 620 | 3270 | [symbol] |
| [symbol] | Hardwoods | [symbol] | 67 | [symbol] | 0.2 | 0.2 | [symbol] | 0.2 | [symbol] | 1.12 | 1.97 | [symbol] | 0.16 | 0.23 | 600 | 2580 | 4.3 |

[symbol]

indicates data missing or illegible when filed

Useful lignins in the present invention can be utilised to replace at least 20 wt % of phenol, in the synthesis of phenolic resins used for the manufacture of closed cell phenolic insulation foams. Useful lignins may have one or more of the following characteristics (i) their purity might be high, e.g. low content of carbohydrates, ash, S, . . . (II) Their molecular weight distribution range is relatively narrow, as it is a mix of oligomers and (iii) their reactivity towards aldehydes is suitable as the number of chemical functional groups is sufficient.

These issues will affect the resin synthesis process as their solubility in water will be different compared to phenol monomer. Furthermore, the use of these resins may lead to a foam with reduced polymer strength. This results in foam with inferior mechanical properties, higher friability and open cells which implies inferior thermal insulation performance.

To make lignins suitable to be used in the said application of phenolic insulation foams, there is a need for further process modification, consisting of purification, fractionation, depolymerization, chemical functionalization and combinations of these techniques

Lignins can be purified. There is a need to remove remaining carbohydrates, reduce the sulphur and/or ash content which would act as fillers in the final foam

Lignins can be fractionated to a narrower range of molecular weight which will improve the homogeneity of the lignin.

Lignins can be depolymerized, by cleaving the polymer into smaller molecular weight fractions. Base and acid catalyzed depolymerization, enzymatic depolymerization and thermal (pyrolytic) depolymerization are some methods to use.

Lignins can be functionalized, and this chemical modification increases its reactivity in foam manufacture. Examples of techniques are phenolation, methylolation, glyoxalation, demethylation and sulphonation.

Another object of the present invention is to use a sulphonated Kraft lignin to at least partly replace fossil sourced materials, such as fossil sourced phenol in the synthesis of phenolic resin such as a resole phenolic resin, to further increase the bio-based content of the final insulation foam.

Sulphonation of Kraft lignin is a separate process. The sulphonation process consists of a chemical reaction between lignin and sulphuric acid resulting in the presence of sulphonate functional groups within the lignin structure. Kraft lignin is blended into 95 to 98% sulphuric acid. The chemical reaction is controlled by keeping the temperature in the range 25 to 40° C. After sulphonation, the sulphonic acid functional groups are neutralised to an alkali salt (e.g. potassium, sodium). The lignin is recovered by precipitation, and washed with water to remove excess acid. Sulphonation process can be modified to obtain lignins with a different degree of sulphonation, expressed as moles sulphonic acid groups per 1000 units weight of lignin.

### Schematically:

Lignin+H₂SO₄→Lignin-SO₂—O—H (sulphonation)
Lignin-SO₂—O—H→Lignin-SO₂—O⁻Na⁺(neutralisation by alkali)

Sulphonated Kraft lignins are commercially available in industrial quantities and are placed in the market by Ingevity.

A further object of the present invention is to use a phenolated Kraft lignin to at least partly replace fossil sourced phenol in the synthesis of the resin such as a resole resin. This is to further increase the bio-based content of the final insulation foam.

The phenolation of Kraft lignin is in a separate process but there are in practice two options, a one-step process (OSP) or a two-step process (TSP). The phenolation process consists of a chemical reaction between phenol and lignin under acidic conditions to increase the amount of aromatic phenol functionality of the lignin. Schematic representation of phenolated lignins:

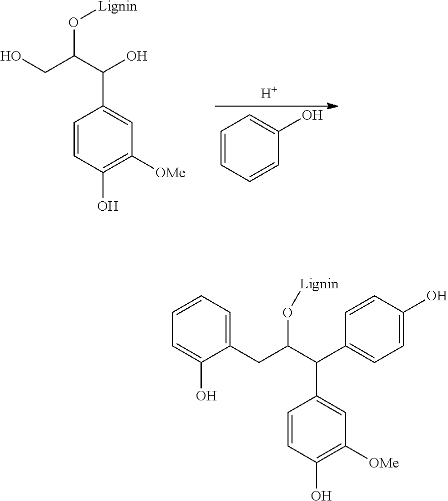

The two-step phenolation process consists of blending lignin with phenol and react at elevated temperature in the presence of an acid catalyst. Afterwards, the phenolated lignin is recovered as a solid material by precipitation and if necessary finally washed or neutralised to have the precipitate purified. The obtained phenolated lignin is used as co-reactant with phenol in the phenolic resin synthesis.

The one-step phenolation is done prior to resin synthesis but both phenolation and resin synthesis could be two consecutive steps in the same reactor. Part of the phenol needed is blended with the lignin and brought to an elevated temperature under acidic conditions to start the phenolation of the lignin. To stop further reaction, the acid catalyst is neutralised. Additionally, the remaining phenol is added together with the alkaline catalyst and water. Gradual addition of formaldehyde will start the condensation polymerisation reaction. The reaction is stopped at the targeted viscosity by cooling down and neutralizing with an acid. This approach omits the purification and isolation of the phenolated lignin prior to resin synthesis.

A next object of the present invention is to use a pyrolytic lignin to partly replace fossil sourced phenol in the synthesis of a resin such as a resole resin to further increase the bio-based content of the final insulation foam. Pyrolysis of biomass results in a pyrolysis oil which can be fractionated into pyrolytic lignin and pyrolytic sugars.

A fast pyrolysis process is known where in a short time frame organic materials are heated to 450-600° C. in an oxygen free environment. Under these conditions, organic vapors, pyrolysis gases and charcoal are produced. The vapors are condensed to bio-oil with a typical yield of 60-75 wt %.

The fast pyrolysis process is based on a rotating cone reactor, where biomass particles are fed near the bottom of the pyrolysis reactor together with an excess flow of hot heat carrier material such as sand, where it is being pyrolysed. The produced vapours pass through several cyclones before entering the condenser, in which the vapours are quenched by re-circulated oil. To achieve a significant improvement in the environmental footprint of the novel insulation foam, the preferred option is to use bio-methanol with a fossil GWP lower than traditional methanol. For the final product (cradle-to-gate), the total GWP can be reduced by 10-20% from approximately 2.0 kg CO₂ eq/kg to below 1.7 kg CO₂ eq/kg insulation foam. Even a value of 1.5 kg CO₂ eq/kg can be achieved with an optimised substrate for biogas digestion and/or syngas. The pyrolysis reactor is integrated in a circulating sand system. This system is composed of a riser which feeds the fluidized bed char combustor, the pyrolysis reactor and a so called “down-comer” from the char combustor which feeds the sand back into the pyrolysis reactor. In this concept, char is burned with air to provide the heat required for the pyrolysis process. Oil is the main product; non-condensable pyrolysis gases are combusted and can be used e.g. to generate additional steam. Excess heat can be used for drying the feedstock.

Due to large amounts of oxygenated components present, the oil has a polar nature and does not mix readily with hydrocarbons. The degradation products from the biomass constituents include organic acids (such as formic and acetic acid), giving the oil its low pH typically 2.9 and density of 1,170 kg/m³. The (hydrophilic) bio-oils with a lower heating value of appr. 16 MJ/kg have typical water contents of 15-35 w % and a kinematic viscosity of 1.3 cSt (40° C.). A typical wood-derived pyrolysis oil contains 46 w % carbon, 7 w % hydrogen, <0.01 w % nitrogen and 47 w % oxygen.

The pyrolysis oil is a mixture of cracked components originating from the pyrolysis of the three main building blocks of biomass; cellulose, hemicellulose and lignin. Pyrolysis is a good pretreatment to facilitate the fractionation of biomass. After pyrolysis the oil can easily be fractionated into three product streams namely; pyrolytic lignin (from lignin), pyrolytic sugars (from cellulose) and an aqueous phase containing smaller organic components e.g. acetic acid (mainly from hemicellulose).

The typical yield is 20-30 wt % of pyrolytic lignin with a water content of about 10-11 wt %. The pyrolytic lignin obtained from this process is a highly viscous liquid. Subsequently from the remaining bio-oil obtained after pyrolytic lignin separation, the pyrolytic sugars and small organic species can be extracted. From the water phase, acetic acid can be produced by means of an extraction step followed by simple distillation.

An additional unexpected advantage for the addition of lignin, is a change in the color of the product. Phenolic foams have a light pink color after production. During the lifespan of the product, the material will color to dark brown. This color change is caused by oxidation, which has a darkening effect. This color changing effect is accelerated when the product is exposed to light (UV). This tendency to change in color is undesirable as even though the insulation product retains its insulation properties, visually products can look different.

This color can be changed to yellowish by modification with urea or an alternative nitrogen containing substance which can react into the matrix. Alternatively colorants can be added to the phenolic foam. A commonly used colorant for example is carbon black. Also other colorants can be used, however the selection is limited as many colorants disturb the cell formation in the foam, leading to open cells and a loss in thermal performance over time.

The use of lignin reduces color change and gives the product stable a light brown color. The color is stable. Also the color will make it possible to distinguish the product from alternative traditional closed celled phenolic foam material.

The Green House Gas, (GHG), emissions of the production of a resin from bio-phenol and/or lignin and/or bio-methanol are estimated at 0.0468 kg CO₂ eq/kg of resin, which is comparable to the production of a fossil based resin. The electricity consumed during the production is estimated at 0.33 kWh/kg resin.

The impact of the sequestered CO₂ in the raw materials has a significantly higher effect on the total GWP of the final product from Cradle-to-gate (A1-A3). For this reason the conversion needs to be made to bio-based raw materials to realise a substantial reduction in GWP.

A further object of the present invention is to use a plasticizing additive based on a bio-based and/or recycled polyurethane foam to replace fossil sourced additive in the foam processing formulation to further increase the sustainable content of the final insulation foam.

Bio-based polyols can be produced from a variety of sources. Bio-based polyols can be produced from bio-based phthalic anhydride phthalic and terephthalic acid. Also vegetable, rapeseed oil and epoxidised soybean polyols with high renewable content are for example options Last but not least e-polyols based on captured CO2 could also be an option to reduce the GWP.

A glycolysis process is used to recycle crushed polyurethane foam waste with glycols and catalyst/additives for conversion into liquid polyols. The outcome of this process does not need any further purification steps to be used. These polyols act as plasticisers and can be used in a foam formulation to form a foam product of the invention.

As the content of the plasticiser in the foam chemical formulation is relatively low, the overall contribution to the total GWP is also limited. Nevertheless, this type of technology can be used to create a further reduction in GWP.

A next object of the present invention is to use a blowing agent such as cyclopentane, recovered from refrigeration applications to replace fossil sourced grades in the foam processing formulation to further increase the sustainable content of the final insulation foam product.

The addition of solids to the foam, for example neutralisers, can have an impact on the GWP values in the EPD. As these solids are generally inert in the formulation, and the maximum amount of solids in general is limited to 10 w %, in many cases even limited below 5 w %, the overall impact on the GWP in the EPD of the foam product is relatively limited.

Possible examples of bio-based neutralisers are sea-and/or egg shells. These types of materials contain sequestered CO₂ in the form of for example CaCO₃/MgCO₃/Na₂CO₃/ . . . Suitably they are in particulate form. The particulate form will allow for dispersion in a foam forming composition.

Flame retardants such as Triethyl phosphate (TEP), (tris (1-chloro-2-propyl)

phosphate (TCCP) or red phosphorous have a high GWP in comparison to other components and can have a significant impact. Red phosphorous for example has a GWP total of 13.3 kg CO₂eq/kg.

The combined use of bio-formaldehyde and phenolated and/or sulphonated Kraft lignin and/or pyrolytic lignin and/or bio-phenol in a resole resin synthesis process and process this resole resin in a foam formulation optionally adding a surfactant/emulsifier, and/or recycled plasticizing additive, and/or recycled blowing agent and/or a mineral acid may result in an insulation foam with over 7% non-fossil content meeting the thermal and mechanical performance of nearly full fossil phenolic insulation foams. In such a product at least 7% by weight of the foam body is formed from at least one component from a renewable source, such as at least 10%, for example at least 15%, desirably at least 20%, optionally at least 25%, for example at least 30%.

A chemical formulation comprising bio-formaldehyde, phenolated lignin and/or sulphonated Kraft lignin, and/or pyrolytic lignin and bio-phenol can be used to manufacture a resole phenolic resin for a foam insulation product. The final foam formulation will also contain a surfactant/emulsifier, a plasticising additive, a (recycled) blowing agent and an acid catalyst will create an insulation foam with over 7% non-fossil content measured in accordance with EN16640:2017. This meets the thermal and mechanical performance of nearly full fossil phenolic insulation foams,

Even more important, a GWP for Cradle-to-Gate (A1-A3) below 2 kg CO₂ eq/kg, 1 kg CO₂ eq/kg, 0.5 kg CO₂ eq/kg and even 0.3 kg CO₂ eq/kg can be achieved. The bio-based content (possibly via bio-attribution), can be increased to up to respectively 30 to 70%.

### Example Types

The invention covers two different types of foaming processes. Phenolic resin procedure and subsequent foaming process Type A can be used for both the production of discontinuous block foam and continuous foam laminates. Process Type B can be used for formulations for continuous laminate foam formulations.

### EXAMPLES

### Section A

### Example A1 to A4

### Comparative Example Comp-A1

For the production of the resole phenolic resin, a commercially available fossil-methanol produced from fossil methane was used with a GWP-fossil of 0.64 kg CO₂ eq./kg. The methanol was converted into a formalin aqueous solution by guiding air through the heated methanol. The vapour mixture was guided over a platinum-asbestos catalyst (at 300° C.) to form a mixture of water (52%), formaldehyde (40%) and methanol (8%). The methanol was removed from the mixture by fractionation to obtain a formalin solution. The final purity of the formalin solution was 49 w % (stored at 50° C.).

Fossil phenol with a weight purity of 99%, produced via the cumene process from fossil benzene was used, with a GWP-fossil of 1.79 kg CO₂ eq./kg.

### Resin Synthesis Comp-A1

Load the lab reactor with 659 g fossil based phenol (>99% pure), 68 g water and 26 g potassium hydroxide (KOH) 40% aqueous concentration. Bring this mixture to a temperature of about 60° C. In a time span between 1 and 2 hours, gradually 647 g of 49 w % fossil based formalin solution was added whilst increasing reaction temperature to about 80° C. After the addition of the formalin, approximately 300 g of water was removed by vacuum distillation in the course of 1 hour while maintaining a temperature of 55 to 80° C. Subsequently the resin viscosity is measured every 15 minutes until the target viscosity (2,000 +/−500 mPa·s @ 25° C.) is reached. Then neutralise with 1.6 g formic acid 85% and start cooling down to room temperature.

Final properties of the resin:

TABLE 11
specifications resin Comp-A1

| Property | unit | Value |
|---|---|---|
| Viscosity @ 25° C. | cPs | 1850 |
| Free Formaldehyde | % | 0.18 |
| Free Phenol | % | 5.9 |
| Water content | % | 18.2 |
| pH | — | 8.1 |

The GWP-total of the resulting resin is 1.5 kg CO₂ eq./kg based on the Gabi-database (version: GaBi ts 9.2 Gabi ts 9.2 (Service Packs 39)). The Gabi database contains raw material profiles, which hold the environmental impact of the conversion from one substance into another. When the Eco invent database is used, which is used in some countries, the GWP total is 2.2 kg CO₂ eq./kg. The Gabi database is used, because the profiles are in general more up to date.

### Resin Synthesis Comp-A2

Identical to Comp-A1, except the fossil based formalin is replaced by bio-formalin produced from bio-methanol. The GWP-fossil of the bio-methanol was approximately 1.07 kg CO₂ eq./kg as a result of the substrate which was a market mix biogas. In the present application the term “market mix” biogas refers to a commerically sold biogas (typically generated for fuel applications) which includes a number of biogases from different sources. The GWP for such a “marked mix” biogas is included in Table 7 above. This market mix biogases include those generated from different sources (possibly including other sources indicated in Table 7) including the use of special grown crops and manure and which impacts the GWP in a negative way. The GWP-biogenic is approximately −1.38 kg CO₂ eq./kg. The GWP-total of the biomethanol from market mix biogas is −0.31 kg CO₂ eq.

### Resin Synthesis A1

Identical to Comp-A1, except the fossil-based formalin is replaced by bio-formalin produced from bio-methanol. The GWP-fossil of the bio-methanol was approximately 0.6 kg CO₂ eq./kg as a result of the source which was biogas. The biogas was produced by fermentation of bio-waste (in this case 50% of the substrate consists of roadside grass). The GWP-total of the bio-methanol is −0.8 kg CO₂ eq./kg (based on a GWP-biogenic of −1.38 kg CO₂ eq./kg for the bio-methanol). The resin A1, has a GWP-fossil of 1,55 kg CO₂ eq/kg, a GWP-biogenic of −0.44 kg CO₂ eq/kg, a GWP-luluc of 0.03 kg CO₂ eq/kg and a GWP-total of 1.14 kg CO₂ eq/kg.

### Resin Synthesis A2

Identical to Comp-A1, except the fossil formalin is replaced by bio-formalin produced from bio-methanol derived from syngas. The syngas was produced by gasification of wood with a GWP-fossil of 0.3 kg CO₂ eq/kg. The GWP-total of the bio-methanol is −1.1 kg CO₂ eq/kg (GWP biogenic of −1.38 kg CO₂ eq/kg for the biomethanol). The resin A2, has a GWP-fossil of 1,45 kg CO₂ eq/kg, a GWP-biogenic of −0.44 kg CO₂ eq/kg, a GWP-luluc of 0.03 kg CO₂ eq/kg and a GWP-total of 1.04 kg CO₂ eq/kg.

### Resin Synthesis A3

Identical to Comp-A1, except the fossil phenol is replaced by bio-phenol, produced from bio-naphtha. The source of the bio-naphtha is tall oil (bio-waste from the paper and pulp industry). The GWP-fossil of the bio-phenol is 1.79 kg CO₂ eq/kg. The GWP-total of the resulting phenolic resole resin is −1.13 kg CO₂ eq/kg (GWP-biogenic of −2.81 kg CO₂ eq for the bio-phenol). The resin A3, has a GWP-fossil of 1.48 kg CO₂ eq/kg, a GWP-biogenic of −1.87 kg CO₂ eq/kg, a GWP-luluc of 0.03 kg CO₂ eq/kg and a GWP-total of −0.36 kg CO₂ eq/kg.

### Resin Synthesis A4

Identical to Comp-A1, except the fossil formalin is replaced by bio-formalin produced from bio-methanol. The bio-methanol was produced from syngas made by gasification of wood with a GWP-fossil of 0.3 kg CO₂ eq/kg. The fossil phenol was replaced by bio-phenol produced from bio-naphtha. The source of the bio-naphtha is tall oil (bio-waste from the paper and pulp industry). The GWP-fossil of the bio-phenol is 1.79 kg CO₂ eq/kg. The GWP-total of the resulting phenolic resole resin is −1.57 kg CO₂ eq. The GWP-biogenic of this resin is (based on −1.38 kg CO₂ eq/kg for the biomethanol and −2.81 kg CO₂ eq/kg for the bio-phenol). The resin A4, has a GWP-fossil of 1.39 kg CO₂ eq/kg, a GWP-biogenic of −2,32 kg CO₂ eq/kg, a GWP-luluc of 0.03 kg CO₂ eq/kg and a GWP-total of −0.90 kg CO₂ eq/kg.

### Foaming Process A1

Load 368 g of the above A1 resin into an empty beaker, add 16 g surfactant (ethoxylated castor oil) with an ethylene oxide degree between 10 to 80 and 16 g plasticizing agent (dimethylphthalate) and mix to an homogeneous blend. Add 0.96 g nucleator (a perfluoro compound) and 22 g blowing agent (mix of cyclo and isopentane ratio 70/30 wt %) and mix to an homogeneous blend. Hold this chemical blend for one to two hours at 20° C. Add 60 g of acid catalyst (a mixture of 62.5 wt % sulphuric (50% solution) and 37.5 wt % phosphoric acid (85% solution)) to the phenolic resole blend. Mix until a homogeneous mixture is formed and pour the reacting chemical mix into a wooden mould (to simulate a typical block foam process) preheated to 70° C. Close the mould and put in an oven preheated to 70° C. for 4 hours minimum.

Demould the foam. Leave the foam for one week at ambient room conditions to dry and to give a stable moisture content. Then cut samples to measure foam properties.

### Comparative Examples Comp-A1 and Comp-A2 and Examples A1 to A4

Comparative foam samples Comp-A1 and Comp-A2 were produced with resin produced according to method resin Comp-A1 and resin Comp-A2 respectively. The foams were produced using foaming method A1. The foam examples A1 to A4 were produced with resin produced according to method resin A1 to A4. The foams were produced using foaming method A1.

The properties of these samples were measured and the results are given in Table 12:

TABLE 12
properties of foam samples Comp-A1 to A4

| Property | Standard | unit | Comp-A1 | Comp-A2 | A1 | A2 | A3 | A4 |
|---|---|---|---|---|---|---|---|---|
| Wet-core density | EN845 | [kg/m³] | 42.1 | 42.3 | 42.8 | 43.1 | 42.9 | 42 |
| Dry core density | | | 36.1 | 36.1 | [symbol] | 36.5 | 36.2 | 35.9 |
| Compressive strength X | EN826 | [kPa] | 172 | 164 | 166 | 170 | 175 | 160 |
| Compressive strength Y | | | 80 | 80 | 79 | 83 | 91 | 79 |
| Friability 10′ | ISO6187 | [%] | 17.3 | 16.9 | 17.7 | 16.8 | 18 | 18.2 |
| Water vapour resistance (μ-value) | EN12086 | [—] | 75 | | | | | 80 |
| Thermal conductivity initial | EN14314/12667 | W/m · K | 0.0227 | 0.0227 | 0.0225 | 0.0227 | 0.0229 | 0.0232 |
| Thermal conductivity 1 day 70° C. | | | 0.0208 | 0.021 | 0.0209 | 0.021 | 0.0206 | 0.021 |
| Thermal conductivity 1 week 70° C. | | | 0.0228 | 0.0228 | 0.0224 | 0.0227 | 0.0228 | 0.023 |
| Thermal conductivity 25 weeks 70° C. | | | 0.0251 | 0.0244 | 0.0251 | 0.0248 | 0.0248 | 0.0243 |
| Thermal conductivity 50 weeks | | | 0.026 | 0.0256 | 0.0259 | 0.0259 | 0.0257 | 0.0255 |
| 70° C. + cond. | | | | | | | | |
| Fire performance (after 30 s) | EN11925-2 | [mm] | <100 | <100 | <100 | <100 | <100 | <100 |

[symbol]

indicates data missing or illegible when filed

The foam properties are unaffected by the use of bio-based materials. However the surprising finding is that only bio-waste generates GWP-total values, which are equal or less in GWP-fossil values and actually result in a reduction of the GWP total due to the negative contribution of the GWP-biogenic of the final product (cradle-to-gate):

TABLE 13
Global Warming Potential of foam samples Comp-A1 to A4

| | property | unit | Comp-A1 | Comp-A2 | A1 | A2 | A3 | A4 |
|---|---|---|---|---|---|---|---|---|
| Methanol | GWP-fossil | kg CO₂ eq/kg | 0.6 | 1.1 | 0.6 | 0.3 | 0.6 | 0.5 |
| | GWP-biogenic | | 0.0 | −1.4 | −1.4 | −1.4 | 0.0 | −1.4 |
| | GWP-total | | 0.6 | −0.3 | −0.8 | −1.3 | 0.6 | −1.1 |
| | bio-Carbon content | [%] | 0.0 | 37.5 | 37.5 | 37.5 | 0.0 | 37.5 |
| Phenol | GWP-fossil | kg CO₂ eq/kg | 1.8 | 1.8 | 1.8 | 1.8 | 1.7 | 1.7 |
| | GWP-biogenic | | 0.0 | 0.0 | 0.0 | 0.0 | −2.8 | −2.8 |
| | GWP-total | | 1.8 | 1.8 | 1.8 | 1.8 | −1.1 | −1.1 |
| | bio-Carbon content | [%] | 0.0 | 0.0 | 0.0 | 0.0 | 76.5 | 76.5 |
| Insulation | GWP-fossil | kg CO₂ eq/kg | 1.9 | 2.0 | 1.9 | 1.9 | 1.8 | 1.9 |
| foam | GWP-biogenic | | 0.0 | −0.3 | −0.4 | −0.4 | −1.2 | −1.7 |
| | GWP-total foam | | 2.0 | 1.8 | 1.6 | 1.6 | 0.7 | 0.3 |
| | bio-Carbon content | [%] | 3.0 | 13.1 | 13.1 | 13.1 | 43.2 | 53.3 |
| | (dry core density) | | | | | | | |

In the GWP total of the foam a GWP-luluc (GWP luluc refers to Global warming potential (land use only)-see Table 1 above) of 0.1 kg CO₂ eq./kg is included. For the phenol and formaldehyde the GWP-luluc is below 0.1 kg CO₂ eq./kg. Because bio-waste is used, the land use is relative low.

A combination of a partial replacement of fossil-phenol with bio-phenol and/or fossil-formaldehyde with bio-formaldehyde or a combination thereof can be used to achieve the desired total GWP of the product. The footprint will be minimised by a full replacement of both bio-phenol and bio-formaldehyde.

The values for the Global Warming Potential were determined by using the Gabi database (version: GaBi ts 9.2 Gabi ts 9.2 (Service Packs 39)), which contains standardised profiles for phenol, formaldehyde and other substances in the formulation. From these profiles, by using the data standard for Phenolic resin production (RER), the GWP-values for the resin were determined. The outcome was subsequently used to determine the values for the insulation foam. The calculations were performed using the software package Envision Web (version 5.0.0.82332bc) from Sphera Solutions GmbH.

The bio-Carbon content is calculated from the molecular weight of the component and the molecular weight of Carbon. For the end product, the dry core density has been used, to eliminate the effect of residual water in the product. The 3% bio-carbon content for Comp-A1 results from the ethoxylated castor oil and has been determined via C¹⁴ determination according to EN16640:2017.

Beside the Global Warming Potential also the Renewable Primary Energy Resources used as Raw Material (PERM; have been calculated according to EN16783:2017) for the insulation product. PERM increases by the inclusion of bio-phenol and bio-formaldehyde into the formulation:

TABLE 14
Global Warming Potential of foam samples Comp-A1 to A4

| | property | unit | Comp-A1 | Comp-A2 | A1 | A2 | A3 | A4 |
|---|---|---|---|---|---|---|---|---|
| Insulation | PERM | kg CO₂ eq/kg | 0.0 | 2.7 | 2.7 | 2.7 | 10.9 | 13.6 |
| foam | PENRM | [%] | 27.1 | 24.4 | 24.4 | 24.4 | 16.2 | 13.5 |
| | bio-Carbon content | | 3.0 | 13.1 | 13.1 | 13.1 | 43.2 | 53.3 |
| | (dry core density) | | | | | | | |

By including bio-formaldehyde and/or bio-phenol or a combination thereof, the PERM can be increased. In example A4, the PERM is even increased above the value for non-renewable raw materials (PENRM). It is beneficial because it shows that the depletion of fossil materials is significantly reduced.

### Section B

### Example B1 to B4

### Resin Synthesis Comp-B1

To a reaction vessel was added 500 g±10 g fossil phenol, 10 to 40 g water and 0.7 to 1.1 g 50% potassium hydroxide at 50° C. The temperature was raised to 70 to 76° C. and 650 g±10 g of 49% fossil formalin solution was added slowly over 1 to 2 hours to dissipate the heat of the reaction exotherm. To cool the mixture, approximately 300 g of water was removed by distillation under reduced pressure in a time span of 1 hour. The temperature was then raised to the range of 82 to 85° C. and maintained in the range of from 82 to 85° C. until the viscosity of the resin reached 7,500 mPa·s+/−1,500 mPa·s. Cooling was commenced whilst adding 3 g of 90% formic acid to neutralize pH. When the temperature has reduced to below 60° C., the following items were sequentially added: 20 to 60 g polyester polyol plasticiser (preferably 25 g), and 30 to 60 g of urea (preferably 35 g). When urea has dissolved, then 20 to 60 g of ethoxylated castor oil (surfactant; preferably 30 g) are mixed in at 30 to 40° C. The resulting phenolic resin comp-B1 contained 10 to 13 wt. % water, less than 4 wt. % free phenol, and less than 1 wt. % free formaldehyde.

### Resin Synthesis Comp-B2

Identical to Comp-B1, except the fossil formalin is replaced by bio-formalin produced from bio-methanol. The GWP-fossil value of the bio-methanol was approximately 1.07 kg CO₂ eq./kg due to the substrate being a market mix biogas. The GWP-biogenic was approximately −1.38 kg CO₂ eq./kg. The GWP-total of the biomethanol is −0.3 kg CO₂ eq.

### Resin Synthesis B1

Identical to Comp-B1, except the fossil formalin is replaced by bio-formalin produced from bio-methanol. The GWP-fossil of the bio-methanol was approximately 0.6 kg CO₂ eq./kg as a result of the source which was biogas, but in this case the substrate of the biogas was bio-waste (grass). The GWP-total of the bio-methanol is −0.8 kg CO₂ eq./kg (based on a GWP-biogenic of −1.38 kg CO₂ eq/kg for the biomethanol). The resin B1, has a GWP-fossil of 1.55 kg CO₂ eq/kg, a GWP-biogenic of −0.44 kg CO₂ eq/kg, a GWP-luluc of 0.03 kg CO₂ eq/kg and a GWP-total of −1.14 kg CO₂ eq/kg.

### Resin Synthesis B2

Identical to Comp-B1, except the fossil formalin is replaced by bio-formalin produced bio-methanol from syngas. The syngas was produced by gasification of wood with a GWP-fossil of 0.3 kg CO₂ eq/kg. The GWP-total of the bio-methanol is −1.1 kg CO₂ eq/kg (based on a GWP biogenic of −1.38 kg CO₂ eq/kg for the biomethanol). The resin B2, has a GWP-fossil of 1.45 kg CO₂ eq/kg, a GWP-biogenic of −0.44 kg CO₂ eq/kg, a GWP-luluc of 0.03 kg CO₂ eq/kg and a GWP-total of −1.04 kg CO₂ eq/kg.

### Resin Synthesis B3

Identical to Comp-B1, except the fossil phenol is replaced by bio-phenol, produced from bio-naphtha. The source of the bio-naphtha is tall oil (bio-waste from the paper and pulp industry). The GWP-fossil of the bio-phenol is 1.79 kg CO₂ eq/kg. The GWP-total of the resulting resin is −1.13 kg CO₂ eq/kg (based on a GWP-biogenic of −2.81 kg CO₂ eq for the bio-phenol). The resin B3, has a GWP-fossil of 1,48 kg CO₂ eq/kg, a GWP-biogenic of −1.87 kg CO₂ eq/kg, a GWP-luluc of 0.03 kg CO₂ eq/kg and a GWP-total of −0.36 kg CO₂ eq/kg.

### Resin Synthesis B4

Identical to Comp-B1, except the fossil formalin is replaced by bio-formalin produced from bio-methanol. The bio-methanol was produced from syngas made by gasification of wood with a GWP-fossil of 0.3 kg CO₂ eq/kg. The fossil phenol was replaced by bio-phenol produced from bio-naphtha. The source of the bio-naphtha is tall oil (bio-waste from the paper and pulp industry). The GWP-fossil of the bio-phenol is 1.7 kg CO₂ eq/kg. The resin B4,has a GWP-fossil of 1,39 kg CO₂ eq/kg, a GWP-biogenic of −2.32 kg CO₂ eq/kg, a GWP-luluc of 0.03 kg CO₂ eq/kg and a GWP-total of −0.90 kg CO₂ eq/kg.

### Foaming Process B1

To 110+/−2 pbw (pbw=parts by weight) of Resin B1 at 15° C. to 19° C. was added with mixing at 300+/−100 rpm 10+/−1 pbw of isopropyl chloride/isopentane (iPC: iP) blowing agent (weight ratio 80/20) at 1 to 3° C. With a high speed mixer, 20+/−1 pbw of 2:1 weight ratio toluene sulfonic acid: xylene sulfonic acid catalyst at 8 to 15° C. is quickly mixed into the resin blend. High speed mixing at 1,000 to 4,000 rpm is used to achieve intimate mixing so that a foamable composition is produced. Then the foaming resin composition was discharged into a mould to give the desired final foam dry core density, such as 35 kg/m³, at the desired foam thickness such as 20 to 200 mm. The cured foam is removed from the mould and placed in an oven for at least 8 hours at 80 to 100° C. The foam then stands for one week at room temperature before cutting into samples to measure physical properties.

### Comparative Examples Comp-B1 and Comp-B2 and Examples B1 to B4

Comparative foam samples Comp-B1 and Comp-B2 were produced with resin produced using the methods for resin Comp-B1 and resin Comp-B2. The foams were produced using foaming process B1. The foam examples B1 to B4 were produced with resin produced according method resin B1 to B4. The foams were produced using foaming process B1.

The properties of these foam samples were measured and the results are given in Table 15:

TABLE 15
properties of foam samples Comp B1, Comp-B2 and B1 to B4

| | Property | Standard | unit | Comp-B1 | Comp-B2 | B1 | B2 | B3 | B4 |
|---|---|---|---|---|---|---|---|---|---|
| Formulation | Phenolic Resin “type B” | | [pbw] | 110 | 110 | 110 | 110 | 110 | 110 |
| | Acid Catalyst | | | 20 | 20 | 20 | 20 | 20 | 20 |
| | isopropyl chloride | | | 7.6 | 7.6 | 7.6 | 7.6 | 7.6 | 7.6 |
| | isopentane | | | 1.9 | 1.9 | 1.9 | 1.9 | 1.9 | 1.9 |
| Property | Sample thickness | | [mm] | 80 | 80 | 80 | 80 | 80 | 80 |
| | Initial lambda | EN13166/12667 | [W/m · k] | 0.0182 | 0.0178 | 0.0180 | 0.0179 | 0.0175 | 0.0181 |
| | (4 days 70° C. + cond.) | | | | | | | | |
| | Aged lambda | | | 0.0187 | 0.0186 | 0.0189 | 0.0190 | 0.0188 | 0.0186 |
| | (2 weeks @ | | | | | | | | |
| | 110° C. + cond.) | | | | | | | | |
| | Aged lambda | | | 0.0194 | 0.0199 | 0.0193 | 0.0197 | 0.0199 | 0.0190 |
| | (4 weeks @ | | | | | | | | |
| | 110° C. + cond.) | | | | | | | | |
| | Dry core density | EN845 | [kg/m³] | 35.8 | 35.2 | 35.6 | 35.8 | 35.8 | 35.1 |
| | Compressive strength | EN826 | [kPa] | 122 | 120 | 128 | 130 | 115 | 135 |
| | Water vapour | EN12086 | [—] | 35 | | | | | 40 |
| | resistance | | | | | | | | |
| | (μ-value) | | | | | | | | |
| | Fire performance | EN11925-2 | [mm] | <100 | <100 | <100 | <100 | <100 | <100 |
| | (after 30 s) | | | | | | | | |

Again, the foam properties are not affected when biobased formalin and/or biobased phenol is used. Also thermal performance remains stable as a function of time, where the value after 4 weeks @ 110° C. is an indication for the average insulation value over a period of 50 years. The product standard allows 2 sets of conditions to accelerate the ageing of the product (70° C. and 110° C. accelerated ageing). In both cases the outcome is assumed to be comparable. The impact on the Global Warming Potential is summarised in Table 16.

TABLE 16
Global Warming Potential of foam samples Comp-B1 to B4

| | property | unit | Comp-B1 | Comp-B2 | B1 | B2 | B3 | B4 |
|---|---|---|---|---|---|---|---|---|
| Methanol | GWP-fossil | kg CO₂ eq/kg | 0.6 | 1.1 | 0.6 | 0.3 | 0.6 | 0.3 |
| | GWP-biogenic | | 0.0 | −1.4 | −1.4 | −1.4 | 0.0 | −1.4 |
| | GWP-total | | 0.6 | −0.3 | −0.8 | −1.1 | 0.6 | −1.1 |
| | bio-Carbon content | [%] | 0.0 | 37.5 | 37.5 | 37.5 | 0.0 | 37.5 |
| Phenol | GWP-fossil | kg CO₂ eq/kg | 1.8 | 1.8 | 1.8 | 1.8 | 1.7 | 1.7 |
| | GWP-blogenic | | 0.0 | 0.0 | 0.0 | 0.0 | −2.8 | −2.8 |
| | GWP-total | | 1.8 | 1.8 | 1.8 | 1.8 | −1.1 | −1.1 |
| | bio-Carbon content | [%] | 0.0 | 0.0 | 0.0 | 0.0 | 76.5 | 76.5 |
| Insulation | GWP-fossil | kg CO₂ eq/kg | 2.0 | 2.1 | 2.0 | 2.0 | 1.9 | 2.0 |
| foam | GWP-biogenic | | 0.0 | −0.3 | −0.4 | −0.4 | −1.1 | −1.6 |
| | GWP-total foam | | 2.1 | 1.9 | 1.7 | 1.7 | 0.9 | 0.5 |
| | bio-Carbon content | [%] | 2.0 | 12.2 | 12.2 | 12.2 | 32.5 | 42.7 |
| | (dry core density - excl facer) | | | | | | | |

In the GWP total of the foam a GWP-luluc of 0.1 kg CO₂ eq./kg is included. For the phenol and formaldehyde resin the GWP-luluc is below 0.1 kg CO₂ eq./kg (0.03).

Partial replacement of phenol with bio-phenol and/or formaldehyde with bio-formaldehyde or a combination thereof can be used to achieve a desired GWP of the product. The footprint however will be minimised by a full replacement with both bio-phenol and bio-formaldehyde.

The bio-Carbon content is calculated from the molecular weight of the formulation component and the molecular weight of Carbon. In case of bio-formaldehyde, the wt % of formaldehyde in the final product is divided by the molecular weight of formaldehyde (30.0 g/mole). The result is multiplied by the molecular weight (12.0 g/mol) to arrive at the bio-based carbon content. The bio-carbon content is calculated when this figure is divided by the total weight and multiplied by 100%.

For the end product, the dry core density has been used, to eliminate the effect of water. The 2% bio-carbon content for Comp-B1 results from the Ethoxylated castor oil and has been determined via C¹⁴ determination according to EN16640:2017 (Bio-based products—Bio-based carbon content—Determination of the bio-based carbon content using the radiocarbon method) This standard specifies a method for the determination of the bio-based carbon content in products, based on the ¹⁴C content measurement. This European Standard also specifies two test methods to be used for the determination of the ¹⁴C content from which the bio-based carbon content is calculated:—Method A: Liquid scintillation-counter method (LSC);—Method B: Accelerator mass spectrometry (AMS). The bio-based carbon content is expressed by a fraction of sample mass or as a fraction of the total carbon content. This calculation method is applicable to any product containing carbon, including bio composites (a product which is a composite of a resin and reinforcement with natural fibres).

Besides the Global Warming Potential, the Renewable Primary Energy Resources derived from the used raw materials (calculated according EN 16783:2017) for the insulation product, increases by the inclusion of bio-phenol and bio-formaldehyde into the foam formulation:

TABLE 17
Global Warming Potential of foam samples Comp-B1 to B4

| | property | unit | Comp-B1 | Comp-B2 | B1 | B2 | B3 | B4 |
|---|---|---|---|---|---|---|---|---|
| Insulation | PERM | MJ/kg | 0.0 | 2.8 | 2.8 | 2.8 | 8.3 | 11.0 |
| foam | PENRM | MJ/kg | 27.1 | 24.3 | 24.3 | 24.3 | 18.8 | 16.1 |
| | bio-Carbon content | [%] | 2.0 | 12.2 | 12.2 | 12.2 | 32.5 | 42.7 |
| | (dry core density - excl facer) | | | | | | | |

### Example B5

In order to optimise the thermal insulation performance even further, the blowing agent can be changed to an HFO with a very low thermal conductivity in the gas phase. For example HFO 1233zd(E). As the amount of blowing agent is limited, the contribution to the total global warming potential by the blowing agent is limited. The increase of the thermal insulation performance of the product can contribute to a reduction of the CO₂ footprint of the product as less insulation material is needed to obtain the same insulation value. This effect however will not be visible when the functional unit is 1 kg of insulation product.

Example B5 is produced with resin synthesis Comp-B1 and foaming method B1. However, for blowing agent, instead of a mixture of isopropyl chloride (iPC) and isopentane (IP), a mixture of HFO 1233zd(E) and isopentane (95/5 wt %) was used. For foam sample B5, resin preparation B4 was used, where the phenol and formaldehyde were fully replaced by bio-based versions.

Comparative example Comp-B3 was produced in an identical manner to Comp-B1 except the blowing agent was changed to a mixture of HFO 1233zd(E) and isopentane in the same ratio and amount used in B5. The product properties are given in Table 18 and 19.

TABLE 18
Properties of foam samples Comp-B3 and B5

| | Property | Standard | unit | Comp-B3 | B5 |
|---|---|---|---|---|---|
| Formulation | Phenolic Resin “type B” | | [pbw] | 110 | 110 |
| | Acid Catalyst | | | 20 | 20 |
| | 1233zd(E) | | | 13.5 | 13.5 |
| | isopentane | | | 0.8 | 0.8 |
| Property | Sample thickness | | [mm] | 80 | 80 |
| | Initial lambda (4 days 70° C. + cond.) | EN13166/12667 | [W/m · k] | 0.0159 | 0.0157 |
| | Aged lambda (2 weeks @ 110° C. + cond.) | | | 0.0167 | 0.0169 |
| | Aged lambda (4 weeks @ 110'° C. + cond.) | | | 0.0178 | 0.0180 |
| | Dry core density | EN845 | [kg/m³] | 35.6 | 35.4 |
| | Compressive strength | EN826 | [kPa] | 125 | 133 |
| | Water vapour resistance (μ-value) | EN12086 | [—] | | |
| | Friability 10′ | ISO6187 | [%] | | |
| | Fire performance (after 30 s) | EN11925-2 | [mm] | <100 | <100 |

The GWP-total of HFO 1233zd(E) in the Gabi database (version: GaBi ts 9.2 Gabi ts 9.2 (Service Packs 39)) is 11 kg/CO₂ eq./kg. This means that the GWP-total of the product is negatively affected.

TABLE 19
Global Warming Potential of foam samples Comp-B3 to B5

| | property | unit | Comp-B3 | B5 |
|---|---|---|---|---|
| Methanol | GWP-fossil | kg CO₂ eq/kg | 0.6 | 0.3 |
| | GWP-biogenic | | 0.0 | −1.4 |
| | GWP-total | | 0.6 | −1.1 |
| | bio-Carbon content | [%] | 0.0 | 37.5 |
| Phenol | GWP-fossil | kg CO₂ eq/kg | 1.8 | 1.7 |
| | GWP-biogenic | | 0.0 | −2.8 |
| | GWP-total | | 1.8 | −1.1 |
| | bio-Carbon content | [%] | 0.0 | 76.5 |
| Insulation | GWP-fossil | kg CO₂ eq/kg | 3.0 | 3.0 |
| foam | GWP-biogenic | | 0.0 | −1.6 |
| | GWP-total foam | | 3.0 | 1.5 |
| | bio-Carbon content | [%] | 2.0 | 42.5 |
| | (dry core density) | | | |

In the GWP total of the foam a GWP-luluc of 0.1 kg CO₂ eq./kg is included. For the phenol and formaldehyde the GWP-luluc is below 0.1 kg CO₂ eq./kg.

Due to the higher thermal performance of B5 compared to B4, 10% less material is required. However the increase in GWP total, due to the addition of the HFO overrides this effect. There is however a discussion ongoing to update the profile of the HFO in the Gabi database. If this new profile is accepted the GWP of the HFO will be lowered from 11 to 3 kg CO₂ eq./kg. In that case the increase of the GWP-total as result of addition of HFO will become 0.2 kg CO₂ eq./kg, making addition of HFO's feasible.

The thermal performance increases by 10%, whereas the GWP-total expressed per kg foam, does not increase by the same extent when compared to B1-B4. The same is observed when foam formulations of section A and section B are compared. The thermal conductivity (lambda value) of sample Comp-A1 after 50 weeks ageing at 70° C., which simulates the average thermal performance of the product over a time span of 50 years, is below 0.026 W/m·K. This is well below the thermal performance of any bio-based insulation material, as presented in Table 3. The product blown with cyclopentane-isopentane blowing agent results in a total GWP of 2.0 kg CO₂ eq./kg (Cradle-to-gate). When comp-A1 is compared to comp-B1, the thermal conductivity (lambda) values are below 0.021 W/m·K after 4 weeks ageing at 110° C. (which is comparable to 50 weeks ageing at 70° C.) which simulates the average performance of 50 years in application for the foam product. This effect can be attributed to a large extent to the blowing agent, which in this example is a mixture of isopropyl chloride and isopentane. It is interesting that the total GWP does not increase significantly. The thermal insulation performance however is 25% improved. This means that the CO₂ footprint to achieve the same thermal performance is much better. The difference using a HFO blowing agent is less. Based on these findings, at least 70% of the blowing agent should consist of a component with a thermal conductivity in the gas phase at 25° C. of 12 mW/m·k or less. Preferable 11.8 mW/m·k or less.

### Resin Synthesis C1 and D1

The preparation of resin types C1 and D1 are identical to resin type B4 apart from the following. For resin C1, the amount of formalin is reduced to 585 g of 49 w % formalin to obtain an F/P-mole ratio of 1.8:1. After formalin addition, 270 g water is removed by means of vacuum distillation. The amount of urea was decreased to 30 g. For resin D1, the amount of 49 w % formalin is increased to 715 g to obtain an F:P mole ratio of 2.2:1. In this preparation, 330 g of water is removed by vacuum distillation. The amount of urea was increased to 69 g.

These samples were foamed according foam preparation Comp-B1. The foam properties of these samples are presented in Table 20.

TABLE 20
Properties of samples C1 and D1

| | Property | Standard | unit | C1 | B4 | D1 |
|---|---|---|---|---|---|---|
| Formulation | Phenolic Resin | | [pbw] | 110 | 110 | 110 |
| | Acid Catalyst | | | 20 | 20 | 20 |
| | isopropyl chloride | | | 7.5 | 7.6 | 7.6 |
| | isopentane | | | 1.9 | 1.9 | 1.9 |
| Property | Sample thickness | | [mm] | 80 | 80 | 80 |
| | Initial lambda (4 days 70° C. + cond.) | EN13166/12667 | [W/m · K] | 0.0180 | 0.0181 | 0.0177 |
| | Aged lambda (2 weeks @ 110° C. + cond.) | | | 0.0189 | 0.0186 | 0.0186 |
| | Aged lambda (4 weeks @ 110° C. + cond.) | | | 0.0197 | 0.0190 | 0.0199 |
| | Dry core density | EN845 | [kg/m³] | 35.6 | 35.3 | 35.2 |
| | Compressive strength | EN826 | [kPa] | 128 | 130 | 95 |
| | Water vapour resistance (μ-value) | EN12086 | [—] | | | |
| | Friability 10′ | ISO6187 | [%] | | | |
| | Fire performance (after 30 s) | EN11925-2 | [mm] | <100 | <100 | <100 |

A further change in the F/P-mole ratio will not substantially change the CO₂ footprint of the product. The reason is that the total GWP for bio-phenol and bio formaldehyde are of the same magnitude in this case, when bio-waste as a raw material source is selected. However when the F/P mole ratio in the product increases to 2.5:1, the thermal and fire performance will be negatively affected.

TABLE 21
Global Warming Potential of foam samples C1, B4 and D1

| | property | unit | C1 | B4 | D1 |
|---|---|---|---|---|---|
| Methanol | GWP-fossil | kg CO₂ eq/kg | 0.3 | 0.3 | 0.3 |
| | GWP-biogenic | | −1.4 | −1.4 | −1.4 |
| | GWP-total | | −1.1 | −1.1 | −1.1 |
| | bio-Carbon content | [%] | 37.5 | 37.5 | 37.5 |
| Phenol | GWP-fossil | kg CO₂ eq/kg | 1.7 | 1.7 | 1.7 |
| | GWP-biogenic | | −2.8 | −2.8 | −2.8 |
| | GWP-total | | −1.1 | −1.1 | −1.1 |
| | bio-Carbon content | [%] | 76.5 | 76.5 | 76.5 |
| Insulation | GWP-fossil | kg CO₂ eq/kg | 2.0 | 2.0 | 2.0 |
| foam | GWP-biogenic | | −1.5 | −1.6 | −1.6 |
| | GWP-total foam | | 0.5 | 0.5 | 0.5 |
| | bio-Carbon content | [%] | 42.3 | 42.7 | 43.1 |
| | (dry core | | | | |
| | density - | | | | |
| | excl facer) | | | | |

In the GWP total of the foam a GWP-luluc of 0.1 kg CO₂ eq./kg is included. For the phenol and formaldehyde the GWP-luluc is below 0.1 kg CO₂ eq./kg.

A change in the F:P-mole ratio does not affect the total GWP of the insulation foam in a significant way in case both phenol and formaldehyde are bio-based. When only a part is replaced or a combination of replacement, the F:P mole ratio can be a factor to consider. An increase of the mole ratio between phenol and formaldehyde, will result in an increase of the renewable content weight.

There is no significant impact of the PENRM when the F:P mole ratio is changed.

### Example E1—Use of Sulphonated Kraft Lignin (1)

### Resin Synthesis E1

Process identical to the one described in resin preparation example comp-A1, but 20% by weight of the phenol input has been replaced by a sulphonated Kraft lignin (Reax 100M supplied by Ingevity). Two additives, ethoxylated castor oil surfactant and dimethylphthalate were added in the cool down phase of the resin synthesis in the same ratio as described in example comp-A1.

Reax 100M is a sulphonated Kraft lignin, molecular weight approximately 2000 D. The molecular weight (Mw) of a molecule/atom is usually expressed in g/mol. However in biochemistry and polymer chemistry, one uses more the unit Dalton (D or Da) instead of g/mol, but both units are the same: 1 g/mol=1 D or Da. Polymers, like lignin, are not well defined chemical structures meaning they do not have a well determined molecular weight like e.g. water, sulphuric acid, . . . . Such compounds contain molecules which are very similar but have different molecular weight. In the case of such compounds we have to speak of a molecular weight distribution. To translate this distribution into a single number, two expressions are commonly used:
1) Mw=weight average molecular weight which is the arithmetic mean molecular weight
2) Mn=number average molecular weight, which takes also into account the number of molecules with a certain molecular weight (weighted average)
   Molecular weight of such compounds is measured with GPC (Gel Permeation Chromatography). The compound is solubilized in a solvent, led over a porous gel. The higher the molecular weight, the longer it takes to go through the gel column op the GPC equipment. The residence time is in direct relation to the molecular weight and can be identified by calibration with compounds where the molecular weight is known.

The sulphonation degree is about 3.4. The degree of sulphonation is measured as input of the sulphonation process. A sulphonation degree of 1.5 means that 1.5 mole of sulphonic acid is added to 1 kg of lignin for the sulphonation. (The total sulphur content is the sum of the added sulphur plus the amount of sulphur added in the sulphonation.)

The cation used is sodium.

The final resin properties are presented in Table 22:

TABLE 22
Resin properties example E1

| Property | unit | Value |
|---|---|---|
| Viscosity @ 25° C. | cPs | 5110 |
| Free Formaldehyde | % | 0.6 |
| Free Phenol | % | 3.9 |
| Water content | % | 17.1 |
| pH | — | 8.2 |

### Foaming Process E1

Load 400 g of the above resin into a can, add 0.96 g nucleator (a perfluoro compound) and 22 g blowing agent (mix of cyclo and isopentane ratio 70/30 wt %) and mix to an homogeneous phenolic resole blend. Hold this chemical blend for two hours at 20° C.

Add 60 g curing acid (mix of sulphuric and phosphoric acid) to the phenolic resole blend, mix for 20 minutes and pour the reacting mix into wooden mould preheated to 70° C. Put mould in an oven preheated to 70° C. for 4 hours.

Demould the foam after 4 hours curing. Leave the foam as it is for one week at room conditions (i.e. temperature and relative humidity) before cutting to samples to 80 mm thickness to measure the physical properties.

Comparative foam example Comp-E1 was produced in a identical way as comparative example Comp-A1.

TABLE 23
Foam properties of sample E1 with 20% replacement of phenol by Reax 100M

| | Property | Standard | unit | Comp-E1 | E1 |
|---|---|---|---|---|---|
| Property | Wet density | EN845 | [kg/m³] | 44.0 | 46.2 |
| | Dry core density | | | 37.5 | 39 |
| | Compressive strength X | EN826 | [kPa] | 163 | 150 |
| | Compressive strength Y | | [kPa] | 85 | 103 |
| | Friability 10′ | ISO6187 | | 14.1 | 19.1 |
| | Thermal conductivity initial | EN14314/EN12667 | [W/m · K] | 0.0234 | 0.0244 |
| | Thermal conductivity 1 day 70° C. | | | 0.0218 | 0.0217 |
| | Thermal conductivity 1 week 70° C. | | | 0.0231 | 0.0239 |
| | Thermal conductivity 25 weeks 70° C. | | | 0.025 | 0.0252 |
| | Thermal conductivity 50 weeks 70° C. + cond | | | 0.0261 | 0.0259 |

### Example E2—Use of Sulphonated Kraft Lignin (2)

### Resin Synthesis E2

Process identical to the one described in resin preparation example comp-A1, but 20% of the phenol input has been replaced by a sulphonated Kraft lignin (Kraftsperse 25M supplied by Ingevity). Two additives, ethoxylated castor oil and dimethylphthalate were added in the cool down phase of the resin synthesis in the same ratio as described in Comp-A1. Kraftsperse 25M is a sulphonated Kraft lignin, molecular weight approximately 4400 D and a sulphonation degree about 2.9. Cation used is sodium.

The final resin properties are given in Table 24:

TABLE 24
Resin properties example E1

| Property | unit | Value |
|---|---|---|
| Viscosity @ 25° C. | cPs | 4340 |
| Free Formaldehyde | % | 0.9 |
| Free Phenol | % | 3.5 |
| Water content | % | 17.9 |
| pH | — | 8.4 |

The resin was foamed using the same foaming process E1.

Comparative example Comp-E2 was produced in an identical way as example Comp-A1.

The product properties are given in Table 25:

TABLE 25
Foam properties of sample E2 with 20% replacement of phenol by Kraftsperse 25M

| | Property | Standard | unit | Comp-E2 | E2 |
|---|---|---|---|---|---|
| Property | Wet core density | EN845 | [kg/m³] | 42.0 | 45.3 |
| | Dry core density | | | 35.4 | 37.7 |
| | Compressive strength X | EN826 | [kPa] | 160 | 170 |
| | Compressive strength Y | | [kPa] | 70 | 105 |
| | Friability 10′ | ISO6187 | | 16.7 | 28.4 |
| | Thermal conductivity initial | EN14314/EN12667 | [W/m · K] | 0.0228 | 0.0215 |
| | Thermal conductivity 1 day 70° C. | | | 0.0215 | 0.0217 |
| | Thermal conductivity 1 week 70° C. | | | 0.0230 | 0.0232 |
| | Thermal conductivity 25 weeks 70° C. | | | 0.0248 | 0.0249 |
| | Thermal conductivity 50 weeks 70° C. + cond | | | 0.0255 | 0.0260 |

The introduction of the sulphonated Kraft lignin, does not negatively influence the density and thermal insulation performance and physical properties like the compressive strength and friability.

### Example F1—Use of Sulphonated Kraft Lignin (2)

### Resin Synthesis F1

Process identical to the one described in comparative example Comp-B1, however 20% of the phenol input has been replaced by a sulphonated Kraft lignin (Kraftsperse 25M supplied by Ingevity).

The resulting phenolic resin composition Resin F1 contained 10 to 13 wt. % water, less than 4 wt. % free phenol, and less than 1 wt. % free formaldehyde.

### Foaming Process F1

Identical to foaming proces B1.

Comparative example Comp-F1 was produced in a identical way as Comp-B1.

TABLE 26
Foam properties of sample F1 with 20% replacement of phenol by Kraftsperse 25M

| | Property | Standard | unit | Comp-F1 | F1 |
|---|---|---|---|---|---|
| Formulation | Phenolic Resin | | [pbw] | 110 | 110 |
| | Acid Catalyst | | | 20 | 20 |
| | isopropyl chloride | | | 7.6 | 7.6 |
| | isopentane | | | 1.9 | 1.9 |
| Property | Sample thickness | | [mm] | 80 | 80 |
| | Initial lambda (4 days 70° C. + cond.) | EN13166/12667 | [W/m · K] | 0.0180 | 0.0181 |
| | Aged lambda (2 weeks @ 110° C. + cond.) | | | 0.0189 | 0.019 |
| | Aged lambda (4 weeks @ 110° C. + cond.) | | | | |
| | Dry core density | EN845 | [kg/m³] | 35.3 | 35.8 |
| | Compressive strength | EN826 | [kPa] | 123 | 122 |
| | Water vapour resistance (p-value) | EN12086 | [—] | | |
| | Friability 10′ | ISO6187 | [%] | | |
| | Fire performance (after 30 s) | EN11925-2 | [mm] | <100 | <100 |

### Comparative Example Comp-E3—Use of Sulphonated Kraft Lignin (3)

### Resin Synthesis Comp-E3

Process identical to the one described in comparative example comp-A1 but 20% of the phenol input has been replaced by a sulphonated Kraft lignin (Hyact supplied by Ingevity). Two additives, ethoxylated castor oil surfactant and dimethylphtalate were added in the cool down phase of the resin synthesis in the same ratio as described in comparative example A1. Hyact is a sulphonated Kraft lignin, molecular weight approximately 23000 D and a sulphonation degree about 0.8. Cation used is sodium.

Final properties of the resin:

TABLE 27
Resin properties comp example E3

| Property | unit | Value |
|---|---|---|
| Viscosity @ 25° C. | cPs | 2530 |
| Free Formaldehyde | % | 0.91 |
| Free Phenol | % | 5.32 |
| Water content | % | 17.0 |
| pH | — | 8.1 |

### Foaming Process Comp-E3: Identical to Example E1

### Comparative Example E4—Use of Sulphonated Kraft Lignin (4)

### Resin Synthesis Comp-E4

Process identical to the one described in comparative example A1, but 20% of the phenol input has been replaced by a sulphonated Kraft lignin (Polyfon supplied by Ingevity). Two additives, ethoxylated castor oil surfactant and dimethylphtalate were already added in the cool down phase of the resin synthesis in the same ratio as described in comparative example A1. Polyfon is a sulphonated Kraft lignin, molecular weight approximately 4300 D and a sulphonation degree about 0.7. Cation used is sodium.

Final properties of the resin:

TABLE 28
Resin properties comp example E4

| Property | unit | Value |
|---|---|---|
| Viscosity @ 25° C. | cPs | 2600 |
| Free Formaldehyde | % | 0.59 |
| Free Phenol | % | 5.94 |
| Water content | % | 16.7 |
| pH | — | 8.1 |

### Foaming Process Comp-E4: Identical to Example Comp-E1

The properties of the foam comparative foam samples comp-E3 and comp-E4 are given in Table 29:

TABLE 29
Product properties comparative example comp-E3 and comp-E4.

| | Property | Standard | unit | Comp-E2 | E2 | Comp-E3 | Comp-E4 |
|---|---|---|---|---|---|---|---|
| Property | Wet core density | EN845 | [kg/m³] | 42.0 | 45.3 | 38.4 | 39.4 |
| | Dry core density | | | 35.4 | 37.7 | 31.9 | 33.3 |
| | Compressive strength X | EN826 | [kPa] | 160 | 170 | 106 | 114 |
| | Compressive strength Y | | [kPa] | 70 | 105 | 75 | 76 |
| | Friability 10′ | ISO6187 | [%] | 16.7 | 28.4 | 67.6 | 59.6 |
| | Thermal conductivity initial | EN14314/EN12667 | [W/m · K] | 0.0228 | 0.0215 | 0.0249 | 0.0233 |
| | Thermal conductivity 1 day 70° C. | | | 0.0215 | 0.0217 | 0.0293 | 0.0292 |
| | Thermal conductivity 1 week 70° C. | | | 0.0230 | 0.0232 | 0.0298 | 0.0293 |
| | Thermal conductivity 25 weeks 70° C. | | | 0.0248 | 0.0249 | 0.0305 | 0.0300 |
| | Thermal conductivity 50 weeks 70° C. + cond. | | | 0.0255 | 0.0260 | | |

Comparative experiment comp-E3 and comp-E4 indicate phenol can be replaced by a sulphonated lignin however long term thermal insulation performance and friability are compromised compared to full phenol based foam. Condition for good performance is that a sulphonated Kraft is used with a high sulphonation degree (moles of sulfonic acid groups per 1,000 unit weight of lignin), at least above 1.5. Molecular weight can have a large range, between 2,000 and 23,000 D.

TABLE 30
properties of sulfonated lignins

| | | | | Surface tension | Total | |
|---|---|---|---|---|---|---|
| | | | Degree of | (1% aqueous) | Sulfur | |
| Example | Lignin | Mw | sulfonation | [mN/mm] | [%] | pH |
| E1/F1 | Reax 100M | 2000 | 3.4 | 48.9 | 12.3 | 8.3 |
| E2 | Kraftperse 25M | 4400 | 2.9 | 52.5 | 9.8 | 8.5 |
| Comp-E3 | Hyact | 23000 | 0.8 | 59.3 | 4.8 | 10.4 |
| Comp-E4 | Polyfon H | 4300 | 0.7 | 55 | 4.2 | 9.8 |

Mechanical properties like friability and compressive strength can be corrected with the choice of surfactant and/or plasticizing agent. In example E3, the surfactant is modified to improve the friability.

### Example E3—Use of Sulphonated Kraft Lignin (5)

### Resin Synthesis E3

Process identical to the one described in comparative example comp-E2 where 20% of the phenol has been replaced by a sulphonated Kraft lignin (Kraftsperse 25M supplied by Ingevity).

Final properties of the resin:

TABLE 31
Resin properties example E3

| Property | unit | Value |
|---|---|---|
| Viscosity @ 25° C. | cPs | 1780 |
| Free Formaldehyde | % | 0.7 |
| Free Phenol | % | 5.4 |
| Water content | % | 18.7 |
| pH | — | 8.2 |

### Foaming Process E3

Load 368 g of the above resin into a 1 l can, add 16 g surfactant (silicone surfactant Niax L5356) and 16 g plasticizing agent (dimethylphtalate) and mix to an homogeneous resole blend. Add 3.0 g nucleator (a perfluoro compound) and 22 g blowing agent (mix of cyclo and isopentane ratio 70/30 wt %) and mix to an homogeneous blend. Hold this chemical blend for two hours at 20° C.

Add 60 g curing acid (mix of sulphuric and phosphoric acid) to the resole blend, mix for 20 minutes and pour the reacting mix into wooden mould preheated to 70° C. Put a floating lid on the mix and put in an oven preheated to 70° C. for 4 hours.

Demould the foam after 4 hours curing. Leave the foam as it is for one week at room conditions before cutting to samples to measure physical properties.

The properties of the foam comparative foam samples E3 is given in Table 32:

TABLE 32
Product properties example E3.

| | Property | Standard | unit | Comp-E2 | E2 | E3 | Comp-E3 | Comp-E4 |
|---|---|---|---|---|---|---|---|---|
| Property | Wet core density | EN845 | [kg/m³] | 42.0 | 45.3 | 42.4 | 38.4 | 39.4 |
| | Dry core density | | | 35.4 | 37.7 | 36.1 | 31.9 | 33.3 |
| | Compressive strength X | EN826 | [kPa] | 160 | 170 | 213 | 106 | 114 |
| | Compressive strength Y | | [kPa] | 70 | 105 | 96 | 75 | 76 |
| | Friability 10′ | ISO6187 | [%] | 16.7 | 28.4 | 20.6 | 67.6 | 59.6 |
| | Thermal conductivity initial | EN14314/EN12667 | [W/m · K] | 0.0228 | 0.0215 | 0.0203 | 0.0249 | 0.0233 |
| | Thermal conductivity | | | 0.0215 | 0.0217 | 0.0212 | 0.0293 | 0.0292 |
| | 1 day 70° C. | | | | | | | |
| | Thermal conductivity | | | 0.0230 | 0.0232 | 0.0224 | 0.0298 | 0.0293 |
| | 1 week 70° C. | | | | | | | |
| | Thermal conductivity | | | 0.0248 | 0.0249 | 0.0249 | 0.0305 | 0.0300 |
| | 25 weeks 70° C. | | | | | | | |
| | Thermal conductivity | | | 0.0255 | 0.0260 | 0.0258 | | |
| | 50 weeks 70° C. + cond. | | | | | | | |

### Example G1—Use of Phenolated Kraft Lignin

### Resin Synthesis G1

Process is identical to the one described in comparative example Comp-A1, but 20% of the phenol input has been replaced by a phenolated Kraft lignin (BioPiva supplied by UPM). Two additives, ethoxylated castor oil surfactant and dimethylphtalate were already added in the cool down phase of the resin synthesis in the same ratio as described in example Comp-A1.

BioPiva has been phenolated prior to the resin synthesis using sulphuric acid. Molecular weight has not changed during phenolation (3000 to 3500 D). Phenolation process has increased the level of aromatic OH from approximately 4 to 6 mmol/g

Final properties of the resin:

TABLE 33
Resin properties example E3

| Property | unit | Value |
|---|---|---|
| Viscosity @ 25° C. | cPs | 2340 |
| Free Formaldehyde | % | 0.41 |
| Free Phenol | % | 7.3 |
| Water content | % | 16.5 |
| pH | — | 8.2 |

### Foaming process G1: Identical to Example Comp-A1

Comparative example Comp-G1 was produced in a identical way as Comp-A1.

The properties of the foam sample G1 and comparative foam sample Comp-G1 are given in Table 34:

TABLE 34
Product properties example G1 BioPiva phenolated Kraft lignin.

| | Property | Standard | unit | Comp-G1 | G1 |
|---|---|---|---|---|---|
| Property | Wet core density | EN845 | [kg/m³] | 41.1 | 46.2 |
| | Dry core density | | | 34.6 | 39.8 |
| | Compressive strength X | EN826 | [kPa] | 157 | 156 |
| | Compressive strength Y | | [kPa] | 66 | 86 |
| | Friability 10′ | ISO6187 | [%] | 17.2 | 31.1 |
| | Thermal conductivity inital | EN14314/EN12667 | [W/m · K] | 0.023 | 0.0226 |
| | Thermal conductivity 1 day 70° C. | | | 0.0212 | 0.0216 |
| | Thermal conductivity 1 week 70° C. | | | 0.0231 | 0.0238 |
| | Thermal conductivity 25 weeks 70° C. | | | 0.0252 | 0.0255 |
| | Thermal conductivity 50 weeks 70° C. + cond. | | | 0.0259 | 0.0263 |

### Example G2—Use of phenolated Kraft Lignin (2)

### Resin Synthesis G2

Loading of the lab reactor with Lineo Classic lignin, supplied by Stora Enso, part of

the phenol and an acidic catalyst to perform the phenolation. Phenolation ended by bringing the mix into an alkaline environment. Adding the remaining phenol and water, adjusting the temperature and meter gradually all the formalin keeping reaction temperature to about 80° C., while removing excess water via distillation. When the target MW is reached, neutralize with formic acid 85% and start cooling down to about 50° C. Add water to correct for specification on water level and further cool down to room temperature. Two additives, ethoxylated castor oil surfactant and dimethylphtalate are added in the cool down phase of the resin synthesis in the same ratio as described in example Comp-A1.

Final properties of the resin:

TABLE 35
Resin properties example G2

| Property | unit | Value |
|---|---|---|
| Viscosity @ 25° C. | cPs | 2560 |
| Free Formaldehyde | % | 1 |
| Free Phenol | % | 6.6 |
| Water content | % | 16.8 |
| pH | — | 7.9 |

### Foaming process G2: Identical to Example Comp-A1

Comparative example Comp-G2 was produced in a identical way as Comp-A1.

Properties:

TABLE 36
Product properties example G2 phenolated Lineo Classic lignin.

| | Property | Standard | unit | Comp-G2 | G2 |
|---|---|---|---|---|---|
| Property | Wet core density | EN845 | [kg/m³] | 41.5 | 41.4 |
| | Dry core density | | | 35.8 | 36.3 |
| | Compressive strength X | EN826 | [kPa] | 164 | 121 |
| | Compressive strength Y | | [kPa] | 84 | 69 |
| | Friability 10′ | ISO6187 | [%] | 14.1 | 36.6 |
| | Thermal conductivity initial | EN14314/EN12667 | [W/m · K] | 0.0231 | 0.0219 |
| | Thermal conductivity 1 day 70° C. | | | 0.0211 | 0.0212 |
| | Thermal conductivity 1 week 70° C. | | | 0.0228 | 0.0235 |
| | Thermal conductivity 25 weeks 70° C. | | | 0.0248 | 0.0250 |
| | Thermal conductivity 50 weeks 70° C. + cond. | | | 0.0257 | 0.0260 |

The total phenolic OH needs to be at least 3 mmole/g to obtain a foam with the required properties.

TABLE 37
Product properties example G2 phenolated Lineo Classic lignin.

| | | | Total |
|---|---|---|---|
| | | Mw | phenolic OH |
| Example | Lignin | [D] | [mmole/g] |
| G1 | BioPiva 395 - | 5,500-6,500 | 4-6 |
| | phenolated | | |
| H1 | Lineo Classic | 5,500-7,500 | 4-5 |
| Comp-J1 | Bio-Piva | 3,000-3,500 | |

### Example G3—Use of Phenolated Kraft Lignin (3)

### Resin Synthesis G3

Process identical to the one described in example G2, however omitting the addition of both surfactant and plasticizing agent.

Final properties of the resin:

TABLE 38
Resin properties example G2

| Property | unit | Value |
|---|---|---|
| Viscosity @ 25° C. | cPs | 2440 |
| Free Formaldehyde | % | 0.3 |
| Free Phenol | % | 7.6 |
| Water content | % | 18.2 |
| pH | — | 8.0 |

### Foaming Process G3

Load 368 g of the above resin into a 1 l can, add 16 g surfactant (silicone surfactant Niax L5356) and 16 g plasticizing agent (dimethylphtalate) and mix to an homogeneous blend. Add 3.0 g nucleator (a perfluoro compound) and 22 g blowing agent (mix of cyclo and isopentane ratio 70/30 wt %) and mix to an homogeneous blend. Hold this chemical blend for two hours at 20° C.

Add 60 g curing acid (mix of sulphuric and phosphoric acid) to the resole blend, mix for 20″ and poor the reacting mix into wooden mould preheated to 70° C. Put a floating lid on the mix and put in an oven preheated to 70° C. for 4 hours.

Demould the foam after 4 hours curing. Leave the foam as it is for one week at room conditions before cutting to samples to measure physical properties.

Comparative example Comp-G3 was produced in a identical way as Comp-A1.

TABLE 39
Product properties example G2 phenolated Lineo Classic lignin.

| | Property | Standard | unit | Comp-G3 | G3 |
|---|---|---|---|---|---|
| Property | Wet density | EN845 | [kg/m³] | 40.5 | 40.3 |
| | Dry core density | | | 34.4 | 35.3 |
| | Compressive strength X | EN826 | [kPa] | 158 | 139 |
| | Compressive strength Y | | [kPa] | 71 | 68 |
| | Friability 10′ | ISO6187 | [%] | 10.4 | 19.4 |
| | Thermal conductivity inital | EN14314/EN12667 | [W/m · K] | 0.0219 | 0.0196 |
| | Thermal conductivity 1 day 70° C. | | | 0.0209 | 0.0216 |
| | Thermal conductivity 1 week 70° C. | | | 0.023 | 0.0239 |
| | Thermal conductivity 25 weeks 70° C. | | | 0.0247 | 0.0248 |
| | Thermal conductivity 50 weeks 70° C. + cond | | | 0.0258 | 0.0258 |

### Example H1—Use of Pyrolytic Lignin

### Resin Synthesis H1

Process identical to the one described in example Comp-A1, but 20% of the phenol input has been replaced by a pyrolytic lignin (supplied by BTG). The pyrolytic lignin had a Molecular weight of from 300-5000 D. Two additives, ethoxylated castor oil surfactant and dimethylphtalate were added in the cool down phase of the resin synthesis in the same ratio as described in example 1.

Final properties of the resin:

TABLE 40
Resin properties example H1

| Property | unit | Value |
|---|---|---|
| Viscosity @ 25° C. | cPs | 9089 |
| Free Formaldehyde | % | 2.0 |
| Free Phenol | % | 5.1 |
| Water content | % | 16.0 |
| pH | — | 7.1 |

### Foaming process H1: Identical to Example Comp-A1

Comparative example Comp-H1 was produced in a identical way as Comp-A1.

Properties:

TABLE 41
Product properties example H1 pyrolytic lignin.

| | Property | Standard | unit | Comp-H1 | H1 |
|---|---|---|---|---|---|
| Property | Sample thickness | EN845 | [kg/m³] | 41.6 | 42.9 |
| | Dry core density | | | 35 | 35.6 |
| | Compressive strength X | EN826 | [kPa] | 160 | 153 |
| | Compressive strength Y | | [kPa] | 72 | 75 |
| | Friability 10′ | ISO6187 | [%] | 20.9 | 40.3 |
| | Thermal conductivity initial | EN14314/EN12667 | [W/m · K] | 0.0225 | 0.0206 |
| | Thermal conductivity 1 day 70° C. | | | 0.0208 | 0.0210 |
| | Thermal conductivity 1 week 70° C. | | | 0.0225 | 0.0228 |
| | Thermal conductivity 25 weeks 70° C. | | | 0.0249 | 0.0252 |
| | Thermal conductivity 50 weeks 70° C. + cond | | | 0.0259 | 0.0261 |

The fire performance of the samples E1-3, G1-3, H1 and their comparative examples all resulted in a flame height below 100 mm measured according EN 11925-2:2020 (after 30 seconds).

### Example I1 to I7—Use of Pyrolytic Lignin

### Resin Synthesis I1, I3, I4 and I5

Process identical to the one described in comparative example Comp-B1 but 10% of the phenol input has been replaced by the same pyrolytic lignin as in H1.

The resulting phenolic resin composition Resin 11 contained 10.8 wt. % water, less than 5 wt. % free phenol, and less than 1 wt. % free formaldehyde. Final properties of the resin:

TABLE 42
Resin properties example I1

| Property | unit | Value |
|---|---|---|
| Viscosity @ 25° C. | cPs | 8450 |
| Free Formaldehyde | % | 0.4 |
| Free Phenol | % | 4.6 |
| Water content | % | 10.8 |
| pH | — | 7.2 |

### Resin Synthesis I2 and I6

Process identical to the one described in comparative example Comp-B1 but 20% of the phenol input has been replaced by the pyrolytic lignin of example H1.

### Resin Properties

TABLE 43
Resin properties example I2

| Property | unit | Value |
|---|---|---|
| Viscosity @ 25° C. | cPs | 7470 |
| Free Formaldehyde | % | 0.4 |
| Free Phenol | % | 4.9 |
| Water content | % | 10.5 |
| pH | — | 7.1 |

### Resin Synthesis I7

Process identical to the one described in comparative example Comp-B1 but 30% of the phenol input has been replaced by the same pyrolytic lignin as in H1.

### Resin Properties

TABLE 44
Resin properties example I7

| Property | unit | Value |
|---|---|---|
| Viscosity @ 25° C. | cPs | 7660 |
| Free Formaldehyde | % | 0.6 |
| Free Phenol | % | 4.4 |
| Water content | % | 11.8 |
| pH | — | 7.0 |

### Foaming Process I1 to I7: Identical to Example Comp-B1

Comparative examples Comp-I1, I3, I4 and I5 were produced in a identical way as Comp-B1.

The produced foam samples were analysed and the results are summarised in table 45.

TABLE 45
Product properties example I1 to I7 with BTG pyrolytic lignin ranging from 10 to 30%.

| | Property | Standard | unit | Comp-I1 | I1 | I2 | Comp-I3 | I3 |
|---|---|---|---|---|---|---|---|---|
| Formulation | Phenolic Resin | | [pbw] | 110 | 110 | 110 | 110 | 110 |
| | Acid Catalyst | | | 20 | 20 | 20 | 20 | 20 |
| | isopropyl chloride | | | 7.6 | 7.6 | 7.6 | 7.6 | 7.6 |
| | isopentane | | | 1.9 | 1.9 | 1.9 | 1.9 | 1.9 |
| Property | Sample thickness | | [mm] | 75 | 75 | 75 | 25 | 25 |
| | Initial lambda | EN13166/12667 | [W/m · K] | 0.0180 | 0.0175 | 0.0187 | 0.0191 | 0.0189 |
| | (4 days | | | | | | | |
| | 70° C. + cond.) | | | | | | | |
| | Aged lambda | | | 0.0187 | 0.0186 | 0.0192 | 0.0198 | |
| | (2 weeks @ | | | | | | | |
| | 110° C.) | | | | | | | |
| | Aged lambda | | | 0.019 | | 0.0196 | 0.1990 | |
| | (2 weeks @ | | | | | | | |
| | 110° C. + cond.) | | | | | | | |
| | Dry core density | EN845 | [kg/m³] | 33.5 | | 32.1 | 35.2 | |
| | Compressive | EN826 | [kPa] | 125 | 108 | 129 | 145 | 150 |
| | strength | | | | | | | |
| | Closed cell content | | [%] | 96.0 | | 95.4 | 96.0 | |
| | Friability 10′ | ISO6187 | [%] | | | 22 | | 10 |
| | Fire performance | EN11925-2 | [mm] | <100 | <100 | <100 | | |
| | (after 30 s) | | | | | | | |

| | Property | Comp-I4 | I4 | Comp-I5 | I5 | I6 | I7 |
|---|---|---|---|---|---|---|---|
| Formulation | Phenolic Resin | 110 | 110 | 110 | 110 | 110 | 110 |
| | Acid Catalyst | 20 | 20 | 20 | 20 | 20 | 20 |
| | isopropyl chloride | 7.6 | 7.6 | 7.6 | 7.6 | 7.6 | 7.6 |
| | isopentane | 1.9 | 1.9 | 1.9 | 1.9 | 1.9 | 1.9 |
| Property | Sample thickness | 50 | 50 | 60 | 60 | 60 | 50 |
| | Initial lambda | 0.0175 | 0.0179 | 0.018 | 0.0186 | 0.0197 | 0.0196 |
| | (4 days | | | | | | |
| | 70° C. + cond.) | | | | | | |
| | Aged lambda | 0.0184 | 0.0188 | 0.0192 | 0.0195 | | 0.0208 |
| | (2 weeks @ | | | | | | |
| | 110° C.) | | | | | | |
| | Aged lambda | 0.0187 | 0.0191 | 0.0195 | 0.0205 | | |
| | (2 weeks @ | | | | | | |
| | 110° C. + cond.) | | | | | | |
| | Dry core density | 34.1 | 31.2 | 32.3 | 33.4 | | 31.2 |
| | Compressive | 130 | 130 | | 133 | | 83 |
| | strength | | | | | | |
| | Closed cell content | 96.0 | 95.5 | 96.0 | 95.3 | | 96.2 |
| | Friability 10′ | | 13 | | 16 | | |
| | Fire performance | <100 | <100 | <100 | <100 | <100 | <100 |
| | (after 30 s) | | | | | | |

Sample 14 was tested according EN13823:2020 to determine the fire performance of the foams. The sample without any facer was mounted in the SBI test device in according to EN15715:2009. The measured Figra_{0.4}=150.6 W/s. The Total Heat Release (THR₆₀₀)=4.2 MJ. The SMOGRA=36 m²/s² and the Total Smoke Production (TSP₆₀₀)=55.8 m². This performance is in line with what would be expected from a standard phenolic foam, without any additional flame retardants. Addition of a flame retardant would improve the fire performance, however this would negatively impact the environmental footprint.

This fire performance without the need of flame retardants differentiates the product from alternative insulation materials. Polyurethane foams and Extruded Polystyrene for example require the addition of flame retardants to obtain a fire performance <150 mm in the EN11925-2. Also many bio-based insulation materials require the addition of a flame retardant to obtain acceptable fire performance.

### Comparative Example Comp-J2—Use of a Commercial Kraft Lignin

### Resin Synthesis Comp-J2

Process is identical to the one described in comparative Example Comp-A1 but 20% of the phenol input has been replaced by a commercial lignin (BioPiva supplied by UPM). Two additives, ethoxylated castor oil and dimethylphtalate were already added in the cool down phase of the resin synthesis in the same ratio as described in Comparative resin example Comp-A1.

Final properties of the resin:

TABLE 46
Resin properties example resin Comp-J2

| Property | unit | Value |
|---|---|---|
| Viscosity @ 25° C. | cPs | 2010 |
| Free Formaldehyde | % | 0.3 |
| Free Phenol | % | 8.7 |
| Water content | % | 16.3 |
| pH | — | 8.2 |

### Foaming Process Comp-J2: identical to Example Comp-A1

Comparative example Comp-J1 was produced in a identical way as Comp-A1.

Properties:

TABLE 47
Product properties comparative example J1 and J2 with BioPiva from UPM

| | Property | Standard | unit | Comp-J1 | Comp-J2 |
|---|---|---|---|---|---|
| Property | Wet core density | EN845 | [kg/m³] | 41.3 | 39.7 |
| | Dry core density | | | 34.8 | 33.2 |
| | Compressive strength X | EN826 | [kPa] | 152 | 108 |
| | Compressive strength Y | | [kPa] | 71 | 62 |
| | Friability 10′ | ISO6187 | [%] | 15 | 76.8 |
| | Thermal conductivity inital | EN14314/EN12667 | [W/m · K] | 0.0225 | 0.0251 |
| | Thermal conductivity 1 day 70° C. | | | 0.0212 | 0.030 |
| | Thermal conductivity 1 week 70° C. | | | 0.0227 | 0.0301 |
| | Thermal conductivity 25 weeks 70° C. | | | 0.0246 | 0.0305 |
| | Thermal conductivity 50 weeks 70° C. + cond | | | 0.0257 | 0.0311 |

This experiment shows the importance of phenolation of this lignin grade.

### Comparative Example Comp-K2—Use of a Commercial Lignosulphonate Lignin

### Resin Synthesis Comp-K2

Process is identical to the one described in comp-A1 but 20% of the phenol input has been replaced by a commercial lignosulphonate (Lignex Mg F supplied by Sappi). The molecular weight of this lignin is approximately 6,000 D. Two additives, ethoxylated castor oil and dimethylphtalate were already added in the cool down phase of the resin synthesis in the same ratio as described in example resin Comp-A1.

Final properties of the resin:

TABLE 48
Resin properties comparative example resin Comp-K2

| Property | unit | Value |
|---|---|---|
| Viscosity @ 25° C. | cPs | 3040 |
| Free Formaldehyde | % | 1.9 |
| Free Phenol | % | 11.2 |
| Water content | % | 16.9 |
| pH | — | 7.8 |

### Foaming Process Comp-K2: Identical to Example Comp-A1

Comparative example Comp-K1 was produced in a identical way as Comp-A1.

Properties of comp-K2 could not be measured as the foam was too brittle.

### Comparative example Comp-L2—Use of a Organosolv Lignin

### Resin Synthesis Comp-L2

Process identical to the one described in comp-A1 but 20% of the phenol input has been replaced by an organosolv lignin (supplied by Suzano). Two additives, ethoxylated castor oil surfactant dimethylphtalate were already added in the cool down phase of the resin synthesis in the same ratio as described in comp A1.

Final properties of the resin:

TABLE 49
Resin properties comparative resin example Comp-L2

| Property | unit | Value |
|---|---|---|
| Viscosity @ 25° C. | cPs | 2220 |
| Free Formaldehyde | % | 0.7 |
| Free Phenol | % | 8.4 |
| Water content | % | 16.7 |
| pH | — | 7.8 |

### Foaming Process Comp-L2: Identical to Example Comp-A1

Comparative example Comp-L1 was produced in a identical way as Comp-A1.

Properties:

TABLE 50
Product properties comparative example Comp-L1 and Comp-L2 with organosolv lignin (Suzano)

| | Property | Standard | unit | Comp-L1 | Comp-L2 |
|---|---|---|---|---|---|
| Property | Wet core density | EN845 | [kg/m³] | 42.2 | 40.8 |
| | Dry core density | | | 35.4 | 33.8 |
| | Compressive strength X | EN826 | [kPa] | 163 | 128 |
| | Compressive strength Y | | [kPa] | 71 | 72 |
| | Friability 10′ | ISO6187 | [%] | 18.6 | 44.8 |
| | Thermal conductivity inital | EN14314/EN12667 | [W/m · K] | 0.0226 | 0.025 |
| | Thermal conductivity 1 day 70° C. | | | 0.0209 | 0.0297 |
| | Thermal conductivity 1 week 70° C. | | | 0,0226 | 0.0297 |
| | Thermal conductivity 25 weeks 70° C. | | | 0.0248 | 0.0301 |
| | Thermal conductivity 50 weeks 70° C. + cond. | | | 0.0257 | 0.0304 |

### Comparative Example Comp-M2—Use of a Hydrolysis Lignin

### Resin Synthesis Comp-M2

Process identical to the one described in example 1 but 20% of the phenol input has been replaced by a hydrolysis lignin (supplied by Chempolis). Two additives, ethoxylated castor oil surfactant and dimethylphtalate were already added in the cool down phase of the resin synthesis in the same ratio as described in Comparative example resin Comp-A1.

Final properties of the resin:

TABLE 51
Resin properties comparative example resin Comp-M2

| Property | unit | Value |
|---|---|---|
| Viscosity @ 25° C. | cPs | 2090 |
| Free Formaldehyde | % | 0.6 |
| Free Phenol | % | 8.8 |
| Water content | % | 16.5 |
| pH | — | 7.9 |

### Foaming Process Comp-M2: Identical to Example Comp-A1

Comparative example Comp-M1 was produced in a identical way as Comp-A1.

Properties:

TABLE 52
Product properties comparative example M2 with hydrolysis lignin (Chempolis)

| | Property | Standard | unit | Comp-M1 | Comp-M2 |
|---|---|---|---|---|---|
| Property | Sample thickness | | [mm] | 42.5 | 38.6 |
| | Dry core density | EN845 | [kg/m³] | 36.2 | 34.4 |
| | Compressive strength X | EN826 | [kPa] | 170 | 123 |
| | Compressive strength Y | | [kPa] | 78 | 75 |
| | Friability 10′ | ISO6187 | [%] | 19.4 | 63.3 |
| | Thermal conductivity inital | EN14314/EN12667 | [W/m · K] | 0.0223 | 0.0287 |
| | Thermal conductivity 1 day 70° C. | | | 0.0207 | 0.0301 |
| | Thermal conductivity 1 week 70° C. | | | 0.0224 | 0.0303 |
| | Thermal conductivity 25 weeks 70° C. | | | 0.0247 | 0.0303 |
| | Thermal conductivity 50 weeks 70° C. + cond. | | | 0.0256 | 0.0301 |

The examples G1, G2, G3, H1, I1, I3, I4, I5, I6 and I7 surprisingly show that for specific types of lignin good physical properties can be obtained. Where the comparative examples Comp-G1, Comp-G2, Comp-G3, Comp-H1, Comp-I1, Comp-I3, Comp-I4, Comp-I5, Comp-J1, Comp-J2, Comp-L1, Comp-L2, Comp M1 and Comp M2 prove that in the majority of cases the product properties are negatively affected.

The main properties of the lignins used are:

TABLE 53
Summary of lignin properties

| | | | Kraftsperse | Reax | | Lineo | Lignex | Pyrolytic | Biopiva |
|---|---|---|---|---|---|---|---|---|---|
| property | unit | Hyact | 25M | 100M | Polyfon H | Classic | MG F | lignin | 395 |
| Solid lignin | % | — | — | — | — | 92-97 | 91-95 | — | 95 |
| Moisture | % | 7.0 | 7.0 | 7.0 | 7.0 | — | — | — | — |
| Carbohydrates | % | — | — | — | — | <2 | — | — | — |
| M_{w} | D | 23000 | 4400 | 2000 | 4300 | 5500-7500 | — | <400 | 6000 |
| Sulphonation | mol/kg | 0.8 | 2.9 | 3.4 | 0.7 | na | — | — | [symbol] |
| Total S | % | 4.8 | 3.8 | 12.3 | 4.2 | <3 | — | — | — |
| Ash | % | — | — | — | — | <2.5 | — | — | <2 |

[symbol]

indicates data missing or illegible when filed

The addition of lignins, is positive in such a way that the amount of renewable content can be increased without the need of addition of bio-phenol as bio-phenol will still have a greater environmental impact than lignin. The biocontent (C¹⁴ carbon) measured according EN16640: 2017 is given in Table 48.

TABLE 54
Renewable content in function of the
amount of the type of lignin added.

| | Biobased carbon |
|---|---|
| sample | content [% on TC] |
| comp. Sample E1 | 3% |
| Sample E1 (20% Reax 100M) | 10% |
| Sample E2 (20% Kraftperse 25M) | 8% |
| Sample E3 (20% phenolated Lineo classic) | 13% |
| Sample E4 (20% Pyrolytic lignin - BTG) | 9% |
| comp. Sample B1 | 2% |
| Sample F1 (20% Kraftperse 25M) | 9% |
| Sample F2 (20% Pyrolytic lignin - BTG) | 7% |

Depending on the type of lignin, the bio-content is increased by 5 to 10%, when 20% of the phenol is replaced by lignin.

An additional advantage is that the GWP-total of the resulting product is even lower in comparison to the replacement of phenol by bio-phenol. Lignin has a GWP-fossil of 1.5 kg CO₂ eq./kg, which is lower compared to fossil phenol (1.8 kg CO₂ eq./kg). The total GHG footprint however is determined by the way the lignin is valorised. Valorisation of lignin means that a waste stream is used for a more useful application. Lignins are currently burned as no useful application exists. In case of non-valorised lignin, like for example the sulphonated lignins in example E1 and E2 there is no contribution from the fractionation and therefore have a very low footprint. For solvent fractionation, the footprint is almost as low as for non-valorised lignins (approx. 5% higher). The BTG pyrolytic lignin for example is a solvent fractionated lignin.

However when Base-Catalysed Depolymerisation is used, the GWP increases 10-fold to 18.3 kg CO₂ eq./kg and is therefore not preferred from an environmental point of view.

For this example we assumed the performance of non-valorised and liquid valorised to be more or less comparable as the difference in footprint is 5% or less.

To illustrate the impact of the addition of lignin samples N1 and N2 were produced. For these samples the same methodology as for Comp-A1 was used, but for sample N1, formaldehyde was replaced by bio-formaldehyde produced from syngas. On top of this 20% of phenol was replaced by Reax 100M from Ingevity. Sample N2 was prepared in a identical way as N1 however the fossil phenol was replaced by bio-based phenol.

Final properties of the resin:

TABLE 55
Resin properties example N1 and N2

| Property | unit | Value N1 | Value N2 |
|---|---|---|---|
| Viscosity @ 25° C. | cPs | 1910 | 1960 |
| Free Formaldehyde | % | 0.2 | 0.2 |
| Free Phenol | % | 4.9 | 5.5 |
| Water content | % | 17.7 | 18.0 |
| pH | — | 8.1 | 8.0 |

The foams were produced according method of comp-A1. The foam properties are presented in Table 56.

TABLE 56
Product properties example N1 and N2 with Reax 100M lignin

| Property | Standard | unit | Comp-A1 | A2 | A4 | E1 | N1 | N2 |
|---|---|---|---|---|---|---|---|---|
| Wet-core density | EN845 | [kg/m³] | 42.1 | 43.1 | 42 | 46.2 | 41.0 | 41.9 |
| Dry core density | | | 36.1 | 36.5 | 35.9 | 39.0 | 34.8 | 35.5 |
| Compressive strength X | EN826 | [kPa] | 172 | 170 | 160 | 150 | 163 | 166 |
| Compressive strength Y | | | 80 | 83 | 79 | 103 | 106 | 97 |
| Friability 10′ | ISO6187 | [%] | 17.3 | 16.8 | 18.2 | 19.1 | 20.0 | 19.7 |
| Thermal conductivity inital | | | 0.0227 | 0.0227 | 0.0232 | 0.0244 | 0.0233 | 0.0243 |
| Thermal conductivity 1 day 70° C. | | | 0.0208 | 0.021 | 0.021 | 0.0217 | 0.0217 | 0.021 |
| Thermal conductivity 1 week 70° C. | EN14314/12667 | W/m · K | 0.0228 | 0.0227 | 0.023 | 0.0239 | 0.023 | 0.0234 |
| Thermal conductivity 25 weeks 70° C. | | | 0.0251 | 0.0248 | 0.0243 | 0.0252 | 0.0249 | 0.0251 |
| Thermal conductivity 50 weeks 70° C.+ | | | 0.026 | 0.0259 | 0.0255 | 0.0259 | 0.026 | 0.0262 |

Again the product properties are not negatively affected. The main benefit of lignin addition is a reduction of the GWP of the final product.

TABLE 57
Global Warming Potential of example N1 and N2 (cradle to gate)

| Material | property | unit | Comp-A1 | A2 | A4 | E1 | N1 | N2 |
|---|---|---|---|---|---|---|---|---|
| Methanol | GWP-fossil | kg CO₂ eq/kg | 0.6 | 0.3 | 0.3 | 0.6 | 0.3 | 0.3 |
| | GWP-biogenic | | 0.0 | −1.4 | −1.4 | 0.0 | −1.4 | −1.4 |
| | GWP-total | | 0.6 | −1.1 | −1.1 | 0.5 | −1.1 | −1.1 |
| | bio-Carbon content | [%] | 0.0 | 37.5 | 37.5 | 0.0 | 37.5 | 37.5 |
| Phenol | GWP-fossil | kg CO₂ eq/kg | 1.8 | 1.3 | 1.7 | 1.8 | 1.8 | 1.7 |
| | GWP-biogenic | | 0.0 | 0.0 | −2.8 | 0.0 | 0.0 | −2.8 |
| | GWP-total | | 1.8 | 1.8 | −1.1 | 1.8 | 1.8 | −1.1 |
| | bio-Carbon content | [%] | 0.0 | 0.0 | 76.5 | 0.0 | 0.0 | 76.5 |
| Lignin (20% replacement) | GWP-fossil | kg CO₂ eq/kg | | | | 1.5 | 1.5 | 1.5 |
| | GWP-biogenic | | | | | −2.8 | −2.8 | −2.8 |
| | GWP-total | | | | | −1.3 | −1.3 | −1.3 |
| | bio-Carbon content | [%] | | | | ±75 | ±75 | ±75 |
| Product (A1-A3) | GWP-fossil | kg CO₂ eq/kg | 1.9 | 1.9 | 1.9 | 1.7 | 1.7 | 1.7 |
| | GWP-biogenic | | 0.0 | −0.4 | −1.7 | −0.3 | −0.7 | −1.7 |
| | GWP-total foam | | 2.0 | 1.6 | 0.3 | 1.5 | | |
| | bio-Carbon content | [%] | 3.0 | 15.9 | 66.8 | ±11 | ±65 | ±65 |
| | (dry core density) | | | | | | | |

In the GWP total of the foam a GWP-luluc of 0.1 kg CO₂ eq./kg is included. For the phenol and formaldehyde the GWP-luluc is below 0.1 kg CO₂ eq./kg.

Combining bio-formaldehyde with 20% phenol replacement by lignin, delivers a significant reduction of the GWP of the product. The reduction in GWP of the final product is roughly 0.9 kg CO₂ equivalent per kilogram of foam (almost 50% reduction).

Even more interesting is the reduction when the remaining part of phenol is replaced by bio-phenol. In this case the GWP is reduced to approx. 0 kg CO₂ eq./kg (100% reduction).

In general it can be concluded that the addition of lignin to replace phenol solves the issue of low bio-content of high performance insulation foams and can reduce the carbon footprint during the production stage (cradle-to-grave) significantly.

When we translate these findings back to the final product, the density can range between 15 and 60 kg/m³, more preferably 25-40 kg/m³. This means that for an 80 mm insulation foam (without facer) for example, with a density of 35 kg/m³, the GHG footprint when lignin is introduced of the insulation foam is 4.2 kg CO₂ eq. when the formaldehyde is fully replaced by a formaldehyde produced from bio-waste. A foam based on bio-phenol would be able to achieve a value of 1.7 kg CO₂ eq. The combination would result in a further reduction to 0.6 kg CO₂ eq.

When 20% of the phenol is replaced by lignin the GHG of the product (cradle-to-gate) would achieve a value of 3.9 kg CO₂ eq./kg. A further substitution to bio-formaldehyde would result to a footprint of 2.8 kg CO₂ eq./kg. When on top all phenol is exchanged for bio-based phenol, the footprint can be reduced to 0.

### Sample O1 and O2: Combinations of Lignin, Bio-Formaldehyde and Bio-Phenol

To confirm these findings sample O1 has been produced in a identical way as sample B4, however in this case 20% of the bio-based phenol was replaced by Phenolated lignin. The phenolation process of the lignin was performed prior to the addition of the formaldehyde under acidic conditions, hence the impact on the GWP is negligible. The lignin grade was Lineo Classic supplied by Stora Enso.

Sample O2, additionally the remaining 80% of fossil phenol was replaced by bio-based phenol.

The product properties were not compromised by the introduction of lignin.

TABLE 58
Product properties example O1 and O2 with phenolated Lineo Classic

| | Property | Standard | unit | Comp-B1 | B2 | B4 | O1 | O2 |
|---|---|---|---|---|---|---|---|---|
| Formulation | Phenolic Resin | | [pbw] | 110 | 110 | 110 | 110 | 110 |
| | Acid Catalyst | | | 20 | 20 | 20 | 20 | 20 |
| | isopropyl chloride | | | 7.6 | 7.6 | 7.6 | 7.6 | 7.6 |
| | isopentane | | | 1.9 | 1.9 | 1.9 | 1.9 | 1.9 |
| Property | Sample thickness | | [mm] | 80 | 80 | 80 | 80 | 80 |
| | Initial lambda (4 days 70° C. + cond.) | EN13166/12667 | [W/m · K] | 0.0182 | 0.0179 | 0.0181 | 0.0174 | 0.0175 |
| | Aged lambda (2 weeks @ 110° C. + cond) | | | 0.0187 | 0.0190 | 0.0186 | 0.0188 | 0.0186 |
| | Aged lambda (4 weeks @ 110° C. + cond.} | | | 0.0194 | 0.0197 | 0.0190 | 0.0189 | 0.0196 |
| | Dry core density | EN845 | [kg/m³] | 35.8 | 35.8 | 35.1 | 34.2 | 33.1 |
| | Compressive strength | EN826 | [kPa] | 122 | 130 | 135 | 125 | 118 |
| | Closed cell content | | [%] | | | | 96.1 | 96 |
| | Friability 10′ | ISO6187 | [%] | | | | 19 | 20 |
| | Fire performance (after 30 s) | EN11925-2 | [mm] | <100 | <100 | 100 | <100 | <100 |

Also for these samples the impact on the GWP potential of the final product has been determined.

TABLE 59
Global Warming Potential of example O1 and O2 with phenolated Lineo Classic

| | property | unit | Comp-B1 | B2 | B4 | O1 | O2 |
|---|---|---|---|---|---|---|---|
| Methanol | GWP-fossil | kg CO₂ eq/kg | 0.6 | 0.3 | 0.3 | 0.3 | 0.3 |
| | GWP-biogenic | | 0.0 | −1.4 | −1.4 | −1.4 | −1.4 |
| | GWP-total | | 0.6 | −1.1 | −1.1 | −1.1 | −1.1 |
| | bio-Carbon content | [%] | 0.0 | 37.5 | 37.5 | 37.5 | 37.5 |
| Phenol | GWP-fossil | kg CO₂ eq/kg | 1.8 | 1.8 | 1.7 | 1.8 | 1.7 |
| | GWP-biogenic | | 0.0 | 0.0 | −2.8 | 0.0 | −2.8 |
| | GWP-total | | 1.8 | 1.8 | −1.1 | 1.8 | −1.1 |
| | bio-Carbon content | [%] | 0.0 | 0.0 | 76.5 | 0.0 | 76.5 |
| Lignin | GWP-fossil | kg CO₂ eq/kg | | | | 1.5 | 1.5 |
| | GWP-biogenic | | | | | −2.8 | −2.8 |
| | GWP-total | | | | | −1.3 | −1.3 |
| | bio-Carbon content | [%] | | | | ±75% | ±75% |
| Insulation | GWP-fossil | kg CO₂ eq/kg | 2.0 | 2.0 | 2.0 | 1.8 | 1.8 |
| foam | GWP-biogenic | | 0.0 | −0.4 | −1.6 | −0.7 | −1.7 |
| | GWP-total foam | | 2.1 | 1.7 | 0.5 | 1.2 | 0.2 |
| | bio-Carbon content | [%] | 2.0 | 12.2 | 42.7 | ±21 | ±42 |
| | (dry core density - excl facer) | | | | | | |

In the GWP total of the foam a GWP-luluc of 0.1 kg CO₂ eq./kg is included. For the phenol and formaldehyde the GWP-luluc is below 0.1 kg CO₂ eq./kg.

Furthermore the lignin will positively contribute to the Renewable primary energy resources used as raw materials (PERM):

TABLE 60
PERM and PENRM of example O1 and O2 with phenolated Lineo Classic

| | property | unit | Comp-B1 | B2 | B4 | O1 | O2 |
|---|---|---|---|---|---|---|---|
| Insulation | PERM | MJ/kg | 0.0 | 2.8 | 11.0 | 5.1 | 10.8 |
| foam | PENRM | MJ/kg | 27.1 | 24.3 | 16.1 | 22.0 | 16.3 |
| | bio-Carbon content | [%] | 2.0 | 12.2 | 42.7 | ±21 | ±42 |
| | (dry core density - excl facer) | | | | | | |

Table 60 shows that the PERM of the product can be increased to above 2.0 when all options are combined.

The main component of the insulation product is the resin. However the footprint of the product in the Cradle-to-gate stage can be further optimised by converting the other components of the foam to bio-based alternatives.

For example a bio-based polyol could be considered. In this case the phthalic acid could be replaced by a bio-based version. Relement for example supplies this material. Also fully and or partly bio-based polyols are available from for example Polylabs and COIM. The polyester polyol, can also be the result of a glycolysis on polyurethane foam scrap, which consists of diethylene glycol polyurethane oligomers, amine and urea polyurethane oligomers and diethylene glycol.

Urea contains a relative high nitrogen content and relative low Carbon content. For this reason a conversion of the urea will have a relative low impact.

In case an organic acid is used as a catalyst, also a bio-based versions can be considered. Bio-based toluene and xylene are commercial available.

In case a neutraliser like for example CaCO₃ is added, bio-based alternatives like sea selves can be considered.

Optimising the blowing agent can also be considered. In case of cyclopentane a grade recovered from end of life refrigeration equipment could be used for example.

Laminates are produced with a facer in a continuous process. Rather than in block foam production, which is discontinuous, the laminate foam is fed into a conveyor in between 2 layers of facer. When this facer has a high renewable content, the GWP can be optimised even further. This can for example be a paper facer, in the most optimum situation produced from recycled paper. Aluminium, relative frequently used as facer material is less preferred as the GWP of aluminium is high. Glass fibre veils, can be an interesting choice when the fire performance is an important application requirement.

The words “comprises/comprising” and the words “having/including” when used herein with reference to the present invention are used to specify the presence of stated features, integers, steps or components but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

### Definitions

The phrase “at least one X selected from the group consisting of A, B, C, and combinations thereof” is defined such that X includes: “at least one A” or “at least one B” or “at least one C”, or “at least one A in combination with at least one B”, or “at least one A in combination with at least one C” or “at least one B in combination with at least one C” or “at least one A in combination with at least one B and at least one C”.

The phrase “Y may be selected from A, B, C and combinations thereof” implies Y may be A, or B, or C, or A+B, or A+C, or B+C, or A+B+C.

The term “blowing agent” is defined as the propelling agent employed to blow the foamable composition for forming a foam. For example, a blowing agent may be employed to blow/expand a resin to form a foam.

### Properties

Suitable testing methods for measuring the physical properties of phenolic resins are described below.

### (i) Resin Viscosity

The viscosity of a resin employed in the manufacture of a foam of the present invention may be determined by methods known to the person skilled in the art for example using a Brookfield viscometer (model DV-II+Pro) with a controlled temperature water bath, maintaining the sample temperature at 25° C., with spindle number SC4-29 rotating at 20 rpm or appropriate rotation speed and spindle type or suitable test temperature to maintain an acceptable mid-range torque for viscosity reading accuracy.

### (i) % Water Content of Phenolic Resin

To dehydrated methanol (manufactured by Honeywell Speciality Chemicals), the phenol resin was dissolved in the range of 25% by mass to 75% by mass. The water content of the phenol resin was calculated from the water amount measured for this solution. The instrument used for measurement was a Metrohm 870 KF Titrino Plus. For the measurement of the water amount, Hydranal™ Composite 5, manufactured by Honeywell Speciality Chemicals was used as the Karl-Fischer reagent, and Hydranal™ Methanol Rapid, manufactured by Honeywell Speciality Chemicals, was used for the Karl-Fischer titration. For measurement of the titre of the Karl-Fischer reagent, Hydranal™ Water Standard 10.0, manufactured by Honeywell Speciality Chemicals, was used. The water amount measured was determined by method KFT IPol, and the titre of the Karl-Fischer reagent was determined by method Titer IPol, set in the apparatus.

Suitable testing methods for measuring the physical properties of phenolic foam are described below.

### (i) Foam Density

This was measured according to EN 1602:2013-Thermal insulating products for building applications-Determination of the apparent density.

### (i) Compressive Strength

This was measured according to EN 826:2013—Thermal insulating products for building applications—Determination of compression behaviour. The value presented in the value for the first crack when the sample is deformed by 10% of the thickness

### (ii) Thermal Conductivity of the Foam

A foam test piece of length 300 mm and width 300 mm was placed between a high temperature plate at 20° C. and a low temperature plate at 0° C. in a thermal conductivity test instrument (LaserComp Type FOX314/ASF, Inventech Benelux BV). The thermal conductivity (TC) of the test pieces was measured according to EN 12667:2001: “Thermal insulation performance of building materials and products—Determination of thermal resistance by means of guarded hot plate and heat flow meter methods, Products of high and medium thermal resistance”. The thermal conductivity may also be measured according to EN 12939:2000 “Thermal performance of building materials and products—Determination of thermal resistance by means of guarded hot plate and heat flow meter methods-Thick products of high and medium thermal resistance”.

### (iii) Thermal Conductivity of the Foam after Accelerated Ageing

This was measured using European Standard EN 13166:2012+A2:2016—“Thermal insulation products for buildings-Factory made products of phenolic foam (PF)”—Specification Annex C section 4.2.3. The thermal conductivity is measured after exposing foam samples for 2 weeks at 70° C. and subsequently 2 weeks at 110° C. and stabilisation to constant weight at 23° C. and 50% relative humidity. This method results in an estimated thermal conductivity for a period of 25 years. To determine the average thermal conductivity for a period of 50 years, the foam samples are exposed for 2 weeks at 70° C. and subsequently 4 weeks at 110° C. and stabilisation to constant weight at 23° C. and 50% relative humidity.
As an alternative to ageing for 2 weeks at 110° C. to arrive at the 25 years average value, the foam can be aged for 25 weeks at 70° C., followed by stabilisation to constant weight at 23° C. and 50% relative humidity. To provide an estimated thermal conductivity for a period of 50 years at ambient temperature the product can be aged for 50 weeks.
For block bio-phenol/lignin/bio-formaldehyde foam, the aged thermal conductivity after accelerated ageing for 25 weeks at 70° C. and conditioned to stable weight at 23° C./50% R.H. is measured according EN14314:2015 (Heat ageing B4, Annex B) simulates the thermal performance over 25 years. This standard only allows for ageing at 70° C.

### (v) Closed Cell Content

The closed cell content may be determined using gas pycnometry. Suitably, closed cell content may be determined according to NEN-EN ISO 4590, Rigid cellular plastics—Determination of the volume percentage of open cells and closed cells.

### (vi) Foam Friability

Friability is measured according test method ASTM C421-08 (2014).

### (viii) Average Cell Diameter

A flat section of foam is obtained by slicing through the middle section of the thickness of the foam board in a direction running parallel to the top and bottom faces of a foam board. A 50-fold enlarged photocopy is taken of the cut cross section of the foam. Four straight lines of length 9 cm are drawn on to the photocopy. The number of cells present on every line is counted and the average number cell number determined according to JIS K6402 test method. The average cell diameter is taken as 1800 pm divided by this average number.

### (x) Fire Performance of the Foam

The fire performance is measured according EN13501. This standard refers to ISO-EN11925-2:2020 which specifies a method of test for determining the ignitability of products by direct small flame impingement under zero impressed irradiance using vertically oriented test specimens. The standard also refers to EN13823:2020 Reaction to fire tests for building products. This document specifies a method of test for determining the reaction to fire performance of construction products when exposed to thermal attack by a single burning item (SBI). The calculation procedures are given in Annex A. The calibration procedures are given in Annexes C and D, of which Annex C is a normative annex. This document has been developed to determine the reaction to fire performance of essentially flat products. The samples shall be installed in the test rig according EN15715:2009.

### (x) Water Vapour Permeability of the Foam

The water vapour permeability is measured in accordance with EN 12086:2013. The test conditions are according to clause 7.1 Table 1, condition B: 23° C.-0/80% R.H. (drycup). A cylindrical specimen with a diameter of 130 mm is tested at the full product thickness.

1. A foam product comprising an expanded foam body having cells defined therein and blowing agent held within the cells, wherein at least 5% by weight of the foam body is formed from at least one component from a renewable source.

2. The foam product according to claim 1 wherein the foam product comprises cardanol, rosin, or a polyol derived from: polyethylene terephthalate; polyurethane;
and/or polyisocyanurate; or any combination thereof as plasticiser.

3. The foam product of any preceding claim wherein the at least one component from a renewable source comprises a phenolated lignin.

4. The foam product of any preceding claim wherein the at least one component from a renewable source comprises a sulphonated lignin, optionally wherein the weight of sulphur in the sulphonated lignin is at least 2% by weight.

5. The foam product according to any preceding claims wherein the at least one component from a renewable source comprises a pyrolytic lignin.

6. The foam product of any preceding claim wherein the at least one component from a renewable source comprises technical lignin originating from paper and/or pulp processes.

7. The foam product of any preceding claim wherein the at least one component from a renewable source comprises soda lignin.

8. The foam product of any preceding claim wherein the at least one component from a renewable source comprises an organosolv lignin.

9. The foam product of any preceding claim wherein the at least one component from a renewable source comprises a depolymerised lignin.

10. The foam product of any preceding claim wherein the at least on component from a renewable source comprises a Kraft lignin.

11. The foam product according to claim 10 wherein the percentage by weight of sulfur in the sulfonated Kraft lignin is at least 2% by weight.

12. The foam product according to claim 10 or 11 wherein the sulfonated Kraft lignin has a weight average molecular weight (Mw) between 2,000 and 23,000 Daltons (Da).

13. A foam product formed from a composition comprising methanol, wherein the methanol has a GWP-total of below −0.5 as measured according to EN 15804:2012+A2:2019.

14. A foam product formed from a composition comprising phenol, wherein the phenol has a GWP-total of below 1 as measured according to EN 15804:2012+A2:2019.

15. A foam product formed from a composition comprising methanol and phenol, wherein the methanol has a GWP-total of below −0.5 as measured according to EN 15804:2012+A2:2019 and the phenol has a GWP-total of below 1 as measured according to EN 15804:2012+A2:2019.

16. The foam product comprising an expanded foam body having cells defined therein and blowing agent held within the cells, wherein the foam body is formed from the reaction of phenolic material and formaldehyde and at least 10%, for example at least 20%, such as at least 30%, for example at least 40% desirably at least 50% by weight of the formaldehyde utilised is a bio-formaldehyde.

17. The foam product according to claim 16, wherein the bio-formaldehyde is produced from bio-methanol.

18. The foam product according to claim 17 wherein the bio-methanol is produced by fermentation of bio-waste.

19. The foam product according to any of claims 16 to 18 wherein the bio-methanol is produced from syngas (synthetic gas) for example syngas obtained by gasification of bio-waste such as forestry waste.

20. A foam product comprising an expanded foam body having cells defined therein and blowing agent held within the cells, wherein the foam body is formed from a reaction with a phenol wherein at least 10% for example at least 15% such as at least 20% such as at least 25% by weight of the phenol is formed from bio-phenol.

21. The foam product according to claim 20, where the bio-phenol is produced from bio-benzene, optionally by means of pyrolysis of bio-waste such as wood materials including wood waste and by-products of wood processing such as in paper production.

22. The foam product according to claim 21 wherein the bio-benzene is made from tall oil.

23. The foam product according to any preceding claim wherein at least 7% by weight of the foam body is formed from at least one component from a renewable source, such as at least 10%, for example at least 15%, desirably at least 20%, optionally at least 25%, for example at least 30%.

24. The foam product according to any preceding claim wherein at least 70% of the blowing agent (based on the total weight of blowing agent) has a thermal conductivity in the gas phase at 25° C. of 12 mW/m·k or less for example 11.8 mW/m·k or less.

25. The foam product according to any preceding claim wherein the weight of the at least one component from a renewable source comprises carbon and is measured according to EN16640:2017 and is based on a C¹⁴ measurement.

26. The foam product according to any preceding claim wherein the foam body has a C¹⁴ carbon content of greater than 3% as measured according to according to EN16640:2017.

27. The foam product according to any preceding claim wherein the average thermal conductivity of the foam product over a 25 year life span of the product is 0.025 W/m·K or less as measured according to as determined in accordance with EN 16783:2017.

28. The foam product according to any preceding claim wherein the average thermal conductivity of the foam product over a 50 year life span of the product is 0.026 W/m·K or less as measured according to as determined in accordance with EN 16783:2017

29. The foam product according to any preceding claim wherein the total Global Warming Potential of the foam is equal or less than 1.7 kg CO₂ eq./kg; such as equal or less than 1.5 kg CO₂ eq./kg; for example equal to or less than −0.5 kg CO₂ eq./kg; as determined in accordance with EN 16783:2017.

30. The foam product according to any preceding claim wherein the Global Warming Potential-biogenic of the product is equal to or less than −0.2 kg CO₂ eq./kg; such as equal to or less than −0.4 kg CO₂ eq./kg as determined in accordance with EN 16783:2017.

31. The foam product according to any preceding claim in which the components which form the foam body have renewable primary energy resources equal or less than 0.7 MJ/kg as determined in accordance with EN 16783:2017.

32. The foam product according to any preceding claim wherein the foam product exhibits a fire performance that is a flame height <100 mm in a single flame source test as determined by EN ISO 11925-2.

33. The foam product according to any preceding claim wherein the closed cell content of the foam product is at least 90%, for example at least 92%, such as at least 94% optionally at least 95% as determined by EN ISO 4590.

34. The foam product according to any preceding claim which has a friability below 20% as measured by ASTM C421-08(2014).

35. The foam product according to any preceding claim which has a compressive strength of 100 kPa or greater as measured by EN 826:2013.

36. The foam product according to any preceding claim wherein the foam product has a density of 10 kg/m³ up to 125 kg/m³ such as a density of from about 15 kg/m³ to about 100 kg/m³, preferably of from about 15 kg/m³ to about 60 kg/m³, suitably from about 20 kg/m³ to about 35 kg/m³ as determined by EN 1602:2013.

37. The foam product according to any preceding claim wherein the foam product is a phenolic foam product.

38. A foam product comprising a combination of any of the features of claims 1 to 37.

39. Use of a lignin as a colour imparting additive in a foam product comprising an expanded foam body having cells defined therein and blowing agent held within the cells.

40. Use of a lignin as a colour stabilising additive in a foam product comprising an expanded foam body having cells defined therein and blowing agent held within the cells.

41. A foam product wherein the foam body has a C¹⁴ carbon content of greater than 3% as measured according to according to EN16640:2017.

42. A phenolic foam product wherein the foam body has a C¹⁴ carbon content of greater than 3% as measured according to according to EN16640:2017.

43. A foam product comprising an expanded foam body having closed cells, and blowing agent held within the cells, wherein the foam body is formed form at least one component from a renewable source, and the foam body has a total GWP for the Cradle-to-gate stages (A1 till A3), below 1.0 kg CO₂ eq/kg (as determined in accordance with EN 16783:2017).

44. A foam product comprising an expanded foam body having cells defined therein and blowing agent held within the cells, wherein the foam body has an EPD rating of 1.0 Kg CO₂ eq/kg for the life cycles A-D as determined according to EN 15804:2012+A2:2019.

45. A foam product comprising an expanded foam body having cells defined therein and blowing agent held within the cells, wherein at least 5% by weight of the foam body is formed from at least one component from a renewable source and optionally wherein the average thermal conductivity of the foam product over a 25 year life span of the product is 0.025 W/m·K or less as measured according to EN 12667 or EN 12939.

46. A foam product comprising an expanded foam body having cells defined therein and blowing agent held within the cells, wherein at least 5% by weight of the foam body is formed from at least one component from a renewable source and optionally wherein the average thermal conductivity of the foam product over a 50 year life span of the product is 0.026 W/m·K or less as measured according to EN 12667or EN 12939.

47. A foam product comprising an expanded foam body having cells defined therein and blowing agent held within the cells, wherein at least 5% by weight of the foam body is formed from at least one component from a renewable source and optionally wherein the average thermal conductivity of the foam product over a 25 year life span of the product is 0.025 W/m·K or less as measured according to EN13166 and/or EN14314.

48. A foam product comprising an expanded foam body having cells defined therein and blowing agent held within the cells, wherein at least 5% by weight of the foam body is formed from at least one component from a renewable source and optionally wherein the average thermal conductivity of the foam product over a 50 year life span of the product is 0.026 W/m·K or less as measured according to EN13166 and/or EN14314.
